(19) United States
(12) Patent Application Publication
(10) Pub. No.: US 2025/0386306 A1
(43) Pub. Date: Dec. 18, 2025

(54) POWER CONTROL METHOD AND DEVICE IN WIRELESS COMMUNICATION SYSTEM

(71) Applicant: Samsung Electronics Co., Ltd., Suwon-si, Gyeonggi-do (KR)

(72) Inventors: Junyung YI, Suwon-si (KR); Youngrok JANG, Suwon-si (KR); Kyoungmin PARK, Suwon-si (KR); Seongmok LIM, Suwon-si (KR); Youngbum KIM, Suwon-si (KR); Hyunsuk RYU, Suwon-si (KR)

(21) Appl. No.: 18/875,969

(22) PCT Filed: Jun. 16, 2023
(86) PCT No.: PCT/KR2023/008389

§ 371 Date: Dec. 17, 2024

(30) Foreign Application Priority Data
Jun. 17, 2022 (KR) 10-2022-0074282

(51) Int. Cl. H04W 52/36; H04L 1/1812; H04L 5/00; H04W 16/28; H04W 52/08; H04W 72/231

(52) U.S. Cl. CPC H04W 52/367; H04L 1/1812; H04L 5/0044; H04W 16/28; H04W 52/08; H04W 72/231

(57) ABSTRACT

The present disclosure relates to a 5G or 6G communication system for supporting higher data transmission rates. Various embodiments of the present disclosure can provide a power control method and device in a wireless communication system. Through the embodiments of the present disclosure, a signal transmission method of a base station in a 5G mobile communication system is defined, and thus higher reliability in uplink transmission can be achieved through transmission power control according to a set beam.

### TECHNICAL FIELD

The disclosure relates to a power control method and device in a wireless communication system.

### BACKGROUND ART

5^{th} generation (5G) mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra-reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures. i.e., 2-step random access channel (RACH) for NR. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Various embodiments of the disclosure provide a power control method and device in a wireless communication system.

Various embodiments of the disclosure can control and determine uplink transmit power when beam information is changed through unified TCI signaling.

The technical problems to be solved in the disclosure are not limited to the above-mentioned technical problems, and a person skilled in the art to which the disclosure pertains will clearly understand, from the following description, other technical problems not mentioned herein.

### Solution to Problem

In various embodiments, a method for controlling uplink transmit power when beam information is changed through integrated TCI signaling in a wireless communication system may include an operation of being configured with a list of TCI states through higher layer signaling including RRC, an operation of activating a part of the list of TCI states through MAC-CE, an operation of changing a beam according to unified TCI configuration through L1 signaling, and an operation of controlling uplink transmit power based on the configuration information and the changed beam.

According to an embodiment of the disclosure, a method performed by a terminal in a communication system may include receiving a physical uplink shared channel (PUSCH) repetition transmission configuration including a first PUSCH and a second PUSCH from a base station; transmitting the first PUSCH to the base station; receiving downlink control information (DCI) including unified transmission configuration indication (TCI) configuration information from the base station after transmission of the first PUSCH; determining a power control adjustment state parameter for transmit power control of the second PUSCH based on a closed loop index related to a TCI configured based on the DCI and a TPC command field included in the DCI; determining transmit power of the second PUSCH based on the power control adjustment state parameter; and transmitting the second PUSCH to the base station based on the transmit power of the second PUSCH.

According to an embodiment of the disclosure, a method performed by a base station in a communication system may include transmitting a physical uplink shared channel (PUSCH) repetition transmission configuration including a first PUSCH and a second PUSCH to a terminal; receiving the first PUSCH from the terminal; transmitting downlink control information (DCI) including unified transmission configuration indication (TCI) configuration information to the terminal after reception of the first PUSCH; and receiving the second PUSCH from the terminal, wherein transmit power of the second PUSCH may be associated with a power control adjustment state parameter for transmit power control of the second PUSCH determined based on a closed loop index related to a TCI configured based on the DCI and a TPC command field included in the DCI.

According to an embodiment of the disclosure, a terminal in a communication system includes a transceiver and a controller, and the controller may be configured to receive a physical uplink shared channel (PUSCH) repetition transmission configuration including a first PUSCH and a second PUSCH from a base station, to transmit the first PUSCH to the base station, to receive downlink control information (DCI) including unified transmission configuration indication (TCI) configuration information from the base station after transmission of the first PUSCH, to determine a power control adjustment state parameter for transmit power control of the second PUSCH based on a closed loop index related to a TCI configured based on the DCI and a TPC command field included in the DCI, to determine transmit power of the second PUSCH based on the power control adjustment state parameter, and to transmit the second PUSCH to the base station based on the transmit power of the second PUSCH.

According to an embodiment of the disclosure, a base station in a communication system includes a transceiver and a controller, and the controller may be configured to transmit a physical uplink shared channel (PUSCH) repetition transmission configuration including a first PUSCH and a second PUSCH to a terminal, to receive the first PUSCH from the terminal, to transmit downlink control information (DCI) including unified transmission configuration indication (TCI) configuration information to the terminal after reception of the first PUSCH, and to receive the second PUSCH from the terminal, wherein transmit power of the second PUSCH may be associated with a power control adjustment state parameter for transmit power control of the second PUSCH determined based on a closed loop index related to a TCI configured based on the DCI and a TPC command field included in the DCI.

### Advantageous Effects of Invention

According to embodiments of the disclosure, by defining a signal transmission method of a base station in a mobile communication system in a 5G system, it is possible to achieve higher reliability of uplink transmission through transmit power control according to a configured beam.

The effects obtainable in the disclosure are not limited to the above effects, and other effects not mentioned are clearly understood from the description below by those skilled in the art.

### BRIEF DESCRIPTION OF DRAWINGS

FIG. 1 is a diagram illustrating a basic structure of a time-frequency domain which is a radio resource area where a data or control channel is transmitted in a 5G wireless communication system.

FIG. 2 is a diagram illustrating an example of a slot structure used in a 5G wireless communication system.

FIG. 3 is a diagram illustrating an example of a configuration of a bandwidth part (BWP) in a 5G wireless communication system.

FIG. 4 is a diagram illustrating an example of a control resource set where a downlink control channel is transmitted in a 5G wireless communication system.

FIG. 5 is a diagram illustrating a structure of a downlink control channel in a 5G wireless communication system.

FIG. 6 is a diagram illustrating an example of a method for configuring uplink and downlink resources in a 5G wireless communication system.

FIG. 7 is a diagram illustrating a method for determining an available slot in a 5G wireless communication system according to an embodiment of the disclosure.

FIG. 8 is a flowchart illustrating the operation of a terminal for type A PUSCH repetition transmission in a 5G wireless communication system according to an embodiment of the disclosure.

FIG. 9 is a flowchart illustrating the operation of a base station for type A PUSCH repetition transmission in a 5G wireless communication system according to an embodiment of the disclosure.

FIG. 10 is a diagram illustrating an example of PUSCH repetition type B according to an embodiment of the disclosure.

FIG. 11 is a diagram illustrating calculation of a PUSCH power control adjustment state according to an embodiment of the disclosure.

FIG. 12 is another diagram illustrating calculation of a PUSCH power control adjustment state according to an embodiment of the disclosure.

FIG. 13 is still another diagram illustrating calculation of a PUSCH power control adjustment state according to an embodiment of the disclosure.

FIG. 14 is a diagram regarding beam application that can be considered in case of using a unified TCI scheme in a wireless communication system according to an embodiment of the disclosure.

FIG. 15 is a diagram for configuring a unified TCI in case of PUSCH repetition transmission according to an embodiment of the disclosure.

FIG. 16A is a diagram illustrating an example of a power control method for a PUSCH when a unified TCI is configured during PUSCH repetition transmission according to an embodiment of the disclosure.

FIG. 16B is a diagram illustrating another example of a power control method for a PUSCH when a unified TCI is configured during PUSCH repetition transmission according to an embodiment of the disclosure.

FIG. 17A is a diagram illustrating an example of a PUSCH transmit power control method when a unified TCI is configured during PUSCH repetition transmission according to an embodiment of the disclosure.

FIG. 17B is a diagram illustrating another example of a PUSCH transmit power control method when a unified TCI is configured during PUSCH repetition transmission according to an embodiment of the disclosure.

FIG. 17C is a diagram illustrating still another example of a PUSCH transmit power control method when a unified TCI is configured during PUSCH repetition transmission according to an embodiment of the disclosure.

FIG. 18 is a flowchart illustrating the operation of a terminal for PUSCH transmit power control based on a beam change when beam configuration information is reconfigured through a unified TCI during PUSCH repetition transmission according to an embodiment of the disclosure.

FIG. 19 is a flowchart illustrating the operation of a base station for PUSCH transmit power control based on a beam change when beam configuration information is reconfigured through a unified TCI during PUSCH repetition transmission according to an embodiment of the disclosure.

FIG. 20 is a block diagram of a terminal according to an embodiment of the disclosure.

FIG. 21 is a block diagram of a base station according to an embodiment of the disclosure.

### MODE FOR THE INVENTION

Hereinafter, embodiments of the disclosure will be described in detail with reference to the accompanying drawings.

In describing embodiments of the disclosure, descriptions of technical contents well-known in the art and not directly related to the disclosure will be omitted. This is to more clearly convey the subject matter of the disclosure without obscuring it by omitting unnecessary description.

For the same reason, some elements are exaggerated, omitted, or schematically illustrated in the accompanying drawings. In addition, the depicted size of each element does not completely reflect the actual size. In the drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided to inform those skilled in the art of the scope of the disclosure, and the disclosure is defined only by the scope of the appended claims. Throughout the description herein, the same or like reference numerals designate the same or like elements. Further, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the entire description herein.

In the following description, a base station is an entity that allocates resources to terminals, and may be at least one of a gNode B, an eNode B, a Node B, a base station (BS), a wireless access unit, a BS controller, and a node on a network. A terminal may include a user equipment (UE), a mobile station (MS), a cellular phone, a smartphone, a computer, or a multimedia system capable of performing communication functions. A downlink (DL) refers to a radio link via which a base station transmits a signal to a terminal, and an uplink (UL) refers to a radio link via which a terminal transmits a signal to a base station. Further, in the following description, LTE, LTE-A or 5G systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the 5G covers the existing LTE, LTE-A, or other similar services. In addition, based on determinations by those skilled in the art, the embodiments of the disclosure may also be applied to other communication systems through some modifications without significantly departing from the scope of the disclosure.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and units may be combined into those of a smaller number of elements and units or separated into those of a larger number of elements and units. In addition, the elements and units may be implemented to operate one or more central processing units (CPUs) within a device or a secure multimedia card. Also, in embodiments, a “unit” may include one or more processors.

Wireless communication systems have expanded beyond the original role of providing a voice-oriented service and have evolved into wideband wireless communication systems that provide a high-speed and high-quality packet data service according to, for example, communication standards such as high-speed packet access (HSPA), long-term evolution (LTE or evolved universal terrestrial radio access (E-UTRA)), and LTE-Advanced (LTE-A) of 3GPP, high-rate packet data (HRPD) and a ultra-mobile broadband (UMB) of 3GPP2, and 802.16e of IEEE. In addition, 5G or NR communication standards are being established for a 5G wireless communication system.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) or a mobile station (MS) transmits data or control signals to a base station (BS or eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a communication system subsequent to LTE, must freely reflect various requirements of users, service providers, and the like, services satisfying various requirements must be supported. The services considered in the 5G communication system include enhanced Mobile Broadband (eMBB) communication, massive Machine Type Communication (mMTC), Ultra-Reliability Low-Latency Communication (URLLC), and the like.

The eMBB aims at providing a data rate higher than that supported by existing LTE, LTE-A, or LTE-Pro. For example, in the 5G communication system, the eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced Multi-Input Multi-Output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, the mMTC is being considered to support application services such as the Internet of things (IoT) in the 5G communication system. The mMTC has requirements, such as support of connection of a large number of UEs in a cell, enhancement coverage of UEs, improved battery time, a reduction in the cost of a UE, and the like, in order to effectively provide the IoT. Since the IoT provides communication functions while being provided to various sensors and various devices, it must support a large number of UEs (e.g., 1,000,000 UEs/km²) in a cell. In addition, the UEs supporting the mMTC may require wider coverage than those of other services provided by the 5G communication system because the UEs are likely to be located in a shadow area, such as a basement of a building, which is not covered by the cell due to the nature of the service. The UE supporting the mMTC must be configured to be inexpensive, and may require a very long battery life-time such as 10 to 15 years because it is difficult to frequently replace the battery of the UE.

Lastly, the URLLC, which is a cellular-based mission-critical wireless communication service, may be used for remote control for robots or machines, industrial automation, unmanned aerial vehicles, remote health care, emergency alert, and the like. Thus, the URLLC must provide communication with ultra-low latency and ultra-high reliability. For example, a service supporting the URLLC must satisfy an air interface latency of less than 0.5 ms, and also requires a packet error rate of 75 or less. Therefore, for the services supporting the URLLC, a 5G system must provide a transmit time duration (TTI) shorter than those of other services, and also may require a design for assigning a large number of resources in a frequency band in order to secure reliability of a communication link.

Three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

Hereinafter, a frame structure of the 5G system will be described in detail with reference to the drawings.

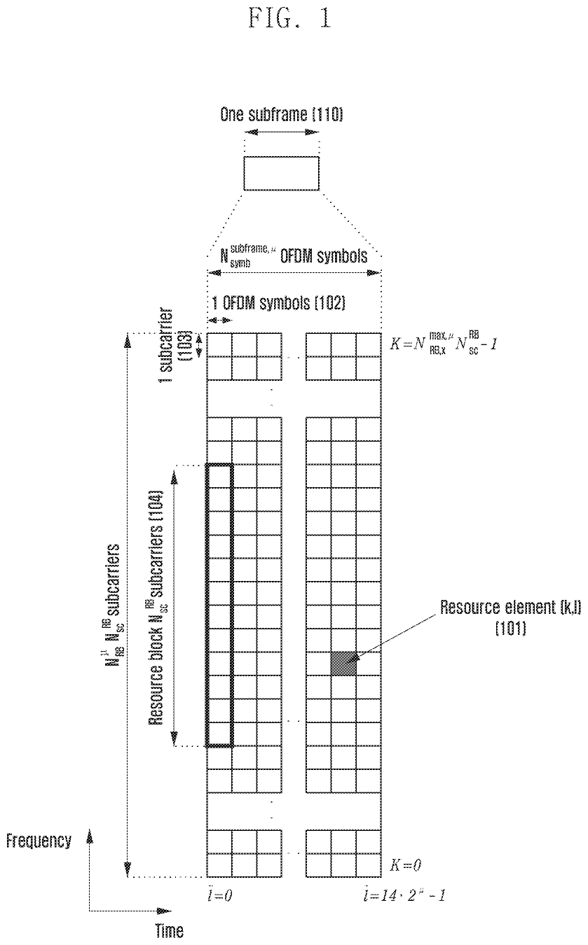

FIG. 1 is a diagram illustrating a basic structure of a time-frequency domain which is a radio resource area where a data or control channel is transmitted in a 5G wireless communication system.

With reference to FIG. 1, the horizontal axis represents a time domain, and the vertical axis represents a frequency domain. A basic unit of resources in the time-frequency domain is a resource element (RE) 101, which may be defined as one orthogonal frequency division multiplexing (OFDM) symbol 102 in the time domain and one subcarrier 103 in the frequency domain. In the frequency domain, N_{IC}^{RB} (for example, 12) consecutive REs may configure one resource block (RB) 104.

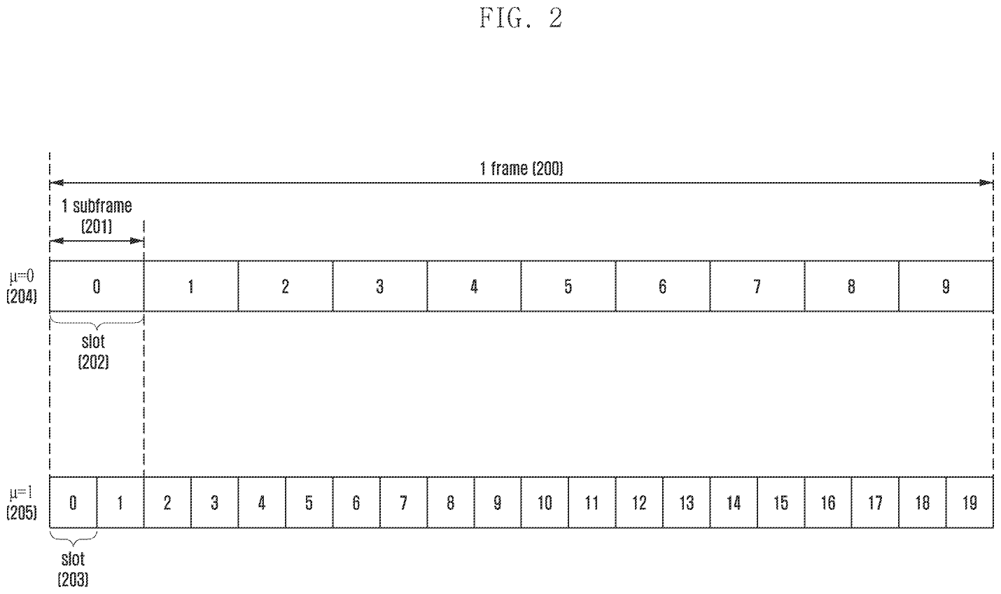

FIG. 2 is a diagram illustrating an example of a slot structure used in a 5G wireless communication system.

With reference to FIG. 2, an example of structures of a frame 200, a subframe 201, and a slot 202 is illustrated. One frame 200 may be defined as 10 ms. One subframe 201 may be defined as 1 ms, and thus the one frame 200 may be composed of ten subframes 201. One slot 202 or 203 may be defined as fourteen OFDM symbols (i.e., the number of symbols for one slot

$$( {N}_{symt}^{slot} )$$

is 14). One subframe 201 may be composed of one or multiple slots 202 and 203. The number of slots 202 and 203 per one subframe 201 may differ according to configuration value μ 204 or 205 for a subcarrier spacing. In the example of FIG. 2, subcarrier spacing configuration values μ=0 (204) and μ=1 (205) are illustrated. In the case of μ=0 (204), one subframe 201 may be composed of one slot 202. In the case of μ=1 (205), one subframe 201 may be composed of two slots 203. That is, depending on the subcarrier spacing configuration value μ, the number of slots per subframe

$$( {N}_{slot}^{subframe , μ} )$$

may vary, and the number of slots per frame

$$( {N}_{slot}^{frame , μ} )$$

may vary accordingly. The numbers

$${N}_{slot}^{subframe , μ} and {N}_{slot}^{frame , μ}$$

according to each subcarrier spacing configuration u may be defined as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, the configuration of a bandwidth part (BWP) in a 5G communication system will be described in detail with reference to the drawings.

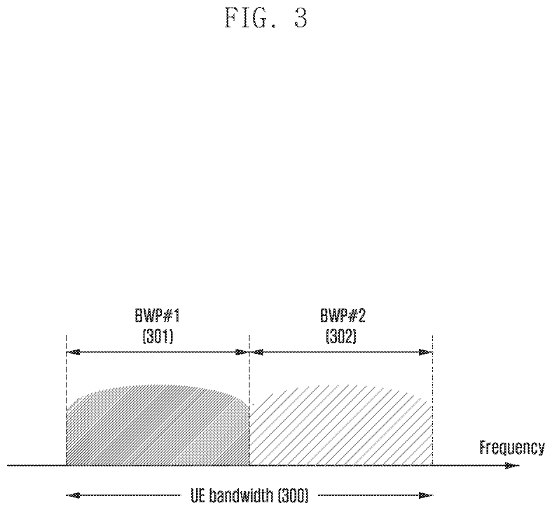

FIG. 3 is a diagram illustrating an example of a configuration of a bandwidth part (BWP) in a 5G wireless communication system.

With reference to FIG. 3, in an example shown, a UE bandwidth 300 is configured as two BWPs, that is, BWP #1 301 and BWP #2 302. A base station may configure one or multiple BWPs for a UE, and may configure information as shown in Table 2 below for each BWP.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, |
| n3, n4, n5}, | |
| (subcarrier spacing) | |
| cyclicPrefix | ENUMERATED { extended |

}
(cyclic prefix)
}

The configuration of BWP is not limited to the above example, and various parameters related to BWP may be configured for the UE in addition to the above configuration information. The configuration information may be transmitted by the base station to the UE via higher layer signaling, for example, radio resource control (RRC) signaling. At least one of configured one or multiple BWPs may be activated. Whether to activate the configured BWP may be dynamically transmitted via downlink control information (DCI) or semi-statically transmitted via RRC signaling from the base station to the UE.

According an embodiment, the UE before RRC connection may be configured with an initial BWP for initial access from the base station through a master information block (MIB). Specifically, the UE may receive configuration information about a search apace and a control resource set (CORESET) in which the PDCCH for reception of system information (which may correspond to remaining system information (RMSI) or system information block 1 (SIB 1)) required for initial access may be transmitted through the MIB in an initial access step. The CORESET and search space, which are configured through the MIB, may be regarded as identity (ID) 0, respectively. The base station may notify the UE of configuration information, such as frequency allocation information, time allocation information, and numerology for the CORESET #0, through the MIB. In addition, the base station may notify the UE of configuration information regarding the monitoring periodicity and occasion for the CORESET #0, that is, configuration information regarding the search space #0, through the MIB. The UE may regard the frequency domain configured with the CORESET #0, obtained from the MIB, as an initial BWP for initial access. Here, the ID of the initial BWP may be regarded as zero.

The configuration of the BWP supported in the 5G wireless communication system may be used for various purposes.

According to an embodiment, in the case where a bandwidth supported by the UE is less than a system bandwidth, the configuration for the BWP may be used. For example, the base station may configure, for the UE, a frequency location (configuration information 2) of the BWP to enable the UE to transmit or receive data at a specific frequency location within the system bandwidth.

In addition, according to an embodiment, the base station may configure multiple BWPs in the UE for the purpose of supporting different numerologies. For example, in order to support both data transmission/reception to/from a certain UE by using a subcarrier spacing of 15 kHz and a subcarrier spacing of 30 kHz, the base station may configure two BWPs with the subcarrier spacing of 15 kHz and the subcarrier spacing of 30 kHz, respectively. Different BWPs may be frequency division multiplexed, and when the base station attempts to transmit or receive data at a specific subcarrier spacing, the BWP configured with the corresponding subcarrier spacing may be activated.

In addition, according to an embodiment, the base station may configure, for the UE, the BWPs having bandwidths of different sizes for the purpose of reducing power consumption of the UE. For example, when the UE supports a very large bandwidth (e.g., a bandwidth of 100 MHz) and always transmits or receives data at that bandwidth, there may arise very high power consumption. In particular, when there is no traffic, monitoring on an unnecessary downlink control channel in a large bandwidth of 100 MHz may be very inefficient in terms of power consumption. Therefore, in order to reduce power consumption of the UE, the base station may configure, for the UE, a BWP of a relatively small bandwidth (e.g., a BWP of 20 MHz). In a situation without traffic, the UE may perform a monitoring operation on a BWP of 20 MHz, and when there is data to be transmitted or received, the UE may transmit or receive data in a BWP of 100 MHz in response to an indication of the base station.

In a method of configuring the BWP, the UEs before the RRC connection may receive configuration information about the initial BWP through the MIB in the initial access step. Specifically, the UE may be configured with a CORESET for a downlink control channel in which DCI for scheduling a SIB may be transmitted from a MIB of a physical broadcast channel (PBCH). The bandwidth of the CORESET configured through the MIB may be regarded as the initial BWP. Through the configured initial BWP, the UE may receive a physical downlink shared channel (PDSCH) in which the SIB is transmitted. The initial BWP may be used for other system information (OSI), paging, and random access as well as the reception of the SIB.

In the case where one or more BWPs are configured for the UE, the base station may indicate the UE to switch the BWP by using a BWP indicator field in DCI. For example, in FIG. 3, in case that the currently activated BWP of the UE is BWP #1 301, the base station may indicate BWP #2 302 to the UE by using the BWP indicator in DCI, and the UE may perform a BWP switch to the BWP #2 302 indicated by the BWP indicator in the received DCI.

As described above, since the DCI-based BWP switch may be indicated by DCI for scheduling PDSCH or PUSCH, the UE should be able to smoothly receive or transmit the PDSCH or PUSCH, which is scheduled by the DCI, without difficulty in the switched BWP when receiving a request for the BWP switch. For this purpose, the standard stipulates requirements for a delay time (T_{BWP}) required when switching the BWP, as defined in Table 3, for example.

TABLE 3

| | |
|---|---|
| NR Slot | |
| length | BWP switch delay T_{BWP} (slots) |

| μ | (ms) | Type 1^{Note 1} | Type 2^{Note 1} |
|---|---|---|---|
| 0 | 1 | [1] | [3] |
| 1 | 0.5 | [2] | [5] |
| 2 | 0.25 | [3] | [9] |
| 3 | 0.125 | [6] | [17] |

Note 1:
Depends on UE capability.
Note 2:
If the BWP switch involves changing of SCS, the BWP switch delay is determined by the larger one between the SCS before BWP switch and the SCS after BWP switch.

The requirements for the BWP switch delay time may support type 1 or type 2 depending on UE capability. The UE may report a supportable BWP delay time type to the base station.

When the UE receives the DCI including the BWP switch indicator in slot n according to the requirements for the BWP switch delay time, the UE may complete a switch to a new BWP indicated by the BWP switch indicator at a time not later than slot n+T_{BWP}, and may perform transmission and reception for a data channel scheduled by the DCI in the switched new BWP. When the base station intends to schedule the data channel to the new BWP, the base station may determine a time domain resource allocation for the data channel by considering the BWP switch delay time (T_{BWP}) of the UE. That is, when the base station schedules the data channel to the new BWP, the base station may schedule the data channel after the BWP switch delay time in a method for determining the time domain resource allocation for the data channel. Thus, the UE may not expect that the DCI indicating the BWP switch will indicate a slot offset (K0 or K2) value less than the T_{BWP}.

If the UE receives the DCI (e.g., DCI format 1_1 or 0_1) indicating the BWP switch, the UE may not perform any transmission or reception during a time duration from the third symbol of the slot in which the PDCCH including the DCI is received to the start point of the slot indicated by the slot offset (K0 or K2) value indicated by the time domain resource allocation indicator field in the DCI. For example, if the UE has received the DCI indicating the BWP switch in slot n and the slot offset value indicated by the DCI is K, the UE may not perform any transmission or reception from the third symbol of the slot n to the symbol prior to slot n+K (i.e., the last symbol of slot n+K−1).

Hereinafter, a synchronization signal (SS)/PBCH block in the 5G wireless communication system will be described.

The SS/PBCH block may refer to a physical layer channel block composed of a primary SS (PSS), a secondary SS (SSS), and a PBCH. Details are as follows.
PSS: This is a signal serving as a reference for downlink time/frequency synchronization and provides some information of a cell ID.
SSS: This is a signal serving as a reference for downlink time/frequency synchronization and provides the remaining cell ID information that is not provided by the PSS. In addition, this may serve as a reference signal for demodulation of the PBCH.
PBCH: This provides essential system information required for transmission or reception of a data channel and a control channel of the UE. The essential system information may include search space related control information indicating radio resource mapping information of a control channel, scheduling control information for a separate data channel for transmission of system information, and the like.
SS/PBCH block: This consist of a combination of the PSS, the SSS, and the PBCH. One or multiple SS/PBCH blocks may be transmitted within 5 ms, and each of the transmitted SS/PBCH blocks may be distinguished by indices.

The UE may detect the PSS and the SSS in the initial access step and may decode the PBCH. The UE may acquire the MIB from the PBCH and may be configured with CORESET #0 (which may correspond to the CORESET having the CORESET index of 0) therefrom. The UE may monitor the CORESET #0 on the assumption that a demodulation reference signal (DMRS) transmitted in the CORESET #0 and the selected SS/PBCH block is quasi-co-located (QCLed). The UE may receive system information with downlink control information transmitted in the CORESET #0. The UE may acquire, from the received system information, configuration information related to a random access channel (RACH) required for initial access. The UE may transmit a physical RACH (PRACH) to the base station by considering the selected SS/PBCH index, and the base station having received the PRACH may acquire information about the SS/PBCH block index selected by the UE. The base station may know which block is selected among the SS/PBCH blocks by the UE, and may know that the CORESET #0 associated therewith is monitored.

Next, downlink control information (DCI) in the 5G wireless communication system will be described in detail.

In the 5G system, scheduling information about uplink data (or physical uplink shared channel (PUSCH)) or downlink data (or physical downlink shared channel (PDSCH)) may be transmitted from the base station to the UE through the DCI. The UE may monitor a fallback DCI format and a non-fallback DCI format with regard to the PUSCH or the PDSCH. The fallback DCI format may include a fixed field predefined between the base station and the UE, and the non-fallback DCI format may include a configurable field.

The DCI may be transmitted through a physical downlink control channel (PDCCH) after a channel coding and modulation process. A cyclic redundancy check (CRC) may be attached to a DCI message payload, and the CRC may be scrambled by a radio network temporary identifier (RNTI) corresponding to the identity of the UE. Different RNTIs may be used according to the purpose of the DCI message, for example, a UE-specific data transmission, a power adjustment command, or a random access response. That is, the RNTI is not explicitly transmitted, but is included in a CRC calculation process and then transmitted. Upon receiving the DCI message transmitted through the PDCCH, the UE may check the CRC by using an assigned RNTI. If a CRC check result is correct, the UE can know that the corresponding message has been transmitted to the UE.

For example, the DCI for scheduling the PDSCH for system information (SI) may be scrambled by an SI-RNTI. The DCI for scheduling the PDSCH for a random access response (RAR) message may be scrambled by an RA-RNTI. The DCI for scheduling the PDSCH for a paging message may be scrambled by a P-RNTI. The DCI for notifying a slot format indicator (SFI) may be scrambled by an SFI-RNTI. The DCI for notifying a transmit power control (TPC) may be scrambled by a TPC-RNTI. The DCI for scheduling the UE-specific PDSCH or PUSCH may be scrambled by a cell RNTI (C-RNTI), a modulation coding scheme C-RNTI (MCS-C-RNTI), or a configured scheduling RNTI (CS-RNTI).

The DCI format 0_0 may be used as a fallback DCI for scheduling the PUSCH. In this case, the CRC may be scrambled by the C-RNTI. The DCI format 0_0 in which the CRC is scrambled by the C-RNTI may include, for example, information in Table 4.

```
TABLE 4
- Identifier for DCI formats - 1 bit
  - The value of this bit field is always set to 0, indicating an UL DCI format
-  $Frequency domain resource assignment - ⌈ {log}_{1} ( N \text{?} + 1 ) / 2 ) ⌉ bits where N \text{?}$
  is defined in subclause 7.3.1,0
  - For PUSCH hopping with resource allocation type 1:
    - N [symbol]   MSB bits are used to indicate the frequency offset according to Subclause
      6.3 of [6, TS 38.214], where N [symbol]    = 1 if the higher layer parameter
      frequencyHoppingOffsetLists contains two offset values and N [symbol]   = 2 if the higher
      layer parameter frequencyHoppingOffsetLists contains four offset values
    -  $⌈ {log}_{2} ( N \text{?} + 1 ) / 2 ) ⌉ - N \text{?} bits provides the frequency domain resource$
      allocation according to Subclause 6.1.2.2.2 of [6, TS 38.214]
  - For non-PUSCH hopping with resource allocation type 1:
    -  $⌈ {log}_{2} ( N \text{?} ( N \text{?} + 1 ) / 2 ) ⌉ bits provides the frequency domain resource allocation$
      according to Subclause 6.1.2.2.2 of [6, TS 38.214]
-  Time domain resource assignment - 4 bits as defined in Subclause 6.1.2.1 of [6, TS
    38.214]
- Frequency hopping flag - 1 bit according to Table 7.3.1.1.1-3, as defined in Subclause 6.3
    of [6, TS 38.214]
- Modulation and coding scheme - 5 bits as defined in Subclause 6.1.4.1 of [6, TS 38.214]
- New data indicator - 1 bit
- Redundancy version - 2 bits as defined in Table 7.3.1.1.1-2
- HARQ process number - 4 bits
- TPC command for scheduled PUSCH - 2 bits as defined in Subclause 7.1.1 of [5, TS
    38.213]
- Padding bits, if required.
- UL/SUL indicator - 1 bit for UEs configured with supplementaryUplink in
    ServingCellConfig in the cell as defined in Table 7.3.1.1.1-1 and the number of bits for
    DCI format 1_0 before padding is larger than the number of bits for DCI format 0_0
    before padding; 0 bit otherwise. The UL/SUL indicator, if present, locates in the last bit
    position of DCI format 0_0, after the padding bit(s).
- If the UL/SUL indicator is present in DCI format 0_0 and the higher layer parameter
    pusch-Config is not configured on both UL and SUL the UE ignores the UL/SUL
    indicator field in DCI format 0_0, and the corresponding PUSCH scheduled by the DCI
    format 0_0 is for the UL or SUL for which high layer parameter pucch-Config is
    configured:
- If the UL/SUL indicator is not present in DCI format 0_0 and pucch-Config is
    configured, the corresponding PUSCH scheduled by the DCI format 0_0 is for the UL
    or SUL for which high layer parameter pucch-Config is configured.
- If the UL/SUL indicator is not present in DCI format 0_0 and pucch-Config is not
    configured, the corresponding PUSCH scheduled by the DCI format 0_0 is for the
    uplink on which the latest PRACH is transmitted. [symbol]
indicates data missing or illegible when filed
```

The DCI format 0_1 may be used as a non-fallback DCI for scheduling the PUSCH. In this case, the CRC may be scrambled by the C-RNTI. The DCI format 0_1 in which the CRC is scrambled by the C-RNTI may include, for example, information in Table 5.

```
TABLE 5
- Identifier for DCI formats - 1 bit
  - The value of this bit field is always set to 0, indicating an UL DCI format
- Carrier indicator - 0 or 3 bits, as defined in Subclause 10.1 of [5, TS38.213].
- UL/SUL indicator - 0 bit for UEs not configured with supplementaryUplink in
    ServingCellConfig in the cell or UEs configured with supplementaryUplink in
    ServingCellConfig in the cell but only PUCCH carrier in the cell is configured for PUSCH
    transmission, otherwise, 1 bit as defined in Table 7:3.1.1.1-1.
- Bandwidth part indicator - 0, 1 or 2 bits as determined by the number of UL BWPs
    n [symbol]   configured by higher layers, excluding the initial UL bandwidth part. The bitwidth
    for this field is determined as ┌log₂(n [symbol]  )┐ bits, where
  - n [symbol]   = n [symbol]   +1 if n [symbol]    ≤3, in which case the bandwidth part indicator is equivalent
    to the ascending order of the higher layer parameter BWP-Id;
  - otherwise n [symbol]   in which case the bandwidth part indicator is defined in Table
    7.3.1.1.2-1;
  If a UE does not support active BWP change via DCI, the UE ignores this bit field.
- Frequency domain resource assignment - number of bits determined by the following,
  $where N \text{?} is the size of the active UL bandwidth part :$
  - N [symbol]   bits if only resource allocation type 0 is configured, where N [symbol]   is defined in
    Subclause 6.1.2.2.1 of [6, TS 38.214],
  -  $⌈ {log}_{2} ( N \text{?} ( N \text{?} + 1 ) / 2 ) ⌉ bits if only resource allocation type 1 is configured , or$
    $max ( ⌈ {log}_{2} ( N \text{?} ( N \text{?} + 1 ) / 2 ) ⌉ , N \text{?} ) + 1 bits if both resource allocation type 0 and$
    1 are configured.
  - If both resource allocation type 0 and 1 are configured, the MSB bit is used to indicate
    resource allocation type 0 or resource allocation type 1, where the bit value of 0
    indicates resource allocation type 0 and the bit value of 1 indicates resource allocation
    type 1.
  - For resource allocation type 0, the N [symbol]   LSBs provide the resource allocation as
    defined in Subclause 6.1.2.2.1 of [6, TS 38.214].
  -  $For resource allocation type 1 , the ⌈ {log}_{2} ( N \text{?} ( N \text{?} + 1 ) / 2 ) ⌉ LSBs provide the$
    resource allocation as follows:
    - For PUSCH hopping with resource allocation type 1:
      - N [symbol]   MSB bits are used to indicate the frequency offset according to Subclause
        6.3 of [6, TS 38.214], where N [symbol]   = 1 if the higher layer parameter
        frequencyHoppingOffsetLists contains two offset values and N [symbol]   = 2 if the
        higher layer parameter frequencyHoppingOffsetLists contains four offset values
      -  $⌈ {log}_{2} ( N \text{?} ( N \text{?} + 1 ) / 2 ) ⌉ - N \text{?} bits provides the frequency domain resource$
        allocation according to Subclause 6.1.2.2.2 of [6, TS 38.214]
    - For non-PUSCH hopping with resource allocation type 1:
      -  $⌈ {log}_{2} ( N \text{?} ( N \text{?} + 1 ) / 2 ) ⌉ bits provides the frequency domain resource$
        allocation according to Subclause 6.1.2.2.2 of [6, TS 38.214]
    If “Bandwidth part indicator” field indicates a bandwidth part other than the active
    bandwidth part and if both resource allocation type 0 and 1 are configured for the
    indicated bandwidth part, the UE assumes resource allocation type 0 for the indicated
    bandwidth part if the bitwidth of the “Frequency domain resource assignment” field of
    the active bandwidth part is smaller than the bitwidth of the “Frequency domain
    resource assignment” field of the indicated bandwidth part.
  - Time domain resource assignment - 0, 1, 2, 3, or 4 bits as defined in Subclause 6.1.2.1 of
    [6, TS38.214]. The bitwidth for this field is determined as ┌log₂(I)┐] bits, where I is the
    number of entries in the higher layer parameter pusch-TimeDomainAllocationList if the
    higher layer parameter is configured; otherwise I is the number of entries in the default
    table.
  - Frequency hopping flag - 0 or 1 bit:
      - 0 bit if only resource allocation type 0 is configured or if the higher layer parameter
        frequencyHopping is not configured;
      - 1 bit according to Table 7.3.1.1.1-3 otherwise, only applicable to resource allocation
        type 1, as defined in Subclause 6.3 of [6, TS 38.214].
  - Modulation and coding scheme - 5 bits as defined in Subclause 6.1.4.1 of [6, TS 38.214]
  - New data indicator - 1 bit
  - Redundancy version - 2 bits as defined in Table 7.3.1.1.1-2
  - HARQ process number - 4 bits
  - 1^{st} downlink assignment index - 1 or 2 bits:
      - 1 bit for semi-static HARQ-ACK codebook;
      - 2 bits for dynamic HARQ-ACK codebook.
  - 2^{nd} downlink assignment index - 0 or 2 bits:
      - 2 bits for dynamic HARQ-ACK codebook with two HARQ-ACK sub-codebooks;
      - 0 bit otherwise.
  - TPC command for scheduled PUSCH - 2 bits as defined in Subclause 7.1.1 of (5,
    TS38.213]
  -  $SRS resource indicator - ⌈ {log}_{2} ( \text{?} ( \text{?} ) ) ⌉ or ⌈ {log}_{2} ( N \text{?} ) ⌉ bits , where N \text{?} is$
    the number of configured SRS resources in the SRS resource set associated with the
    higher layer parameter usage of value ‘codeBook’ or ‘nonCodeBook’.
      -  $⌈ {log}_{2} ( \text{?} ( \text{?} ) ) ⌉ bits according to Tables 7.3 \text{.1} \text{.1} \text{.2} - 28 / 29 / 30 / 31 if the higher$
        layer parameter txConfig = nonCodebook, where N [symbol]   is the number of configured
      SRS resources in the SRS resource set associated with the higher layer parameter usage
      of value ‘nonCodeBook’ and
      - if UE supports operation with maxMIMO-Layers and the higher layer parameter
        maxMIMO-Layers of PUSCH-ServingCellConfig of the serving cell is configured,
        Lₘₐₓ is given by that parameter
      - otherwise, Lₘₐₓ is given by the maximum number of layers for PUSCH supported by
        the UE for the serving cell for non-codebook based operation.
      - ┌logᵢ (N [symbol]   )] bits according to Tables 7.3.1.1.2-32 if the higher layer parameter
      txConfig = codebook, where N [symbol]   is the number of configured SRS resources in the
      SRS resource set associated with the higher layer parameter usage of value ‘codeBook’.
  - Precoding information and number of layers - number of bits determined by the following:
      - 0 bits if the higher layer parameter txConfig = nonCodeBook;
      - 0 bits for 1 antenna port and if the higher layer parameter txConfig = codebook;
      - 4, 5, or 6 bits according to Table 7.3.1.1.2-2 for 4 antenna ports, if txConfig =
        codebook, and according to whether transform precoder is enabled or disabled, and the
        values of higher layer parameters maxRank, and codebookSubset;
      - 2, 4, or 5 bits according to Table 7.3.1.1.2-3 for 4 antenna ports, if txConfig =
        codebook, and according to whether transform precoder is enabled or disabled, and the
        values of higher layer parameters maxRank, and codebookSubset;
      - 2 or 4 bits according to Table 7.3.1.1.2-4 for 2 antenna ports, if txConfig = codebook,
        and according to whether transform precoder is enabled or disabled, and the values of
        higher layer parameters maxRank and codebookSubset;
      -  1 or 3 bits according to Table 7.3.1.1.2-5 for 2 antenna ports, if txConfig = codebook
        and according to whether transform precoder is enabled or disabled, and the values of
        higher layer parameters maxRank and codebookSubset.
  - Antenna ports - number of bits determined by the following
      - 2 bits as defined by Tables 7.3.1.1.2-6, if transform precoder is enabled, dmrs-Type = 1,
        and maxLength = 1;
      - 4 bits as defined by Tables 7.3.1.1.2-7, if transform precoder is enabled, dmrs-Type = 1,
        and maxLength = 2;
      - 3 bits as defined by Tables 7.3.1.1.2-8/9/10/11, if transform precoder is disabled
        dmrs-Type = 1, and maxLength = 1, and the value of rank is determined according to the
        SRS resource indicator field if the higher layer parameter txConfig = nonCodebook and
        according to the Precoding information and number of layers field if the higher layer
        parameter txConfig = codebook;
      - 4 bits as defined by Tables 7.3.1.1.2-12/13/14/15, if transform precoder is disabled,
        dmrs-Type = 1, and maxLength = 2, and the value of rank is determined according to the
        SRS resource indicator field if the higher layer parameter ixConfig = nonCodebook and
        according to the Precoding information and number of layers field if the higher layer
        parameter (xConfig = codebook;
      - 4 bits as defined by Tables 7.3.1.1.2-16/17/18/19, if transform precoder is disabled,
        dmrs-Type = 2, and maxLength = 1, and the value of rank is determined according to the
        SRS resource indicator field if the higher layer parameter txConfig = nonCodebook and
        according to the Precoding information and number of layers field if the higher layer
        parameter txConfig = codebook;
      - 5 bits as defined by Tables 7.3.1.1.2-20/21/22/23, if transform precoder is disabled.
        dmrs-Type = 2, and maxLength = 2, and the value of rank is determined according to the
        SRS resource indicator field if the higher layer parameter txConfig = nonCodebook and
        according to the Precoding information and number of layers field if the higher layer
        parameter txConfig = codebook.
  where the number of CDM groups without data of values 1, 2, and 3 in Tables 7.3.1.1.2-6
  to 7.3.1.1.2-23 refers to CDM groups {0}, {0,1]}, and {0, 1,2} respectively.
  If a UE is configured with both dmrs-UplinkForPUSCH-Mapping TypeA and
  dmrs-UplinkForPUSCH-MappingTypeB, the bitwidth of this field equals max
  where x [symbol]   is the “Antenna ports” bitwidth derived according to
  dmrs-UplinkForPUSCH-MappingTypeA and x [symbol]    is the “Antenna ports” bitwidth derived
  according to dmrs-UplinkForPUSCH-MappingTypeB. A number of |x_{_{A}}− x_{_{B}}| zeros are
  padded in the MSB of this field, if the mapping type of the PUSCH corresponds to the
  smaller value of xₐ and x_{b}.
- SRS request - 2 bits as defined by Table 7.3.1.1.2-24 for UEs not configured with
    supplementaryUplink in ServingCellConfig in the cell; 3 bits for UEs configured with
    supplementaryUplink in ServingCellConfig in the cell where the first bit is the
    non-SUL/SUL indicator as defined in Table 7.3.1.1.1-1 and the second and third bits are
    defined by Table 7.3.1.1.2-24. This bit field may also indicate the associated CSI-RS
    according to Subclause 6.1.1.2 of [6, TS 38.214].
-  CSI request - 0, 1, 2, 3, 4, 5, or 6 bits determined by higher layer parameter
    reportTriggerSize.
-  CBG transmission information (CBGTI) - 0 bit if higher layer parameter
    codeBlockGroupTransmission for PDSCH is not configured, otherwise, 2, 4, 6, or 8 bits
    determined by higher layer parameter maxCodeBlockGroupsPerTransportBlock for
    PUSCH.
-  PTRS-DMRS association - number of bits determined as follows
    - 0 bit if PTRS-UplinkConfig is not configured and transform precoder is disabled, or if
    transform precoder is enabled, or if maxRank = I;
    - 2 bits otherwise, where Table 7.3.1.1.2-25 and 7.3.1.1.2-26 are used to indicate the
    association between PTRS port(s) and DMRS port(s) for transmission of one PT-RS
    port and two PT-RS ports respectively, and the DMRS ports are indicated by the
    Antenna ports field.
    If “Bandwidth part indicator” field indicates a bandwidth part other than the active
    bandwidth part and the “PTRS-DMRS association” field is present for the indicated
    bandwidth part but not present for the active bandwidth part, the UE assumes the
    “PTRS-DMRS association” field is not present for the indicated bandwidth part.
-  beta_offset indicator - 0 if the higher layer parameter betaOffsets = semiStatic; otherwise
    2 bits as defined by Table 9.3-3 in [5, TS 38.213].
- DMRS sequence initialization - 0 bit if transform precoder is enabled; 1 bit if transform
    precoder is disabled.
- UL-SCH indicator − 1 bit A value of “1” indicates UL-SCH shall be transmitted on the
    PUSCH and a value of “0” indicates UL-SCH shall not be transmitted on the PUSCH.
    Except for DCI format 0_1 with CRC scrambled by SP-CSI-RNTI, a UE is not expected
    to receive a DCI format 0_1 with UL-SCH indicator of “0” and CSI request of all zero(s). [symbol]
indicates data missing or illegible when filed
```

The DCI format 1_0 may be used as a fallback DCI for scheduling the PDSCH. In this case, the CRC may be scrambled by the C-RNTI. The DCI format 1_0 in which the CRC is scrambled by the C-RNTI may include, for example, information in Table 6.

```
TABLE 6
-  Identifier for DCI formats - 1 bits
    - The value of this bit field is always set to 1, indicating a DL DCI format
-  $Frequency domain resource assignment - ⌈ {log}_{2} ( N \text{?} ( N \text{?} + 1 ) / 2 ) ⌉ bits where \text{?} N \text{?}$
    is given by subclause 7.3.1.0
If the CRC of the DCI format 1_0 is scrambled by C-RNTI and the “Frequency domain
resource assignment” field are of all ones, the DCI format 1_0 is for random access
procedure initiated by a PDCCH order, with all remaining fields set as follows:
-  Random Access Preamble index - 6 bits according to ra-PreambleIndex in Subclause 5.1.2
    of [8, TS38.321]
-  UL/SUL indicator - 1 bit. If the value of the “Random Access Preamble index” is not all
    zeros and if the UE is configured with supplementaryUplink in ServingCellConfig in the
    cell, this field indicates which UL carrier in the cell to transmit the PRACH according to
    Table 7.3.1.1.1-1; otherwise, this field is reserved
-  SS/PBCH index - 6 bits. If the value of the “Random Access Preamble index” is not all
    zeros, this field indicates the SS/PBCH that shall be used to determine the RACH
    occasion for the PRACH transmission; otherwise, this field is reserved.
-  PRACH Mask index - 4 bits. If the value of the “Random Access Preamble index” is not
    all zeros, this field indicates the RACH occasion associated with the SS/PBCH indicated
    by “SS/PBCH index” for the PRACH transmission, according to Subclause 5.1.1 of [8,
    TS38.321]; otherwise, this field is reserved
- Reserved bits - 10 bits
Otherwise, all remaining fields are set as follows:
- Time domain resource assignment - 4 bits as defined in Subclause 5.1.2.1 of [6, TS
    38.214]
- VRB-to-PRB mapping - 1 bit according to Table 7.3.1.2.2-5
- Modulation and coding scheme - 5 bits as defined in Subclause 5.1.3 of [6, TS 38.214]
- New data indicator - 1 bit
- Redundancy version - 2 bits as defined in Table 7.3.1.1.1-2
- HARQ process number - 4 bits
- Downlink assignment index - 2 bits as defined in Subclause 9.1.3 of [5, TS 38.213], as
    counter DAI
- TPC command for scheduled PUCCH - 2 bits as defined in Subclause 7.2.1 of [5, TS
    38.213]
- PUCCH resource indicator - 3 bits as defined in Subclause 9.2.3 of [5, TS 38,213]
- PDSCH-to-HARQ_feedback timing indicator - 3 bits as defined in Subclause 9.2.3 of [5,
    TS38.213]
```

The DCI format 1_1 may be used as a non-fallback DC for scheduling the PDSCH. In this case, the CRC may be scrambled by the C-RNTI. The DCI format 1_1 in which the CRC is scrambled by the C-RNTI may include, for example, information in Table 7.

```
TABLE 7
- Identifier for DCI formats - 1 bits
    - The value of this bit field is always set to 1, indicating a DL DCI format
- Carrier indicator - 0 or 3 bits as defined in Subclause 10.1 of [5, TS 38.213].
- Bandwidth part indicator - 0, 1 or 2 bits as determined by the number of DL BWPs
    n [symbol]   configured by higher layers, excluding the initial DL bandwidth part. The bitwidth
    for this field is determined as ┌log₂(n [symbol]   )┐ bits, where
    - n [symbol]    = n [symbol]   +1 if n [symbol]   ≤ 3, in which case the bandwidth part indicator is equivalent
    to the ascending order of the higher layer parameter BWP-Id;
    - otherwise n [symbol]   = n [symbol]   , in which case the bandwidth part indicator is defined in Table
    7.3.1.1.2-1;
    If a UE does not support active BWP change via DCI, the UE ignores this bit field.
-  Frequency domain resource assignment - number of bits determined by the following,
    where N [symbol]   is the size of the active DL bandwidth part:
    - N [symbol]    bits if only resource allocation type 0 is configured, where N [symbol]   is defined in
    Subclause 5.1.2.2.1 of [6, TS38.214],
    -  $⌈ log \text{?} ( N \text{?} ( N \text{?} + 1 ) / 2 ) ⌉ bits if only resource allocation type 1 is configured , or$
    -  $max ( ⌈ {log}_{2} ( N \text{?} ( N \text{?} + 1 ) / 2 ) ⌉ , N \text{?} ) + 1 bits if both resource allocation type 0 and$
      1 are configured.
    - If both resource allocation type 0 and 1 are configured, the MSB bit is used to indicate
      resource allocation type 0 or resource allocation type 1, where the bit value of 0
      indicates resource allocation type 0 and the bit value of 1 indicates resource allocation
      type 1.
    - For resource allocation type 0, the N [symbol]   LSBs provide the resource allocation as
      defined in Subclause 5.1.2.2.1 of [6, TS 38.214].
    -  $For resource allocation type 1 , the ⌈ {log}_{2} ( N \text{?} ( N \text{?} + 1 ) / 2 ) ⌉ LSBs provide the$
      resource allocation as defined in Subclause 5.1.2.2.2 of [6, TS 38.214]
    If “Bandwidth part indicator” field indicates a bandwidth part other than the active
    bandwidth part and if both resource allocation type 0 and 1 are configured for the
    indicated bandwidth part, the UE assumes resource allocation type 0 for the indicated
    bandwidth part if the bitwidth of the “Frequency domain resource assignment” field of the
    active bandwidth part is smaller than the bitwidth of the “Frequency domain resource
    assignment” feld of the indicated bandwidth part.
-  Time domain resource assignment - 0, 1, 2, 3, or 4 bits as defined in Subclause 5.1.2.1 of
    [6, TS 38,214]. The bitwidth for this field is determined as ┌log₂(I)┐ bits, where I is the
    number of entries in the higher layer parameter pdsch-TimeDomainAllocationList if the
    higher layer parameter is configured; otherwise I is the number of entries in the default
    table.
-  VRB-to-PRB mapping - 0 or 1 bit:
    - 0 bit if only resource allocation type 0 is configured or if interleaved VRB-to-PRB
    mapping is not configured by high layers;
    - 1 bit according to Table 7.3.1.2.2-5 otherwise, only applicable to resource allocation
    type 1, as defined in Subclause 7.3.1.6 of [4, TS 38.211].
-  PRB bundling size indicator - 0 bit if the higher layer parameter prb-BundlingType is not
    configured or is set to ‘static’, or 1 bit if the higher layer parameter prb-BundlingType is
    set to ‘dynamic’ according to Subclause 5.1.2.3 of [6, TS 38.214].
- Rate matching indicator - 0, 1, or 2 bits according to higher layer parameters
    rateMatchPatternGroup1 and rataMatchPatternGroup2, where the MSB is used to
    indicate rateMatchPatternGroup1 and the LSB is used to indicate
    rateMatchPatternGroup2 when there are two groups.
- ZP CSI-RS trigger - 0, 1, or 2 bits as defined in Subclause 5.1.4.2 of [6, TS 38.214]. The
    bitwidth for this field is determined as ┌log₂ (n [symbol]   + 1)┐ bits, where n [symbol]   is the number of
    aperiodic ZP CSI-RS resource sets configured by higher layer.
For transport block 1:
    - Modulation and coding scheme - 5 bits as defined in Subclause 5.1.3.1 of [6, TS
    38.214]
    - New data indicator - 1 bit
    - Redundancy version - 2 bits as defined in Table 7.3.1.1.1-2
For transport block 2 (only present if maxNrofCodeWordsScheduledByDCI equals 2):
    - Modulation and coding scheme - 5 bits as defined in Subclause 5.1.3.1 of [6, TS
    38.214]
    - New data indicator- 1 bit
    - Redundancy version - 2 bits as defined in Table 7.3.1.1.1-2
    If “Bandwidth part indicator” field indicates a bandwidth part other than the active
    bandwidth part and the value of maxNrofCodeWordsScheduledByDCI for the indicated
    bandwidth part equals 2 and the value of maxNrofCodeWordsScheduledByDCI for the
    active bandwidth part equals 1, the UE assumes zeros are padded when interpreting the
    “Modulation and coding scheme”, “New data indicator”, and “Redundancy version” fields
    of transport block 2 according to Subclause 12 of [5, TS38.213], and the UE ignores the
    “Modulation and coding scheme”, “New data indicator”, and “Redundancy version” fields
    of transport block 2 for the indicated bandwidth part.
- HARQ process number - 4 bits
- Downlink assignment index - number of bits as defined in the following
    - 4 bits if more than one serving cell are configured in the DL and the higher layer
      parameter pdsch-HARQ-ACK-Codebook=dynamic, where the 2 MSB bits are the
      counter DAI and the 2 LSB bits are the total DAI;
    - 2 bits if only one serving cell is configured in the DL and the higher layer parameter
      pdsch-HARQ-ACK-Codebook=dynamic, where the 2 bits are the counter DAI;
    - 0 bits otherwise.
- TPC command for scheduled PUCCH - 2 bits as defined in Subclause 7.2.1 of [5, TS
    38.213]
- PUCCH resource indicator - 3 bits as defined in Subclause 9.2.3 of [5, TS 38.213]
- PDSCH-to-HARQ_feedback timing indicator - 0, 1, 2, or 3 bits as defined in Subclause
    9.2.3 of [5, TS 38.213]. The bitwidth for this field is determined as ┌log₂ (I)┐] bits, where I is
    the number of entries in the higher layer parameter dl-DataToUL-ACK.
- Antenna port(s) - 4, 5, or 6 bits as defined by Tables 7.3.1.2.2-1/2/3/4, where the number
    of CDM groups without data of values 1, 2, and 3 refers to CDM groups {0}, {0.1}, and
    {0, 1,2} respectively. The antenna ports {p [symbol]   p [symbol]   } shall be determined according to the
    ordering of DMRS port(s) given by Tables 7.3.1.2.2-1/2/3/4.
    If a UE is configured with both dmrs-DownlinkForPDSCH-Mapping TypeA and
    dmrs-DownlinkForPDSCH-MappingTypeB, the bitwidth of this field equals max(x [symbol]   ,x [symbol]   ),
    where x₂ is the “Antenna ports” bitwidth derived according to
    dmrs-DownlinkForPDSCH-MappingTypeA and x₂ is the “Antenna ports” bitwidth
    derived according to dmrs-DownlinkForPDSCH-MappingTypeB. A number of |x_{A} - x_{B}|
    zeros are padded in the MSB of this field, if the mapping type of the PDSCH corresponds
    to the smaller value of x [symbol]   and x [symbol]   .
- Transmission configuration indication - 0 bit if higher layer parameter tci-PresentInDCI is
    not enabled; otherwise 3 bits as defined in Subclause 5.1.5 of [6, TS38.214].
    If “Bandwidth part indicator” field indicates a bandwidth part other than the active
    bandwidth part,
  - if the higher layer parameter tci-PresentInDCI is not enabled for the CORESET used
    for the PDCCH carrying the DCI format 1_1,
    - the UE assumes tci-PresentInDCI is not enabled for all CORESETs in the indicated
        bandwidth past;
  - otherwise,
    - the UE assumes tci-PresentInDCI is enabled for all CORESETs in the indicated
        bandwidth part.
- SRS request - 2 bits as defined by Table 7.3.1.1.2-24 for UEs not configured with
    supplementaryUplink in ServingCellConfig in the cell; 3 bits for UEs configured with
    supplementary Uplink in ServingCellConfig in the cell where the first bit is the
    non-SUL/SUL indicator as defined in Table 7.3.1.1.1-1 and the second and third bits are
    defined by Table 7.3.1.1.2-24. This bit field may also indicate the associated CSI-RS
    according to Subclause 6.1.1.2 of [6, TS 38.214].
- CBG transmission information (CBGTI) - 0 bit if higher layer parameter
    codeBlockGroupTransmission for PDSCH is not configured, otherwise, 2, 4, 6, or 8 bits
    as defined in Subclause 5.1.7 of [6, TS38.214], determined by the higher layer parameters
    maxCodeBlockGroupsPerTransportBlock and maxNrofCodeWordsScheduledByDCI for
    the PDSCH.
- CBG flushing out information (CBGFI) - 1 bit if higher layer parameter
    codeBlockGroupFlushindicator is configured as “TRUE”, 0 bit otherwise.
- DMRS sequence initialization - 1 bit. [symbol]
indicates data missing or illegible when filed
```

Hereinafter, a time domain resource allocation method for data channels in the 5G wireless communication system will be described.

The base station may configure, for the UE, a table about time domain resource allocation information for a downlink data channel (PDSCH: physical downlink shared channel) and an uplink data channel (PUSCH: physical uplink shared channel) through higher layer signaling (e.g., RRC signaling). For the PDSCH, a table consisting of up to maxNrofDL-Allocations=16 entries can be configured, and for the PUSCH, a table consisting of up to maxNrofUL-Allocations=16 entries can be configured. The time domain resource allocation information may include, for example, PDCCH-to-PDSCH slot timing (which corresponds to the time duration in slot units between the time when the PDCCH is received and the time when the PDSCH scheduled by the received PDCCH is transmitted, and is denoted as K0), PDCCH-to-PUSCH slot timing (which corresponds to the time duration in slot units between the time when the PDCCH is received and the time when the PUSCH scheduled by the received PDCCH is transmitted, and is denoted as K2), information about the location and length of a start symbol where the PDSCH or PUSCH is scheduled within a slot, mapping type of the PDSCH or PUSCH, and the like. For example, information such as Table 8 and Table 9 below may be notified from the base station to the UE.

TABLE 8
PDSCH-TimeDomainResourceAllocationList information element

PDSCH-TimeDomainResourceAllocationList ::= SEQUENCE
(SIZE(1..maxNrofDL-Allocations)) OF PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S
(PDCCH-to-PDSCH timing, slot units)

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 9
PUSCH-TimeDomainResourceAllocation information element

PUSCH-TimeDomainResourceAllocationList ::= SEQUENCE
(SIZE(1..maxNrofUL-Allocations)) OF PUSCH-TimeDomainResourceAllocation
PUSCH-TimeDomainResourceAllocation ::= SEQUENCE {

| | |
|---|---|
| k2 | INTEGER(0..32) OPTIONAL, |

-- Need S
(PDCCH-to-PUSCH timing, slot units)

| | |
|---|---|
| mappingType | ENUMERATED {typeA, typeB}, |

(PUSCH mapping type)

| | |
|---|---|
| startSymbolAndLength | INTEGER (0..127) |

(start symbol and length of PUSCH)
}

The base station may notify one of the entries in the table about time domain resource allocation information to the UE through L1 signaling (e.g., DCI) (e.g., it may be indicated in the ‘time domain resource allocation’ field in DCI). The UE may acquire the time domain resource allocation information for the PDSCH or PUSCH based on the DCI received from the base station. Hereinafter, a frequency domain resource allocation method for data channels in the 5G wireless communication system will be described.

In the 5G wireless communication system, two types, that is, resource allocation type 0 and resource allocation type 1 are supported as a method for indicating frequency domain resource allocation information for a downlink data channel (PDSCH: physical downlink shared channel) and an uplink data channel (PUSCH: physical uplink shared channel).

### Resource Allocation Type 0

RB allocation information may be notified from the base station to the UE in the form of a bitmap for a resource block group (RBG). In this case, the RBG may be composed of a set of consecutive virtual RBs (VRBs), and the size of the RBG, P, may be determined based on a value configured via higher layer parameter (rbg-Size) and a value of a bandwidth part size defined in Table 10 below.

TABLE 10
Nominal RBG size P

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The total number (N_{RBG}) of RBGs of a bandwidth part i having a size of

$${N}_{BWP , i}^{size}$$

can be defined as follows.

$$◼ {N}_{RBG} = ⌈ ( {N}_{BWP , i}^{size} + ( {N}_{BWP , i}^{start} mod P ) ) / P ⌉ ,$$

where
the size of the first RBG is

$$R B {G}_{0}^{size} = P - {N}_{BWP , i}^{start} mod P ,$$

the size of last RBG is

$$R B {G}_{last}^{size} = ( {N}_{BWP , i}^{start} + {N}_{BWP , i}^{size} ) mod P if ( {N}_{BWP , i}^{start} + {N}_{BWP , i}^{size} ) mod P > 0$$

and P otherwise,
the size of all other RBGs is P.
Each bit of a bitmap having a N_{RBG} bit size may correspond to each RBG. RBGs may be indexed in order of increasing frequency, starting from the lowest frequency position of the bandwidth part. For N_{RBG} RBGs in the bandwidth part, RBG #0 to RBG #(N_{RBG}−1) may be mapped from the MSB to LSB of the RBG bitmap. If a specific bit value in the bitmap is 1, the UE may determine that the RBG corresponding to the bit value has been allocated. If a specific bit value in the bitmap is 0, the UE may determine that the RBG corresponding to the bit value has not been allocated.

### Resource Allocation Type 1

RB allocation information may be notified from the base station to the UE as information on the start position and length of sequentially allocated VRBs. In this case, interleaving or non-interleaving may be additionally applied to the sequentially allocated VRBs. The resource allocation field of the resource allocation type 1 may be composed of a resource indicator value (RIV), and the RIV may be composed of the start point (RBₛₜₐᵣₜ) of the VRB and the length (L_{RBs}) of the sequentially allocated RB. Specifically, the RIV within a bandwidth part having a size of

$${N}_{BWP}^{size}$$

can be defined as follows.

$$◼ if ( {L}_{RBs} - 1 ) \leq ⌊ {N}_{BWP}^{size} / 2 ⌋ then$$

$$◆ R I V = {N}_{BWP}^{size} ( {L}_{RBs} - 1 ) + R {B}_{start}$$

else

$$◆ R I V = {N}_{BWP}^{size} ( {N}_{BWP}^{size} - {L}_{RBs} + 1 ) + ( {N}_{BWP}^{size} - 1 - R {B}_{start} )$$

where L_{RBs}≥1 and shall not exceed

$${N}_{BWP}^{size} - R {B}_{start} .$$

The base station may configure the resource allocation type for the UE through higher layer signaling (e.g., the higher layer parameter resourceAllocation may be configured as one of resourceAllocationType0, resource AllocationType1, or dynamicSwitch). If the UE is configured with both resource allocation types 0 and 1 (or equally, the higher layer parameter resourceAllocation is configured as dynamicSwitch), the base station may indicate whether a bit corresponding to the most significant bit (MSB) of the field indicating resource allocation in the DCI format indicating scheduling is resource allocation type 0 or resource allocation type 1. In addition, based on the indicated resource allocation type, the resource allocation information may be indicated through the remaining bits excluding the bit corresponding to the MSB, and based on this, the UE may interpret the resource allocation field information of the DCI field. If the UE is configured with one of resource allocation type 0 or resource allocation type 1 (or equally, the higher layer parameter resourceAllocation is configured as one of resourceAllocationType0 or resourceAllocationType1), the resource allocation information may be indicated based on the resource allocation type in which the field indicating resource allocation in the DCI format indicating scheduling is configured, and the UE may interpret the resource allocation field information of the DCI field based on this.

Hereinafter, a modulation and coding scheme (MCS) used in the 5G wireless communication system will be described in detail.

In 5G, multiple MCS index tables are defined for PDSCH and PUSCH scheduling. Which MCS table the UE assumes among the plurality of MCS tables may be configured or indicated through higher layer signaling or L1 signaling from the base station to the UE or through an RNTI value that the UE assumes when decoding the PDCCH.

MCS index table 1 for PDSCH and CP-OFDM-based PUSCH (or PUSCH without transform precoding) may be as follows.

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

MCS index table 2 for PDSCH and CP-OFDM-based PUSCH (or PUSCH without transform precoding) may be as follows.

| MCS Index | Modulation Order | Target code Rate | Spectral |
|---|---|---|---|
| I_{MCS} | Qₘ | R × [1024] | efficiency |
| 0 | 2 | 120 | 0.2344 |
| 1 | 2 | 193 | 0.3770 |
| 2 | 2 | 308 | 0.6016 |
| 3 | 2 | 449 | 0.8770 |
| 4 | 2 | 602 | 1.1758 |
| 5 | 4 | 378 | 1.4766 |
| 6 | 4 | 434 | 1.6953 |
| 7 | 4 | 490 | 1.9141 |
| 8 | 4 | 553 | 2.1602 |
| 9 | 4 | 616 | 2.4063 |
| 10 | 4 | 658 | 2.5703 |
| 11 | 6 | 466 | 2.7305 |
| 12 | 6 | 517 | 3.0293 |
| 13 | 6 | 567 | 3.3223 |
| 14 | 6 | 616 | 3.6094 |
| 15 | 6 | 666 | 3.9023 |
| 16 | 6 | 719 | 4.2129 |
| 17 | 6 | 772 | 4.5234 |
| 18 | 6 | 822 | 4.8164 |
| 19 | 6 | 873 | 5.1152 |
| 20 | 8 | 682.5 | 5.3320 |
| 21 | 8 | 711 | 5.5547 |
| 22 | 8 | 754 | 5.8906 |
| 23 | 8 | 797 | 6.2266 |
| 24 | 8 | 841 | 6.5703 |
| 25 | 8 | 885 | 6.9141 |
| 26 | 8 | 916.5 | 7.1602 |
| 27 | 8 | 948 | 7.4063 |

| | | |
|---|---|---|
| 28 | 2 | reserved |
| 29 | 4 | reserved |
| 30 | 6 | reserved |
| 31 | 6 | reserved |

MCS index table 3 for PDSCH and CP-OFDM-based PUSCH (or PUSCH without transform precoding) may be as follows.

| MCS Index | Modulation Order | Target code Rate | Spectral |
|---|---|---|---|
| I_{MCS} | Qₘ | R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

MCS index table 1 for DFT-s-OFDM-based PUSCH (or PUSCH with transform precoding) may be as follows.

| MCS Index | Modulation | Target code Rate | Spectral |
|---|---|---|---|
| I_{MCS} | Order Qₘ | R × 1024 | efficiency |
| 0 | q | 240/q | 0.2344 |
| 1 | q | 314/q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table 2 for DFT-s-OFDM-based PUSCH (or PUSCH with transform precoding) may be as follows.

| MCS Index | Modulation | Target code Rate | Spectral |
|---|---|---|---|
| I_{MCS} | Order Qₘ | R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

MCS index table for PUSCH to which transform precoding (or discrete Fourier transform (DFT) precoding) and 64 QAM are applied may be as follows.

| MCS Index | Modulation | Target code Rate | Spectral |
|---|---|---|---|
| I_{MCS} | Order Qₘ | R × 1024 | efficiency |
| 0 | q | 240/ q | 0.2344 |
| 1 | q | 314/ q | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 466 | 2.7305 |
| 18 | 6 | 517 | 3.0293 |
| 19 | 6 | 567 | 3.3223 |
| 20 | 6 | 616 | 3.6094 |
| 21 | 6 | 666 | 3.9023 |
| 22 | 6 | 719 | 4.2129 |
| 23 | 6 | 772 | 4.5234 |
| 24 | 6 | 822 | 4.8164 |
| 25 | 6 | 873 | 5.1152 |
| 26 | 6 | 910 | 5.3320 |
| 27 | 6 | 948 | 5.5547 |

| | | |
|---|---|---|
| 28 | q | reserved |
| 29 | 2 | reserved |
| 30 | 4 | reserved |
| 31 | 6 | reserved |

MCS index table for PUSCH to which transform precoding (or DFT precoding) and 64 QAM are applied may be as follows.

| MCS Index | Modulation | Target code Rate | Spectral |
|---|---|---|---|
| I_{MCS} | Order Qₘ | R × 1024 | efficiency |
| 0 | q | 60/q | 0.0586 |
| 1 | q | 80/q | 0.0781 |
| 2 | q | 100/q | 0.0977 |
| 3 | q | 128/q | 0.1250 |
| 4 | q | 156/q | 0.1523 |
| 5 | q | 198/q | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 2 | 679 | 1.3262 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 4 | 658 | 2.5703 |
| 22 | 4 | 699 | 2.7305 |
| 23 | 4 | 772 | 3.0156 |
| 24 | 6 | 567 | 3.3223 |
| 25 | 6 | 616 | 3.6094 |
| 26 | 6 | 666 | 3.9023 |
| 27 | 6 | 772 | 4.5234 |

| | | |
|---|---|---|
| 28 | q | reserved |
| 29 | 2 | reserved |
| 30 | 4 | reserved |
| 31 | 6 | reserved |

Hereinafter, a downlink control channel in the 5G wireless communication system will be described in detail with reference to the drawings.

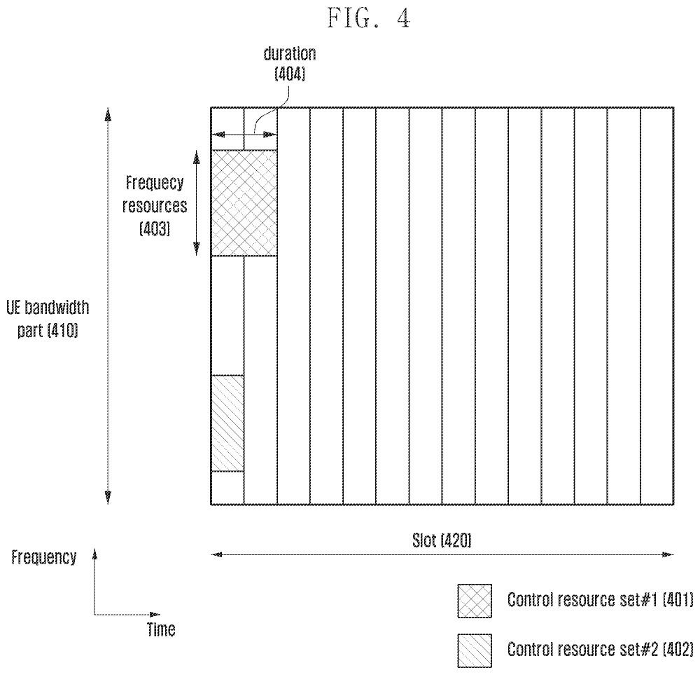

FIG. 4 is a diagram illustrating an example of a control resource set (CORESET) where a downlink control channel is transmitted in the 5G wireless communication system.

With reference to FIG. 4, a UE BWP 410 may be configured in the frequency domain and two CORESETs (CORESET #1 401 and CORESET #2 402) may be configured within one slot 420 in the time domain. The CORESETs 401 and 402 may be configured in specific frequency resources 403 within the entire UE BWP 410 in the frequency domain. In the time domain, the CORESETs 401 and 402 may be configured with one or a plurality of OFDM symbols, which may be defined as a CORESET duration 404. In an example shown in FIG. 4, the CORESET #1 401 is configured with the CORESET duration of two symbols, and the CORESET #2 402 is configured with the CORESET duration of one symbol.

The above-described CORESETs in 5G may be configured for the UE by the base station via higher layer signaling (e.g., SI, MIB, RRC signaling). Configuring the CORESETs for the UE refers to providing information such as CORESET identities, frequency locations of CORESETs, symbol lengths of CORESETs, and the like. For example, the following information may be included.

TABLE 11

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(Control Resource Set Identity)

| | |
|---|---|
| frequencyDomainResources | BIT STRING (SIZE (45)), |

(Frequency Domain Resource Allocation Information)

| | |
|---|---|
| duration | INTEGER |

```
(1..maxCoReSetDuration),
(Time Domain Resource Allocation Information)
  cce-REG-MappingType
CHOICE {
(CCE-to-REG Mapping Type)
    interleaved
SEQUENCE {
      reg-BundleSize
ENUMERATED {n2, n3, n6},
(REG Bundle Size)
      precoderGranularity
ENUMERATED {sameAsREG-bundle, allContiguousRBs},
      interleaverSize
ENUMERATED {n2, n3, n6}
      (Interleaver Size)
      shiftIndex
  INTEGER(0..maxNrofPhysicalResourceBlocks−1)
        OPTIONAL
    (Interleaver Shift)
},
```

| | |
|---|---|
| nonInterleaved | NULL |

```
  },
  tci-StatesPDCCH
SEQUENCE(SIZE (1..maxNrofTCI-StatesPDCCH)) OF TCI-StateId
      OPTIONAL,
(QCL Configuration Information)
```

| | |
|---|---|
| tci-PresentInDCI | ENUMERATED {enabled} |

OPTIONAL, -- Need S
}

In Table 11, tci-StatesPDCCH (simply referred to as transmission configuration indication (TCI) state) configuration information may include information about one or multiple synchronization signal/physical broadcast channel (SS/PBCH) block indices or channel state information reference signal (CSI-RS) indices having a QCL relationship with a DMRS transmitted in the corresponding CORESET.

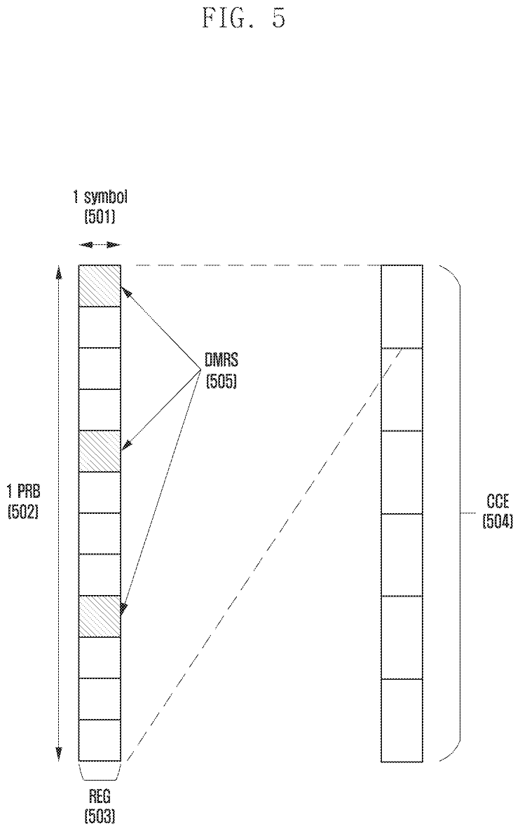

FIG. 5 is a diagram illustrating the structure of a downlink control channel in the 5G wireless communication system. That is, FIG. 5 shows an example of the basic unit of time and frequency resources that constitute the downlink control channel used in the 5G wireless communication system.

With reference to FIG. 5, the basic unit of time and frequency resources constituting a control channel may be referred to as a resource element group (REG) 503, which may be defined as one OFDM symbol 501 in the time domain and one physical resource block (PRB) 502, i.e., 12 subcarriers, in the frequency domain. The base station may concatenate REGs 503 to construct a downlink control channel allocation unit.

As shown in FIG. 5, when a basic unit for allocating a downlink control channel in the 5G wireless communication system is a control channel element (CCE) 504, one CCE 504 may be composed of a plurality of REGs 503. In the example shown in FIG. 5, the REG 503 may include 12 REs, and if one CCE 504 consist of six REGs 503, one CCE 504 may include 72 REs. When the downlink CORESET is configured, it may be composed of a plurality of CCEs 504, and a specific downlink control channel may be mapped to one or more CCEs 504 depending on an aggregation level (AL) in the CORESET and then transmitted. The CCEs 504 within the CORESET are distinguished by numbers. Here, the numbers of the CCEs 504 may be assigned according to a logical mapping scheme.

The basic unit of the downlink control channel shown in FIG. 5, that is, the REG 503, may include REs to which DCI is mapped and a region to which a DMRS 505 which is a reference signal for decoding the DCI is mapped. As shown in FIG. 5, three DMRSs 505 may be transmitted in one REG 503. The number of CCEs required for transmission of the PDCCH may be 1, 2, 4, 8, or 16 depending on the AL, and different numbers of CCEs may be used to implement link adaptation of the downlink control channel. For example, in case of AL=L, one downlink control channel may be transmitted through L CCEs. The UE needs to detect a signal in a state of not knowing information about the downlink control channel, and a search space representing a set of CCEs is defined for blind decoding. The search space is a set of downlink control channel candidates composed of CCEs that the UE has to attempt to decode at a given AL. Since there are various ALs that make one bundle of 1, 2, 4, 8, or 16 CCEs, the UE may have a plurality of search spaces. A search space set may be defined as a set of search spaces at all configured ALs.

The search spaces may be classified into a common search space and a UE-specific search space. A certain group of UEs or all the UEs may examine the common search space of the PDCCH so as to receive cell common control information such as dynamic scheduling for system information or a paging message. For example, PDSCH scheduling allocation information for transmission of SIB including cell operator information and the like may be received by examining the common search space of the PDCCH. In case of the common search space, since a certain group of UEs or all the UEs need to receive the PDCCH, the common search space may be defined as a set of prearranged CCEs. Scheduling allocation information about the UE-specific PDSCH or PUSCH may be received by examining the UE-specific search space of the PDCCH. The UE-specific search space may be UE-specifically defined as a function of the UE identity and various system parameters.

In the 5G wireless communication system, parameters for the search space of the PDCCH may be configured for the UE by the base station via higher layer signaling (e.g., SIB, MIB, RRC signaling, etc.). For example, the base station may configure, for the UE, the number of PDCCH candidates at each aggregation level L, a monitoring periodicity for a search space, a monitoring occasion in symbol units within a slot for a search space, a search space type (a common search space or a UE-specific search space), a combination of RNTI and DCI format to be monitored in the corresponding search space, a control resource set index to monitor a search space, and the like. For example, parameters for the search space of the PDCCH may include the following information.

TABLE 12

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |

(Search Space Identity)

| | |
|---|---|
| controlResourceSetId | ControlResourceSetId, |

(Control Resource Set Identity)

| | |
|---|---|
| monitoringSlotPeriodicityAndOffset | CHOICE { |

(Monitoring Slot Level Periodicity)

| | |
|---|---|
| sl1 | NULL, |

```
    sl2
  INTEGER (0..1),
    sl4
  INTEGER (0..3),
```

| | |
|---|---|
| sl5 | INTEGER |

```
(0..4),
    sl8
  INTEGER (0..7),
    sl10
  INTEGER (0..9),
    sl16
  INTEGER (0..15),
    sl20
  INTEGER (0..19)
  }
```

| | |
|---|---|
| | OPTIONAL, |
| duration (Monitoring Duration) | INTEGER (2..2559) |
| monitoringSymbolsWithinSlot | BIT STRING (SIZE |

(14))
OPTIONAL,
(Monitoring Symbol within Slot)

| | |
|---|---|
| nrofCandidates | SEQUENCE { |

(Number of PDCCH Candidates per Aggregation Level)

| | |
|---|---|
| aggregationLevel1 | ENUMERATED {n0, |

```
n1, n2, n3, n4, n5, n6, n8},
    aggregationLevel2
  ENUMERATED {n0, n1, n2, n3, n4, n5, n6, n8},
    aggregationLevel4
  ENUMERATED {n0, n1, n2, n3, n4, n5, n6, n8},
    aggregationLevel8
  ENUMERATED {n0, n1, n2, n3, n4, n5, n6, n8},
    aggregationLevel16
  ENUMERATED {n0, n1, n2, n3, n4, n5, n6, n8}
  },
```

| | |
|---|---|
| searchSpaceType | CHOICE { |

```
  (Search Space Type)
    -- Configures this search space as common search space (CSS) and
DCI formats to monitor.
    common
  SEQUENCE {
  (Common Search Space)
}
```

| | |
|---|---|
| ue-Specific | SEQUENCE { |

```
  (UE-specific Search Space)
    -- Indicates whether the UE monitors in this USS for DCI formats 0-0
and 1-0 or for formats 0-1 and 1-1.
    formats
  ENUMERATED {formats0-0-And-1-0, formats0-1-And-1-1},
      ...
    }
```

The base station may configure one or more search space sets for the UE according to configuration information. According to an embodiment, the base station may configure search space set 1 and search space set 2 for the UE. Also, the base station may configure the search space set 1 so that DCI format A scrambled by an X-RNTI is monitored in the common search space, and may configure the search space set 2 so that DCI format B scrambled by a Y-RNTI is monitored in the UE-specific search space.

According to the configuration information, one or more search space sets may exist in the common search space or the UE-specific search space. For example, search space set #1 and search space set #2 may be configured as the common search space, and search space set #3 and search space set #4 may be configured as the UE-specific search space.

In the common search space, the following combinations of the DCI format and the RNTI may be monitored. However, the disclosure is not limited to the following example.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of the DCI format and the RNTI may be monitored. However, the disclosure is not limited to the following example.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may follow the definitions and usages described below.
Cell RNTI (C-RNTI): For UE-specific PDSCH scheduling
Modulation Coding Scheme C-RNTI (MCS-C-RNTI): For UE-specific PDSCH scheduling
Temporary Cell RNTI (TC-RNTI): For UE-specific PDSCH scheduling
Configured Scheduling RNTI (CS-RNTI): For semi-statically configured UE-specific PDSCH scheduling
Random Access RNTI (RA-RNTI): For PDSCH scheduling in random access step
Paging RNTI (P-RNTI): For scheduling of PDSCH in which paging is transmitted
System Information RNTI (SI-RNTI): For scheduling of PDSCH in which system information is transmitted
Interruption RNTI (INT-RNTI): For notifying whether to puncture PDSCH.
Transmit Power Control for PUSCH RNTI (TPC-PUSCH-RNTI): For indication of power control command for PUSCH
Transmit Power Control for PUCCH RNTI (TPC-PUCCH-RNTI): For indication of power control command for PUCCH
Transmit Power Control for SRS RNTI (TPC-SRS-RNTI): For indication of power control command for SRS

The above-described specified DCI formats may follow the definition below.

TABLE 13

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In the 5G wireless communication system, the search space of the aggregation level L in the CORESET p and the search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , m ax}^{( L )}} ⌋ + {n}_{CI} ) mod ⌊ {N}_{CCE , p} / L ⌋ \} + i \qquad Equation 1$$

L: Aggregation level
n_{Cl}: Carrier index
N_{CCE.p}: Total number of CCEs existing in the CORESET p
n_{s,f}^{μ}: Slot index
M_{p,s,max}^{(L)}: Number of PDCCH candidates of aggregation level L
m_{s,nCl}=0, . . . , M_{p,s,max}^{(L)}−1: PDCCH candidate group index of aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, A₀=39827, A₁=39829, A₂=39839, D=65537
n_{RNTI}: UE identifier

In the case of the common search space, the value of

$${Y}_{p , {n}_{s , f}^{μ}}$$

may correspond to zero.

In the case of the UE-specific search space, the value of

$${Y}_{p , {n}_{s , f}^{μ}}$$

may correspond to a value that varies depending on the UE's identity (C-RNTI or ID configured for the UE by the base station) and time index.

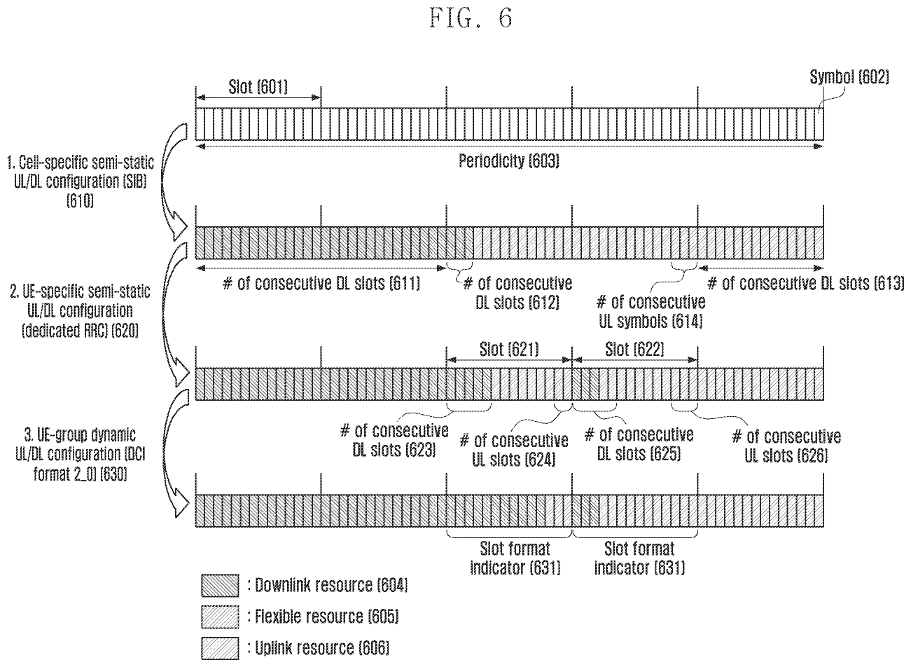

FIG. 6 is a diagram illustrating an example of uplink-downlink configuration considered in a wireless communication system according to an embodiment of the disclosure.

With reference to FIG. 6, a slot 601 may include fourteen symbols 602. In the 5G communication system, uplink-downlink configuration of symbol/slot may be configured in three steps. First, the uplink-downlink of symbol/slot may be configured semi-statically with cell-specific configuration information 610 through system information in a symbol unit. Specifically, the cell-specific uplink-downlink configuration information through system information may include uplink-downlink pattern information and reference subcarrier information. The uplink-downlink pattern information may indicate a pattern periodicity 603, the number 611 of consecutive downlink slots from the start point of each pattern, the number 612 of symbols in the next slot, the number 613 of consecutive uplink slots from the end of the pattern, and the number 614 of symbols in the next slot. In this case, slots and symbols not indicated for uplink or downlink may be determined as flexible slots/symbols.

Second, using user-specific configuration information through dedicated higher layer signaling, flexible slots or slots 621 and 622 containing flexible symbols may be indicated with the number 623 and 625 of consecutive downlink symbols from the start symbol of each slot and the number 624 and 626 of consecutive uplink symbols from the end of each slot or indicated with the entire slot downlink or the entire slot uplink.

Finally, in order to dynamically change the downlink signal transmission and uplink signal transmission intervals, each of symbols indicated as flexible symbols in each slot (i.e., symbols not indicated as downlink or uplink) may be indicated whether it is a downlink symbol, an uplink symbol, or a flexible symbol, through a slot format indicator (SFI) 631 and 632 included in the downlink control channel. The SFI may select one index from a table in which the uplink-downlink configuration of 14 symbols in one slot is predetermined, as shown in the following Table.

TABLE 14

| | Symbol number in a slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on tdd-UL-DL- |
| | ConfigurationCommon, or tdd-UL-DL-ConfigurationDedicated and, |
| | if any, on detected DCI formats |

### [PUSCH: Related to Transmission Scheme]

Next, a scheduling scheme of PUSCH transmission will be described. The PUSCH transmission may be dynamically scheduled by UL grant in DCI or operated by configured grant Type 1 or Type 2. Indication of dynamic scheduling for PUSCH transmission are possible in DCI format 0_0 or 0_1.

Configured grant Type 1 PUSCH transmission may be configured semi-statically by receiving configuredGrantConfig including rrc-ConfiguredUplinkGrant of Table 15 through higher signaling without receiving UL grant in DCI. Configured grant Type 2 PUSCH transmission may be scheduled semi-persistently by UL grant in DCI after receiving configuredGrantConfig that does not include rrc-ConfiguredUplinkGrant of Table 15 through higher signaling. When PUSCH transmission operates by a configured grant, parameters applied to PUSCH transmission are applied through configuredGrantConfig, which is higher signaling of Table 15, except for dataScramblingIdentityPUSCH, txConfig, codebookSubset, maxRank, scaling of UCI-OnPUSCH, provided by higher signaling pusch-Config of Table 16. If the UE is provided with transformPrecoder in configuredGrantConfig, which is higher signaling of Table 15, the UE applies tp-pi2BPSK in pusch-Config of Table 16 to PUSCH transmission operated by configured grant.

TABLE 15

| | |
|---|---|
| ConfiguredGrantConfig ::= | SEQUENCE { |
| frequencyHopping | ENUMERATED {intraSlot, |
| interSlot} | OPTIONAL, -- Need S, |
| cg-DMRS-Configuration | DMRS-UplinkConfig, |
| mcs-Table | ENUMERATED {qam256, |
| qam64LowSE} | OPTIONAL, -- Need S |
| mcs-TableTransformPrecoder | ENUMERATED {qam256, |
| qam64LowSE} | OPTIONAL, -- Need S |
| uci-OnPUSCH | SetupRelease { |
| CG-UCI-OnPUSCH } | OPTIONAL, -- Need M |
| resourceAllocation | ENUMERATED { |

resourceAllocationType0, resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, |
| disabled} | OPTIONAL, -- Need S |
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |

sym2, sym7, sym1x14, sym2x14, sym4x14, sym5x14, sym8x14, sym10x14,
sym16x14, sym20x14, sym32x14, sym40x14, sym64x14, sym80x14, sym128x14,
sym160x14, sym256x14, sym320x14, sym512x14, sym640x14, sym1024x14,
sym1280x14, sym2560x14, sym5120x14, sym6, sym1x12, sym2x12, sym4x12,
sym5x12, sym8x12, sym10x12, sym16x12, sym20x12, sym32x12, sym40x12,
sym64x12, sym80x12, sym128x12, sym160x12, sym256x12, sym320x12,
sym512x12, sym640x12, sym1280x12, sym2560x12
},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |

frequencyHoppingOffset INTEGER (1..maxNrofPhysicalResourceBlocks−1)
OPTIONAL, -- Need R
pathlossReferenceIndex INTEGER (0..maxNrofPUSCH-PathlossReferenceRSs−1),
...
}
OPTIONAL, -- Need R
...
}

Next, a PUSCH transmission method is described. A DMRS antenna port for PUSCH transmission is the same as an antenna port for SRS transmission. The PUSCH transmission may follow a codebook-based transmission method or a non-codebook-based transmission method depending on whether the value of txConfig in higher signaling pusch-Config of Table 16 is ‘codebook’ or ‘nonCodebook’.

As described above, the PUSCH transmission may be scheduled dynamically through DCI format 0_0 or 0_1, and may be configured semi-statically by configured grant. If the UE receives indication of scheduling for the PUSCH transmission through DCI format 0_0, the UE performs beam configuration for PUSCH transmission by using pucch-spatialRelationInfoID corresponding to a UE-specific PUCCH resource corresponding to the minimum ID within an activated uplink BWP in a serving cell, and in this case, the PUSCH transmission is based on a single antenna port. The UE does not expect scheduling for the PUSCH transmission through DCI format 0_0 within a BWP in which a PUCCH resource including pucch-spatialRelationInfo is not configured. If the UE is not configured with txConfig in pusch-Config of Table 16, the UE does not expect scheduling through DCI format 0_1.

TABLE 16

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, |
| nonCodebook} | OPTIONAL, -- Need S |

dmrs-UplinkForPUSCH-MappingTypeA SetupRelease {

| | |
|---|---|
| DMRS-UplinkConfig } | OPTIONAL, -- Need M |

dmrs-UplinkForPUSCH-MappingTypeB SetupRelease {

| | |
|---|---|
| DMRS-UplinkConfig } | OPTIONAL, -- Need M |
| pusch-PowerControl | PUSCH-PowerControl |

OPTIONAL, -- Need M

| | |
|---|---|
| frequencyHopping | ENUMERATED {intraSlot, |
| interSlot} | OPTIONAL, -- Need S |
| frequencyHoppingOffsetLists | SEQUENCE (SIZE (1..4)) OF |

INTEGER (1..maxNrofPhysicalResourceBlocks−1)
OPTIONAL, -- Need M

| | |
|---|---|
| resourceAllocation | ENUMERATED { |

resourceAllocationType0, resourceAllocationType1, dynamicSwitch},
pusch-TimeDomainAllocationList SetupRelease {
PUSCH-TimeDomainResourceAllocationList } OPTIONAL, -- Need M

| | |
|---|---|
| pusch-AggregationFactor | ENUMERATED { n2, n4, n8 } |

OPTIONAL, -- Need S

| | |
|---|---|
| mcs-Table | ENUMERATED {qam256, |
| qam64LowSE} | OPTIONAL, -- Need S |
| mcs-TableTransformPrecoder | ENUMERATED {qam256, |
| qam64LowSE} | OPTIONAL, -- Need S |
| transformPrecoder | ENUMERATED {enabled, |
| disabled} | OPTIONAL, -- Need S |
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI-OnPUSCH} |

OPTIONAL, -- Need M

| | |
|---|---|
| tp-pi2BPSK | ENUMERATED {enabled} |

OPTIONAL, -- Need S
...
}

Next, codebook-based PUSCH transmission is described. The codebook-based PUSCH transmission may be scheduled dynamically through DCI format 0_0 or 0_1 and may operate semi-statically by configured grant. If the codebook-based PUSCH is scheduled dynamically by DCI format 0_1 or configured semi-statically by configured grant, the UE determines a precoder for PUSCH transmission based on an SRS resource indicator (SRI), a transmission precoding matrix indicator (TPMI), and a transmission rank (the number of PUSCH transmission layers). In this case, the SRI may be given through a field, SRS resource indicator, in DCI or configured through higher signaling, srs-ResourceIndicator. In the codebook-based PUSCH transmission, the UE is configured with at least one SRS resource and may be configured with up to two. When the UE is provided with the SRI through DCI, the SRS resource indicated by the SRI refers to an SRS resource corresponding to the SRI among SRS resources transmitted before PDCCH containing the SRI. Also, the TPMI and the transmission rank may be given through a field, precoding information and number of layers, in DCI or configured through higher signaling, precodingAndNumberOfLayers. The TPMI is used to indicate the precoder applied to the PUSCH transmission. If the UE is configured with one SRS resource, the TPMI is used to indicate the precoder to be applied in one configured SRS resource. If the UE is configured with multiple SRS resources, the TPMI is used to indicate the precoder to be applied in the SRS resource indicated through the SRI.

The precoder to be used for the PUSCH transmission is selected from an uplink codebook having the number of antenna ports equal to the value of nrofSRS-Ports in SRS-Config, which is higher signaling. In the codebook-based PUSCH transmission, the UE determines a codebook subset based on the TPMI and higher signaling, codebookSubset in pusch-Config. The codebookSubset in pusch-Config may be configured as one of ‘fully AndPartialAndNonCoherent’, ‘partialAndNonCoherent’, or ‘nonCoherent’ based on the UE capability reported by the UE to the base station. If the UE reports ‘partialAndNonCoherent’ as the UE capability, the UE does not expect the value of codebookSubset, which is higher signaling, to be configured as ‘fully AndPartialAndNonCoherent’. Also, if the UE reports ‘nonCoherent’ as the UE capability, the UE does not expect the value of codebookSubset, which is higher signaling, to be configured as ‘fully AndPartial AndNonCoherent’ or ‘partialAndNonCoherent’. If higher signaling, nrofSRS-Ports in SRS-ResourceSet, indicates two SRS antenna ports, the UE does not expect the value of codebookSubset, which is higher signaling, to be configured as ‘partialAndNonCoherent’.

The UE may be configured with one SRS resource set in which the value of usage in higher signaling SRS-ResourceSet is configured as ‘codebook’, and one SRS resource within the SRS resource set may be indicated through the SRI. If multiple SRS resources are configured in the SRS resource set where the usage value in higher signaling SRS-ResourceSet is configured as ‘codebook’, the UE expects that the value of nrofSRS-Ports in higher signaling SRS-ResourceSet is configured as the same value for all SRS resources.

The UE transmits to the base station one or multiple SRS resources included in the SRS resource set in which the usage value is configured as ‘codebook’ according to higher signaling, and the base station selects one of the SRS resources transmitted by the UE and instructs the UE to perform PUSCH transmission using the transmission beam information of the selected SRS resource. In this case, in the codebook-based PUSCH transmission, the SRI is used as information to select the index of one SRS resource and is contained in DCI. Additionally, the base station includes, in the DCI, information indicating the TPMI and rank to be used by the UE for PUSCH transmission. Using the SRS resource indicated by the SRI, the UE performs PUSCH transmission by applying the precoder indicated by the TPMI and rank indicated based on the transmission beam of the SRS resource.

Next, the non-codebook-based PUSCH transmission is described. The non-codebook-based PUSCH transmission may be scheduled dynamically through DCI format 0_0 or 0_1 and may operate semi-statically by configured grant. If at least one SRS resource is configured in the SRS resource set where the value of usage in higher signaling SRS-ResourceSet is configured as ‘nonCodebook’, the UE may receive scheduling of the non-codebook-based PUSCH transmission through DCI format 0_1.

For an SRS resource set in which the usage value in higher signaling SRS-ResourceSet is configured as ‘nonCodebook’, the UE may be configured with one connected non-zero power (NZP) CSI-RS resource. The UE may perform calculations on the precoder for SRS transmission through measurement of the NZP CSI-RS resource connected to the SRS resource set. If the difference between the last received symbol of the aperiodic NZP CSI-RS resource connected to the SRS resource set and the first symbol of the aperiodic SRS transmission from the UE is less than 42 symbols, the UE does not expect that information about the precoder for SRS transmission will be updated.

If the value of resourceType in SRS-ResourceSet, which is higher signaling, is configured as ‘aperiodic’, the connected NZP CSI-RS is indicated by SRS request, which is a field in DCI format 0_1 or 1_1. In this case, if the connected NZP CSI-RS resource is an aperiodic NZP CSI-RS resource, it indicates that the connected NZP CSI-RS exists for the case where the value of the field SRS request in DCI format 0_1 or 1_1 is not ‘00’. At this time, the corresponding DCI should not indicate cross carrier or cross BWP scheduling. Additionally, if the value of the SRS request indicates the existence of the NZP CSI-RS, the NZP CSI-RS is located in a slot where PDCCH including the SRS request field is transmitted. In this case, TCI states configured in the scheduled subcarrier are not configured as QCL-TypeD.

If a periodic or semi-persistent SRS resource set is configured, the connected NZP CSI-RS may be indicated through associatedCSI-RS in higher signaling SRS-ResourceSet. For the non-codebook-based transmission, the UE does not expect that spatialRelationInfo, higher signaling for the SRS resource, and associatedCSI-RS in higher signaling SRS-ResourceSet will be configured together.

When configured with a plurality of SRS resources, the UE may determine the precoder and transmission rank to be applied to PUSCH transmission, based on the SRI indicated by the base station. In this case, the SRI may be indicated through a field, SRS resource indicator, in DCI or configured through higher signaling, srs-ResourceIndicator. Similar to the codebook-based PUSCH transmission described above, when the UE is provided with the SRI through DCI, the SRS resource indicated by the SRI refers to an SRS resource corresponding to the SRI among SRS resources transmitted before PDCCH containing the SRI. The UE may use one or multiple SRS resources for SRS transmission, and the maximum number of SRS resources that allow simultaneous transmission in the same symbol within one SRS resource set is determined by the UE capability reported by the UE to the base station. In this case, the SRS resources simultaneously transmitted by the UE occupy the same RB. The UE configures one SRS port for each SRS resource. The SRS resource set in which the usage value in higher signaling SRS-ResourceSet is configured as ‘nonCodebook’ may be configured as only one, and the SRS resources for the non-codebook-based PUSCH transmission may be configured up to four.

The base station transmits one NZP-CSI-RS connected to the SRS resource set to the UE, and the UE calculates the precoder to be used when transmitting one or more SRS resources in the SRS resource set, based on the result measured when receiving the NZP-CSI-RS. The UE applies the calculated precoder when transmitting to the base station one or more SRS resources in the SRS resource set in which usage is configured as ‘nonCodebook’, and the base station selects one or more SRS resources among the received one or more SRS resources. Here, in the non-codebook-based PUSCH transmission, the SRI represents an index that can express a combination of one or multiple SRS resources, and the SRI is contained in DCI. Also, the number of SRS resources indicated by the SRI transmitted by the base station may be the number of transmission layers of PUSCH, and the UE transmits the PUSCH by applying the precoder, applied to SRS resource transmission, to each layer.

### [PUSCH: Preparation Procedure Time]

Hereinafter, a PUSCH preparation procedure time will be described. In the case where the base station schedules the UE to transmit PUSCH using DCI format 0_0 or DCI format 0_1, the UE may need the PUSCH preparation procedure time to transmit PUSCH by applying a transmission method (a transmission precoding method of SRS resource, the number of transmission layers, and a spatial domain transmission filter) indicated through DCI. Considering this, the NR has defined the PUSCH preparation procedure time. The PUSCH preparation procedure time of the UE may follow Equation 2 below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad Equation 2$$

In T_{proc,2} above, each variable may have the following meaning.
N₂: It is the number of symbols determined depending on UE processing capability 1 or 2 based on the capability of the UE and numerology μ. If the UE processing capability 1 is reported via UE's capability report, it may have the value in Table 17. If the UE processing capability 2 is reported and it is configured through higher signaling that the UE processing capability 2 can be used, it may have the value in Table 18.

TABLE 17

| | PUSCH preparation time N₂ |
|---|---|
| μ | [symbols] |
| 0 | 10 |
| 1 | 12 |
| 2 | 23 |
| 3 | 36 |

TABLE 18

| | PUSCH preparation time N₂ |
|---|---|
| μ | [symbols] |
| 0 | 5 |
| 1 | 5.5 |
| 2 | 11 for frequency range 1 |

d_{2,1}: It is the number of symbols configured as 0 if all resource elements of the first OFDM symbol in PUSCH transmission are configured to consist of DM-RS only, otherwise, as 1.
k: 64
μ: It follows the value that makes T_{proc,2} larger from among μ_{DL} and μ_{UL}. Here, μ_{DL} refers to the numerology of downlink where PDCCH containing DCI for scheduling PUSCH is transmitted, and μ_{UL} refers to the numerology of uplink where PUSCH is transmitted.
T_{c}: It has 1/(Δfₘₐₓ·N_{f}) Δfₘₐₓ=480·10³ Hz, N_{f}=4096,
d_{2,2}: It follows a BWP switching time if DCI for scheduling PUSCH indicates BWP switching. Otherwise, it has 0.
d₂: If OFDM symbols of PUSCH with a high priority index and PUCCH with a low priority index overlap in time, the d₂ value of the PUSCH with a high priority index is used. Otherwise, d₂ is 0.
Tₑₓₜ: If the UE uses a shared spectrum channel access scheme, the UE may calculate Tₑₓₜ and apply it to the PUSCH preparation procedure time. Otherwise, Tₑₓₜ is assumed to be 0.
T_{switch}: If an uplink switching interval is triggered, T_{switch} is assumed to be a switching interval time. Otherwise, it is assumed to be 0.

Considering the time domain resource mapping information of PUSCH scheduled through DCI and the effect of timing advance (TA) between uplink and downlink, the base station and the UE determine that the PUSCH preparation procedure time is not sufficient when the first symbol of the PUSCH starts earlier than the first uplink symbol where CP starts after T_{proc,2} from the last symbol of PDCCH containing the DCI that schedules the PUSCH. Otherwise, the base station and the UE determine that the PUSCH preparation procedure time is sufficient. The UE may transmit the PUSCH only when the PUSCH preparation procedure time is sufficient, and may ignore the DCI that schedules the PUSCH when the PUSCH preparation procedure time is not sufficient.

Next, PUSCH repetition transmission will be described. If the UE is configured with higher signaling, pusch-AggregationFactor, when PUSCH transmission is scheduled with DCI format 0_1 in PDCCH containing a CRC scrambled by C-RNTI, MCS-C-RNTI, or CS-RNTI, the same symbol allocation is applied in as many consecutive slots as pusch-AggregationFactor, and the PUSCH transmission is limited to single rank transmission. For example, the UE should repeat the same TB in as many consecutive slots as pusch-AggregationFactor, and apply the same symbol allocation to each slot. Table 19 shows the redundancy version applied to PUSCH repetition transmission per slot. If the UE is scheduled with PUSCH repetition in a plurality of slots via DCI format 0_1, and if at least one of slots in which PUSCH repetition transmission is performed is indicated as a downlink symbol according to information of higher signaling, tdd-UL-DL-ConfigurationCommon or tdd-UL-DL-ConfigurationDedicated, the UE does not perform PUSCH transmission in a slot where the symbol is located.

TABLE 19

| rv_{id} indicated by the | rv_{id} to be applied to n^{th} transmission occasion | | | |
|---|---|---|---|---|
| DCI scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

### [PUSCH: Related to Repetition Transmission]

Hereinafter, repetition transmission of an uplink data channel in the 5G system will be described in detail. The 5G system supports two types of repetition transmission methods for an uplink data channel: PUSCH repetition type A and PUSCH repetition type B. The UE may be configured with either PUSCH repetition type A or B through higher layer signaling.

### PUSCH Repetition Type A

As described above, the symbol length and start symbol position of the uplink data channel are determined by the time domain resource allocation method within one slot, and the base station may notify the number of repetitions to the UE through higher layer signaling (e.g., RRC signaling) or L1 signaling (e.g., DCI).
The UE may repeatedly transmit, in consecutive slots, the uplink data channel with the same symbol length and start symbol configured based on the number of repetitions received from the base station. In this case, if at least one symbol in symbols of the uplink data channel configured for the UE or a slot configured for the UE by the base station is configured as downlink, the UE skips uplink data channel transmission, but it counts the number of repetitions of the uplink data channel. That is, the uplink data channel may not be transmitted even though it is included in the number of repetitions of the uplink data channel. On the other hand, the UE that supports Rel-17 uplink data repetition may determine a slot capable of uplink data repetitions to be an available slot and count the number of transmissions during the uplink data channel repetition in the available slot. In the case where the uplink data channel repetition is skipped in any slot determined as the available slot, the corresponding transmission may be postponed and then repeated through a slot allowing transmission.
For determining the available slot, if at least one symbol configured with time domain resource allocation (TDRA) for PUSCH in a slot for PUSCH transmission is overlapped with a symbol (e.g., downlink) for a purpose other than uplink transmission, that slot may be determined as an unavailable slot (e.g., a slot that is not the available slot and is determined to be unavailable for PUSCH transmission). In addition, the available slot may be considered as an uplink resource for determining a transport block size (TBS) and a resource for PUSCH transmission in the PUSCH repetition and multi-slot PUSCH transmission consisting of one TB (transport block on multiple slots (TBoMS)).

### PUSCH Repetition Type B

As described above, the start symbol and length of the uplink data channel are determined by the time domain resource allocation method within one slot, and the base station may notify the number of repetitions, numberofrepetitions, to the UE through higher layer signaling (e.g., RRC signaling) or L1 signaling (e.g., DCI).
Based on the configured start symbol and length of the uplink data channel, the nominal repetition of the uplink data channel is determined as follows. The slot at which the nth nominal repetition starts is given by

$${K}_{s} + ⌊ \frac{S + n \cdot L}{{N}_{symb}^{slot}} ⌋ ,$$

and the symbol starting in that slot is given by

$$mod ( S + n \cdot L , {N}_{symb}^{slot} ) .$$

The slot at which the nth nominal repetition ends is given by

$${K}_{s} + ⌊ \frac{S + ( n + 1 ) \cdot L - 1}{{N}_{symb}^{slot}} ⌋ ,$$

and the symbol ending in that slot is given by

$$mod ( S + ( n + 1 ) \cdot L - 1 , {N}_{symb}^{slot} ) .$$

Here, n is 0, . . . , numberofprepetitions−1. Also, S represents the configured start symbol of the uplink data channel, and L represents the configured symbol length of the uplink data channel. In addition, Kₛ represents the slot where PUSCH transmission starts and represents the number of symbols per

$${N}_{symb}^{slot}$$

slot.
For the PUSCH repetition type B, the UE may determine a specific OFDM symbol as an invalid symbol in the following cases.
A symbol configured for downlink by tdd-UL-DL-ConfigurationCommon or tdd-UL-DL-ConfigurationDedicated may be determined as an invalid symbol for the PUSCH repetition type B.
Symbols indicated by ssb-PositionsInBurst in SIB1 or ssb-PositionsInBurst in ServingCellConfigCommon, which is higher layer signaling, for SSB reception in the unpaired spectrum (TDD spectrum) may be determined as invalid symbols for the PUSCH repetition type B.
Symbols indicated through pdcch-ConfigSIB1 in MIB to transmit a control resource set connected to a Type0-PDCCH CSS set in the unpaired spectrum (TDD spectrum) may be determined as invalid symbols for the PUSCH repetition type B.
If higher layer signaling numberOfInvalidSymbolsForDL-UL-Switching is configured in the unpaired spectrum (TDD spectrum), as many symbols as numberOfInvalidSymbolsForDL-UL-Switching from symbols configured for downlink by tdd-UL-DL-ConfigurationCommon or tdd-UL-DL-ConfigurationDedicated may be determined as invalid symbols.
Additionally, the invalid symbol may be configured in a certain higher layer parameter (e.g., InvalidSymbolPattern). This higher layer parameter (e.g., InvalidSymbolPattern) may provide a symbol-level bitmap spanning one or two slots to configure the invalid symbol. In the bitmap, ‘1’ represents the invalid symbol. Further, the periodicity and pattern of the bitmap may be configured through a higher layer parameter (e.g., periodicity AndPattern). If a certain higher layer parameter (e.g., InvalidSymbolPattern) is configured and the InvalidSymbolPatternIndicator-ForDCIFormat0_1 or InvalidSymbolPatternIndicator-ForDCIFormat0_2 parameter indicates ‘1’, the UE applies an invalid symbol pattern, and if the above parameter indicates ‘0’, the UE does not apply the invalid symbol pattern. If a certain higher layer parameter (e.g., InvalidSymbolPattern) is configured and the InvalidSymbolPatternIndicator-ForDCIFormat0_1 or InvalidSymbolPatternIndicator-ForDCIFormat0_2 parameter is not configured, the UE applies the invalid symbol pattern.

After the invalid symbol is determined, for each nominal repetition, the UE may consider symbols other than the invalid symbol as valid symbols. If one or more valid symbols are included in each nominal repetition, the nominal repetition may contain one or more actual repetitions. Here, each actual repetition contains a set of consecutive valid symbols that can be used for the PUSCH repetition type B within one slot. If the OFDM symbol length of the nominal repetition is not 1, and the length of the actual repetition becomes 1, the UE may ignore transmission for the actual repetition.

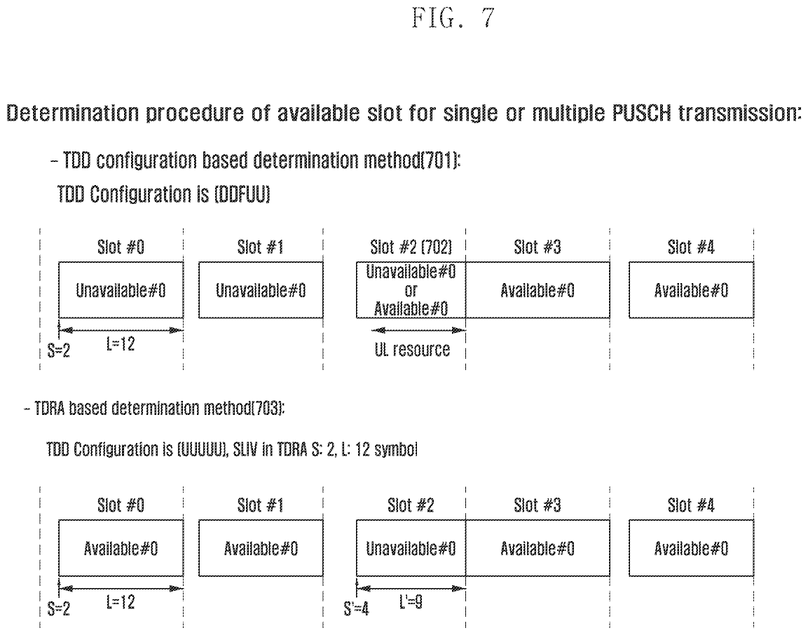

FIG. 7 is a diagram illustrating a method for determining an available slot in a 5G wireless communication system according to an embodiment of the disclosure.

When the base station configures uplink resources through higher layer signaling (tdd-UL-DL-ConfigurationCommon or tdd-UL-DL-ConfigurationDedicated) or L1 signaling (dynamic slot format indicator), the base station and the UE may determine, for the configured uplink resources, the available slot through 1) an available slot determination method based on TDD configuration or 2) an available slot determination method considering TDD configuration and time domain resource allocation (TDRA), configured grant (CG) configuration or activation DCI.

In an example 701 of the method for determining available slots based on TDD configuration as shown in FIG. 7, if the TDD configuration is configured as ‘DDFUU’ through higher layer signaling, the base station and the UE may determine slot #3 and slot #4 configured to be uplink ‘U’ in the TDD configuration as available slots. In this case, slot #2, which is configured to be flexible slot ‘F’ in the TDD configuration, may be determined as an unavailable slot or an available slot, which may be predefined through base station's configuration, for example.

In an example 703 of the method for determining available slots considering TDD configuration and TDRA, CG configuration or activation DCI as shown in FIG. 7, if the TDD configuration is configured as ‘UUUUU’ through higher layer signaling, and the start and length indicator value (SLIV) of PUSCH transmission is configured as {S: 2, L: 12 symbol} through L1 signaling, the base station and the UE may determine, for the configured uplink slots ‘U’, slot #0, slot #1, slot #3, and slot #4 that satisfy the SLIV of PUSCH as available slots. In this case, the base station and the UE may determine slot #2 (′L=9′≤SLIV ‘L=12’) failing to satisfy the SLIV, which is the TDRA condition for PUSCH transmission, as an unavailable slot. This is exemplary only and is not limited to PUSCH transmission. It may also be applied to PUCCH transmission, PUSCH/PUCCH repetition transmission, nominal repetition of PUSCH repetition type B, and TBoMS.

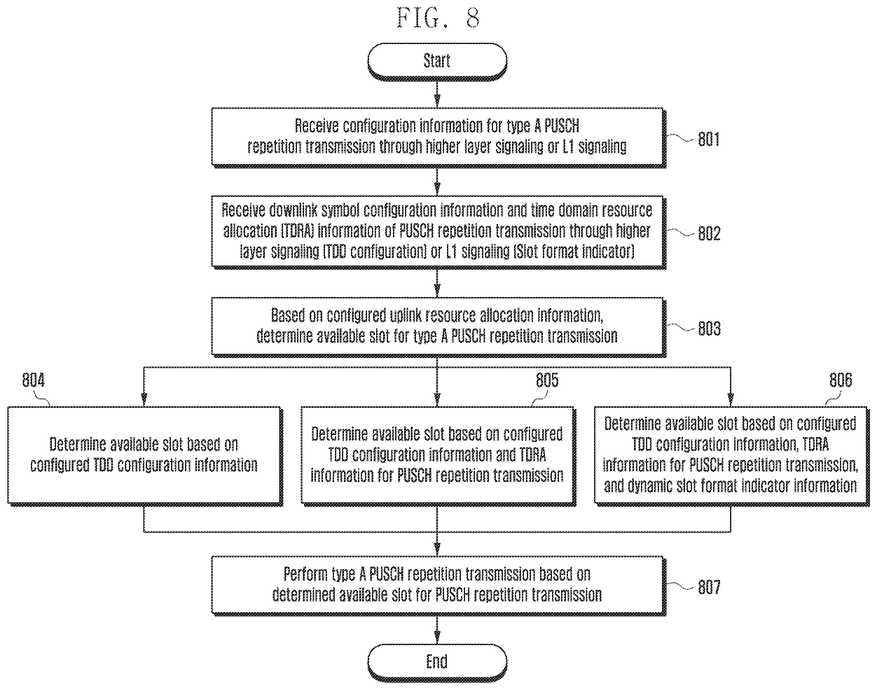

FIG. 8 is a flowchart illustrating the operation of a terminal for type A PUSCH repetition transmission in a 5G wireless communication system according to an embodiment of the disclosure.

In FIG. 8, the operation of a terminal for type A PUSCH repetition transmission is described. At 801, the UE may receive configuration information for type A PUSCH repetition transmission from the base station through higher layer signaling or L1 signaling. At 802, the UE may receive downlink symbol configuration information and time domain resource allocation (TDRA) information of PUSCH repetition transmission through higher layer signaling (e.g., TDD configuration; tdd-UL-DL-ConfigurationCommon or tdd-UL-DL-ConfigurationDedicated) or L1 signaling (e.g., Slot format indicator). Then, at 803, based on the uplink resource allocation information configured from the base station, the UE may determine an available slot for type A PUSCH repetition transmission. At this time, the UE may determine the available slot by using any one or a combination of three methods 804, 805, and 806. In the first method 804, the UE may determine only a slot configured to be uplink as the available slot based on the configured TDD configuration information. In the second method 805, the UE may determine the available slot by considering the configured TDD configuration information, TDRA information for PUSCH transmission, CG-configuration, and activation DCI. In the third method 806, the UE may determine the available slot based on the configured TDD configuration information, TDRA information for PUSCH transmission, CG-configuration, activation DCI information, and dynamic slot format indicator (SFI). The method used to determine the available slot may be predefined/promised between the base station and the UE or may be configured and indicated semi-statically or dynamically through signaling between the base station and the UE. Thereafter, at 807, the UE may perform type A PUSCH repetition transmission to the base station through the determined available slot.

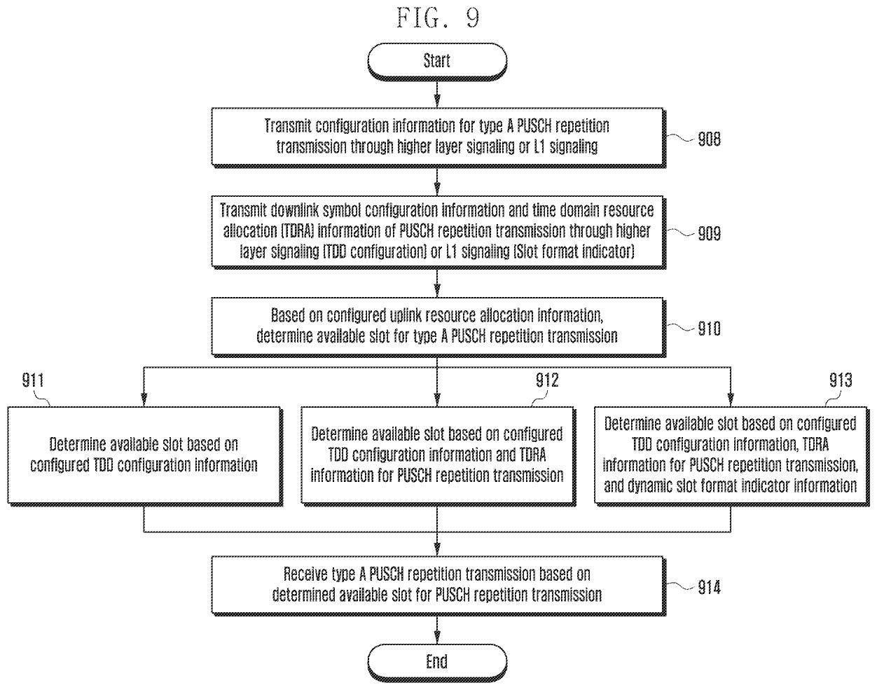

FIG. 9 is a flowchart illustrating the operation of a base station for type A PUSCH repetition transmission in a 5G wireless communication system according to an embodiment of the disclosure.

In FIG. 9, the operation of a base station for type A PUSCH repetition transmission is described. At 908, the base station may transmit configuration information for type A PUSCH repetition transmission to the UE through higher layer signaling or L1 signaling. At 909, the base station may configure and transmit downlink symbol configuration information and time domain resource allocation (TDRA) information of PUSCH repetition transmission through higher layer signaling (e.g., TDD configuration; tdd-UL-DL-ConfigurationCommon or tdd-UL-DL-ConfigurationDedicated) or L1 signaling (e.g., Slot format indicator). Then, at 910, based on the uplink resource allocation information configured to the UE, the base station may determine an available slot for type A PUSCH repetition transmission. At this time, the base station may determine the available slot by using any one or a combination of three methods 911, 912, and 913. In the first method 911, the base station may determine only a slot configured to be uplink as the available slot based on the configured TDD configuration information. In the second method 912, the base station may determine the available slot by considering the configured TDD configuration information, TDRA information for PUSCH transmission, CG-configuration, and activation DCI. In the third method 913, the base station may determine the available slot based on the configured TDD configuration information, TDRA information for PUSCH transmission, CG-configuration, activation DCI information, and dynamic slot format indicator (SFI). The method used to determine the available slot may be predefined/promised between the base station and the UE or may be configured and indicated semi-statically or dynamically through signaling between the base station and the UE. Thereafter, at 914, the base station may receive type A PUSCH repetition transmission from the UE through the determined available slot. This is exemplary only, are not limited to PUSCH transmission, and can also be applied to PUCCH transmission, PUSCH/PUCCH repetition transmission, nominal repetition of PUSCH repetition type B, and TBoMS.

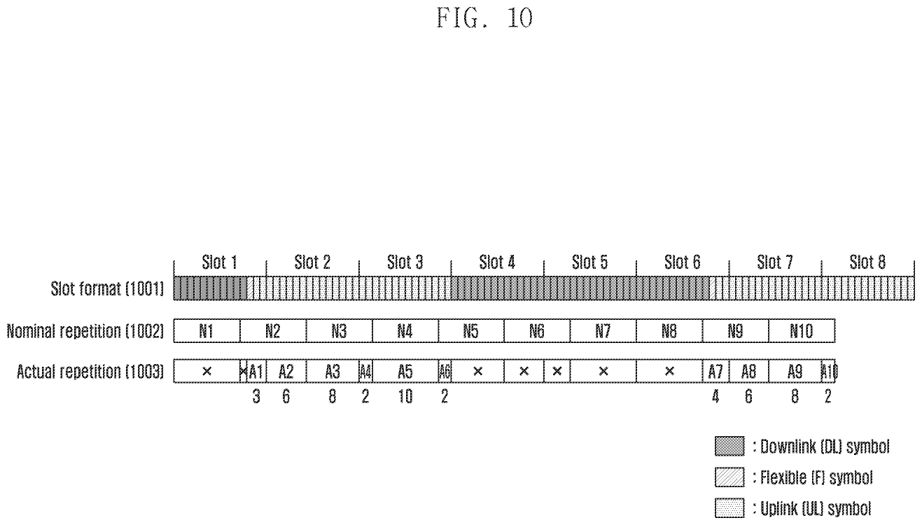

FIG. 10 is a diagram illustrating an example of PUSCH repetition type B according to an embodiment of the disclosure.

FIG. 10 shows an example in which for nominal repetition 1002, the UE is configured with a transmission start symbol S as 0, a transmission symbol length L as 10, and the number of repetition transmissions as 10, which are expressed as N1 to N10. In this case, the UE may determine an invalid symbol in consideration of a slot format 1001 to determine actual repetition 1003, which can be expressed as A1 to A10. According to the above-described method for determining the invalid symbol and the actual repetition, PUSCH repetition type B is not transmitted in symbols determined to be downlink (DL) in the slot format, and if a slot boundary exists within the nominal repetition, the actual repetition is divided into two based on the slot boundary. For example, A1 that means the first actual repetition may consist of 3 OFDM symbols, and A2 transmitted next may consist of 6 OFDM symbols.

In addition, for PUSCH repetition transmission, NR Release 16 may define the following additional methods for UL grant-based PUSCH transmission and configured grant-based PUSCH transmission across slot boundaries.
Method 1 (mini-slot level repetition): Through one UL grant, two or more PUSCH repetition transmissions are scheduled within one slot or across the boundaries of consecutive slots. Additionally, in Method 1, the time domain resource allocation information in DCI indicates the resource of the first repetition transmission. Also, based on the time domain resource information for the first repetition and the uplink or downlink direction determined for each symbol of each slot, the time domain resource information for the remaining repetition transmissions may be determined. Each repetition transmission occupies consecutive symbols.
Method 2 (multi-segment transmission): Through one UL grant, two or more PUSCH repetition transmissions are scheduled in consecutive slots. In this case, one transmission is designated for each slot, and the respective transmissions may be different in a starting point or a repetition length. Additionally, in Method 2, time domain resource allocation information in DCI indicates the starting point and repetition length of all repetition transmissions. In the case where repetition transmission is performed within a single slot through Method 2, if there are multiple bundles of consecutive uplink symbols within the slot, each repetition transmission is performed for each bundle of uplink symbols. If there is a unique (i.e., one) bundle of consecutive uplink symbols in the slot, one PUSCH repetition transmission is performed according to the method of NR Release 15.
Method 3: Through two or more UL grants, two or more PUSCH repetition transmissions are scheduled in consecutive slots. In this case, one transmission is designated for each slot, and the nth UL grant may be received before the PUSCH transmission scheduled by the (n−1)^{th} UL grant ends.
Method 4: Through one UL grant or one configured grant, one or multiple PUSCH repetition transmissions within a single slot, or two or more PUSCH repetition transmissions across the boundaries of consecutive slots may be supported. The number of repetition transmissions indicated to the UE by the base station is only a nominal value, and the number of PUSCH repetition transmissions actually performed by the UE may be greater than the nominal number of repetitions. The time domain resource allocation information within DCI or configured grant refers to the resource of the first repetition transmission indicated by the base station. The time domain resource information of the remaining repetition transmissions may be determined by referring to at least the resource information of the first repetition transmission and the uplink or downlink direction of the symbols. If the time domain resource information of the repetition transmission indicated by the base station spans a slot boundary or includes an uplink/downlink switching point, the corresponding repetition transmission may be divided into a plurality of repetition transmissions. In this case, one repetition transmission may be included for each uplink interval within one slot.

In the case of a conventional TPC command-based power control method, if the UE is scheduled for repetition transmission of an uplink data channel/control channel/reference signal from the base station, the same TPC command value could be applied between respective repetition transmissions. However, as the repetition transmission of the uplink data channel/control channel/reference signal gets farther away from the scheduling time point, there may be a need for the base station to additionally notify the UE of a power control indication compared to the initially indicated power control indication value because of changes in the distance between the base station and the UE due to movement of the UE, changes in the channel, changes in the scheduling situation for other UEs, etc. Therefore, in the disclosure, in the case where the UE is scheduled for repetition transmission of an uplink data channel/control channel/reference signal from the base station, a method of defining/configuring/indicating a time unit in which different TPC command values can be applied for each repetition transmission is specifically described by considering TPC command accumulation or absolute TPC command application operation, repetition transmission situations considering single or multiple TRPs, etc.

Hereinafter, higher layer signaling may be signaling corresponding to at least one or any combination of the following signalings.
MIB (Master Information Block)
SIB (System Information Block) or SIB X (X=1, 2, . . . )
RRC (Radio Resource Control)
MAC (Medium Access Control) CE (Control Element)
UE Capability Reporting
UE assistance information or message

In addition, L1 signaling may be signaling corresponding to at least one or any combination of the following physical layer channels or signaling methods.
PDCCH (Physical Downlink Control Channel)
DCI (Downlink Control Information)
UE-specific DCI
Group common DCI
Common DCI
Scheduling DCI (e.g., DCI used for the purpose of scheduling downlink or uplink data)
Non-scheduled DCI (e.g., DCI not for the purpose of scheduling downlink or uplink data)
PUCCH (Physical Uplink Control Channel)
UCI (Uplink Control Information)

### [PUSCH Power Control Method]

Now, a power control method for uplink data channel transmission in the

5G system will be described in detail. In the case where uplink data is transmitted through an uplink data channel (PUSCH; Physical Uplink Shared Channel) in response to a power control command received from the base station, a method for the UE to configure and transmit the transmit power of the uplink data channel is described. The uplink data channel transmit power of the UE, together with the i-th transmission unit, parameter set configuration index j, and the PUSCH power control adjustment state corresponding to the closed loop index l, can be determined as shown in Equation 3 below, which is expressed in dBm. In Equation 3 below, when the UE supports multiple carrier frequencies in multiple cells, each parameter can be set for each cell c, carrier frequency f, and bandwidth part b, and can be distinguished by indices b, f, and c.

$${P}_{PUSCH , b , f , c} ( i , j , {q}_{d} , l ) = min \{ \begin{matrix}{P}_{CMAX , f , c} ( i ) , \\ \begin{matrix}{P}_{0 \_ PUSCH , b , f , c} ( j ) + 10 {log}_{10} ( {2}^{μ} * {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ]$$

P_{CMax,f,c}(i). This is the maximum transmit power available to the UE in the i-th transmission unit and is determined by the power class of the UE, parameters activated from the base station, and various parameters embedded in the UE.
P_{o_PUSCH,b,f,c}(j): P_{o_PUSCH,b,f,c}(j) is composed of the sum of P_{o_NOMINAL_PUSCH,f,c}(j) and P_{o_UE_PUSCH,b,f,c}(j). P_{O_NOMINAL_PUSCH,f,c}(j) is configured to the UE via cell-specific higher layer signaling, and is a value configured via UE-specific higher layer signaling. Here, when j=0, it means PUSCH for transmitting msg3, when j=1, it means configured grant PUSCH, and if j is one of values {2, . . . , J−1}, it means grant PUSCH.
μ: Subcarrier spacing configuration value

$${M}_{RB , b , f , c}^{PUSCH} ( i ) :$$

This may refer to the amount of resources used in the i-th PUSCH transmission unit (e.g., the number of resource blocks (RBs) used for PUSCH transmission in the frequency domain).
α_{b,f,c}(j): This is a value to compensate for path loss and refers to a value that can be determined (in case of dynamic grant PUSCH) through higher layer configuration and SRS resource indicator (SRI).
PL_{b,f,c}(q_{d}). This indicates a path loss between the base station and the UE, and the UE calculates the path loss from a difference between the transmit power of the reference signal (RS) resource q_{d} signaled by the base station and the UE reception signal level of the reference signal. It means the downlink path loss estimated by the UE through the reference signal whose reference signal index is q_{d}, and the reference signal index q_{d} may be determined by the UE through the higher layer configuration and SRI (in the case of a configured grant PUSCH (type 2 configured grant PUSCH) based on ConfiguredGrantConfig that does not include dynamic grant PUSCH or higher layer configuration rrc-ConfiguredUplinkGrant) or through the higher layer configuration.
Δ_{TF,b,f,c}(i): This refers to a value determined according to the modulation coding scheme (MCS) and the format (transport format (TF), for example, whether UL-SCH is included or not or whether CSI is included or not, etc.) of information transmitted through PUSCH.
f_{b,f,c}(i,l): This is a closed loop power control adjustment value and refers to a value for the closed loop index/that can be determined by the higher layer configuration and SRI for PUSCH. Here, the closed loop power adjustment for PUSCH transmission can be supported selectively by an accumulation method for accumulatively applying the value indicated by the TPC command or an absolute method for directly applying the value indicated by the TPC command, and this can be determined depending on whether the higher layer parameter tpc-Accumulation is configured. If the higher layer parameter tpc-Accumulation is configured to disabled, the closed loop power adjustment for PUSCH transmission is performed by the absolute method, and if tpc-Accumulation is not configured, the closed loop power adjustment for PUSCH transmission is performed by the accumulation method.

The PUSCH power control adjustment state f_{b,f,c}(i,l) can be determined through the bandwidth part b, the carrier frequency f, the cell c, the i-th transmission unit, and the closed loop index l.
δ_{PUSCH,b,f,c}(i,l). This may be a value indicated by the TPC command field included in the DCI format 0_0, 0_1, or 0_2, which schedules the i-th PUSCH transmission unit corresponding to the closed loop index l in the bandwidth part b, the carrier frequency f, and the cell c, or a value indicated by the TPC command field included in the DCI format 2_2 transmitted together with the CRC scrambled by TPC-PUSCH-RNTI.
If the UE is configured with twoPUSCH-PC-AdjustmentStates, which is a higher layer signaling, the closed loop index/may have a value of 0 or 1.
If the UE is not configured with twoPUSCH-PC-AdjustmentStates, which is a higher layer signaling, or is scheduled for PUSCH transmission based on RAR UL grant, the closed loop index/may have a value of 0.
If the UE is configured with ConfiguredGrantConfig, which is a higher layer signaling, and performs PUSCH transmission or retransmission, the closed loop index/may follow the value of powerControlLoopToUse, which is a higher layer signaling.
If the UE is configured with SRI-PUSCH-PowerControl, which is an higher layer signaling, the UE can obtain a value indicated by the SRS resource indicator (SRI) field in the DCI format that schedules PUSCH transmission, and a connection relationship with the closed loop index l configured through sri-PUSCH-ClosedLoopIndex, which is a higher layer signaling, and determine the closed loop index l based on the value indicated by the SRI field in the DCI format based on the connection relationship.
If the UE is scheduled for PUSCH transmission based on a DCI format that does not include the SRI field, or is not configured with SRI-PUSCH-PowerControl, which is a higher layer signaling, the UE can regard the closed loop index l as 0.
If the UE is indicated with a TPC command value through a TPC command field included in DCI format 2_2 transmitted together with a CRC scrambled by TPC-PUSCH-RNTI, the closed loop index l can be indicated through the closed loop index field included in DCI format 2_2.
If the UE is not configured with the higher layer signaling tpc-Accumulation, i.e., if the TPC command accumulation operation is possible for the UE, the PUSCH power control adjustment state f_{b,f,c}(i,l) for the i-th PUSCH transmission unit corresponding to the closed loop index l within the bandwidth part b, carrier frequency f, and cell c can be calculated as in Equation 4.

$${f}_{b , f , c} ( i , l ) = {f}_{b , f , c} ( i - {i}_{0} , l ) + {\sum }_{m = 0}^{c ( {D}_{i} ) - 1} {δ}_{PUSCH , b , f , c} ( m , l ) \qquad Equation 4$$

δ_{PUSCH,b,f,c}(i,l) may be, as described above, a value indicated by a TPC command field included in DCI format 0_0, 0_1, or 0_2 which schedules the m-th PUSCH transmission unit corresponding to the closed loop index l within the bandwidth part b, the carrier frequency f, and the cell c, or may be a value indicated by a TPC command field included in DCI format 2_2 transmitted together with a CRC scrambled by TPC-PUSCH-RNTI. If TPC command accumulation operation is possible, the value of δ_{PUSCHb,f,c} may have a corresponding value in [dB] units depending on which value the TPC command field included in DCI format 0_0, 0_1, 0_2, or 2_2 is indicated with, as shown in Table 20 below. For example, if the value of the TPC command field is 0, δ_{PUSCH,b,f,c} may have a value of −1 dB.

### Table 20

TABLE 20

| TPC command | Accumulated δ_{PUSCH, b, f, c} or δ_{SRS, b, f, c} [dB] |
|---|---|
| field value | (in case of not configured with tpc-Accumulation) |
| 0 | −1 |
| 1 | 0 |
| 2 | 1 |
| 3 | 3 |

$${\sum }_{m = 0}^{c ( {D}_{i} ) - 1}$$

δ_{PUSCH,b,f,c}(m, l) may refer to the sum of δ_{PUSCH,b,f,c} for all transmission units corresponding to a specific set Dᵢ including the above-described TPC command values. Here, c(Dᵢ) may refer to the number of all elements belonging to the set Dᵢ. Dᵢ may refer to a set of DCIs including all TPC command values for performing TPC command accumulation operation for the i-th PUSCH transmission unit. In order to determine Dᵢ, a start point and an end point are defined in the time dimension, and all DCIs received by the UE between the two points may be included as elements of Dᵢ.
The end point for determining Dᵢ may be a point that is K_{PUSCH}(i) symbols before the start symbol of the i-th PUSCH transmission unit.
The start point for determining Dᵢ may be a point that is K_{PUSCH}(i−i₀)−1 symbols before the start symbol of the i−i₀-th PUSCH transmission unit. In this case, i₀, which is a positive integer, may be determined as the smallest value that satisfies that a time point that is K_{PUSCH}(i−i₀) symbols before the start symbol of the i−i₀-th PUSCH transmission unit is earlier in time than the end point (a point that is K_{PUSCH}(1) symbols before the start symbol of the i-th PUSCH transmission unit) for determining the Dᵢ
For example, in the case where the end point for determining Dᵢ can be defined as sym(i), and the time point that is K_{PUSCH}(i−i₀) symbols before the start symbol of the i−i₀-th PUSCH transmission unit can be defined as sym (i−i₀), then if sym(i)=sym(i−1)>sym(i−2)>sym(i−3) holds true, then i₀ can be determined as 2.
If the UE is configured with tpc-Accumulation, which is a higher layer signaling, that is, if the TPC command accumulation operation is impossible for the UE, the PUSCH power control adjustment state f_{b,f,c,}(i,l) for the i-th PUSCH transmission unit corresponding to the closed loop index l within the bandwidth part b, carrier frequency f, and cell c can be calculated as in Equation 5.

$${f}_{b , f , c} ( i , l ) = {δ}_{PUSCH , b , f , c} ( i , l ) \qquad Equation 5$$

As described above, δ_{PUSCHb,fv,c}(i,l) may be a value indicated by a TPC command field included in DCI format 0_0, 0_1, or 0_2 which schedules the i-th PUSCH transmission unit corresponding to the closed loop index l within the bandwidth part b, the carrier frequency f, and the cell c, or may be a value indicated by a TPC command field included in DCI format 2_2 transmitted together with a CRC scrambled by TPC-PUSCH-RNTI. If the TPC command accumulation operation is impossible, the δ_{PUSCHb,f,c} is value may have a corresponding value in [dB] units depending on which value the TPC command field included in DCI format 0_0, 0_1, 0_2, or 2_2 is indicated with, as shown in Table 21 below. For example, if the value of the TPC command field is 0, δ_{PUSCHb,f,c} may have a value of −4 dB.

TABLE 21

| TPC command | Absolute δ_{PUSCH, b, f, c} or δ_{SRS, b, f, c} [dB] |
|---|---|
| field value | (in case of configured with tpc-Accumulation) |
| 0 | −4 |
| 1 | −1 |
| 2 | 1 |
| 3 | 4 |

As described above, when the UE can perform the TPC command accumulation operation (i.e., if the higher layer signaling tpc-Accumulation is not configured), various methods can be considered for determining the definition of K_{PUSCH}(i) applicable to the i-th PUSCH transmission unit corresponding to the closed loop index l within the bandwidth part b, the carrier frequency f, and the cell c, or when the UE cannot perform the TPC command accumulation operation and operates through the absolute value (i.e., if the higher layer signaling tpc-Accumulation is configured), various methods can be considered for determining the definition of δ_{PUSCHb,f,c}(i,l) applicable to the i-th PUSCH transmission unit corresponding to the closed loop index l within the bandwidth part b, the carrier frequency f, and the cell c.

### [Condition 1-1]

If the UE is configured with one SRS-ResourceSet in which usage, which is a higher layer signaling, is configured to codebook or noncodebook, and if the i-th PUSCH transmission is scheduled through a DCI format, or
If the UE is configured with two SRS-ResourceSets in which usage, which is a higher layer signaling, is configured to codebook or noncodebook, if the i-th PUSCH transmission is scheduled through a DCI format, and if the dynamic switching field between single TRP and multiple TRP transmissions in the DCI format indicates a single TRP transmission (i.e., the value ‘00’ or ‘01’ is indicated through the dynamic switching field),
The UE can receive scheduling for a single PUSCH transmission unit, scheduling for multiple repeated PUSCH transmission units, or scheduling for multiple independent PUSCH transmission units through PDCCH reception.
The case of having multiple PUSCH transmission units through PDCCH reception may be as follows.
If the UE is configured with the higher layer signaling pusch-aggregationfactor, the UE can receive scheduling for multiple PUSCH transmission units having a semi-statically fixed number of repetition transmissions.
If the UE is configured with pusch-RepTypeA or pusch-RepTypeB for pusch-RepTypeIndicatorDCI-0-1-r16 or pusch-RepTypeIndicatorDCI-0-2-r16, which is an higher layer signaling, and an entry indicated by a TDRA field existing in DCI format 0_1 or 0_2 corresponds to the higher layer signaling PUSCH-TimeDomainResourceAllocation-r16 which includes one higher layer signaling PUSCH-Allocation-r16 in which the value of numberOfRepetitions-r16 greater than 1 is configured, the UE can receive scheduling for multiple PUSCH transmission units having a number of repetition transmissions that can be dynamically indicated.
If an entry indicated by a TDRA field existing in DCI format 0_1 or 0_2 corresponds to the higher layer signaling PUSCH-TimeDomainResourceAllocation-r16 which includes more than one higher layer signaling PUSCH-Allocation-r16, the UE can receive scheduling for a plurality of independent PUSCH transmission units corresponding to the number that can be dynamically indicated.

### [Condition 1-1-1]

In addition to the above Condition 1-1, if the UE can perform TPC command accumulation operation (i.e., if the higher layer signaling tpc-Accumulation is not configured), the following methods may be considered.

[Method 1-1-1-1] K_{PUSCH}(i) applicable to the i-th PUSCH transmission unit may refer to a symbol length from the end point of the last symbol that receives the PDCCH that schedules the i-th PUSCH transmission unit to the start point of the i-th PUSCH transmission unit.
If the UE receives scheduling for the i, i+1, . . . , i+N-1th PUSCH transmission units through reception of corresponding one PDCCH, the end points of the last symbol of the PDCCH that determine all of K_{PUSCH}(i), K_{PUSCH}(i+1), . . . , K_{PUSCH}(i+N−1) applicable to the i, i+1, . . . , i+N-1th PUSCH transmission units may all be the same. Therefore, since the end points for determining Dᵢ according to the above are all the same, the values to which TPC command accumulation is applied may all be the same for all PUSCH transmission units scheduled by the corresponding PDCCH. In this case, there is an advantage of simplifying the operation of the UE without complicating it by applying the power control value that can be determined at the PDCCH scheduling time point to all PUSCH transmission units, but it is an inflexible method in that dynamic power control via L1 signaling (e.g., DCI format 2_2) is impossible for PUSCH transmission units that are transmitted relatively later in time.

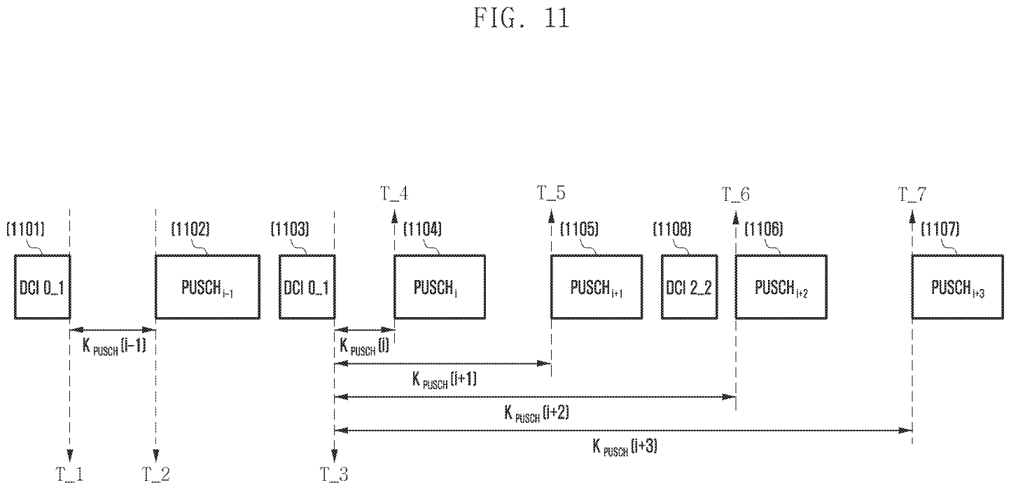

FIG. 11 is a diagram illustrating calculation of a PUSCH power control adjustment state according to an embodiment of the disclosure.

In FIG. 11, DCI format 0_1 1101 schedules a single PUSCH transmission unit, PUSCHᵢ₋₁ 1102, and DCI format 0_1 1103 schedules four PUSCH transmission units, PUSCH; 1104, PUSCHᵢ₊₁ 1105, PUSCHᵢ₊₂ 1106, and PUSCHᵢ₋₃ 1107. For the i-th PUSCH transmission unit, i₀ can be obtained to determine the above Dᵢ. Since T 3 which is K_{PUSCH}(i) ahead of T_4 which is the start point of the first symbol of PUSCHᵢ is later in time than T_1 which is k_{PUSCH}(i−1) ahead of T_2 which is the start point of the first symbol of PUSCHᵢ₋₁, that is, since T_1<T_3, i₀ can be 1. Therefore, the TPC command value included in Dᵢ can be a value included in DCI 0_1 1103. As described above, K_{PUSCH}(i) can be determined through the symbol length from the end point of the last symbol that receives the PDCCH that schedules the i-th PUSCH transmission unit to the start point of the i-th PUSCH transmission unit, so that all of K_{PUSCH}(i) to K_{PUSCH}(i+3) corresponding to PUSCHᵢ, PUSCHᵢ₊₁, PUSCHᵢ₊₂, and PUSCHᵢ₊₃ start from T_3, which is the end point of the last symbol that receives the PDCCH. Therefore, even if the DCI format 2_2 1108 is received between the PUSCH transmission units, the TPC command value included in the DCI format 2_2 1108 cannot be used for accumulation.

[Method 1-1-1-2] K_{PUSCH(i)} applicable to the i-th PUSCH transmission unit may refer to the symbol length from the end point of the last symbol that receives the PDCCH that schedules the i-th PUSCH transmission unit to the start point of the PUSCH transmission unit that is transmitted earliest in time among all PUSCH transmission units scheduled by the corresponding PDCCH.
If the UE receives scheduling for one PUSCH transmission unit through reception of one corresponding PDCCH, Method 1-1-1-2 may derive the same K_{PUSCH(i)} value as Method 1-1-1-1.
If the UE receives scheduling for the i, i+1, . . . , i+N-1th PUSCH transmission units through reception of one corresponding PDCCH, K_{PUSCH}(i) K_{PUSCH}(i+1), . . . , K_{PUSCH}(i+N−1) applicable to the i, i+1, . . . , i+N-1th PUSCH transmission units may have the same value as K_{PUSCH}(i) applicable to the i-th PUSCH transmission unit transmitted earliest in time among all PUSCH transmission units scheduled by the corresponding PDCCH. Therefore, since the end points for determining Dᵢ are all different according to the above, the value to which TPC command accumulation is applied for all PUSCH transmission units scheduled by the corresponding PDCCH may be different for each PUSCH transmission unit. In this case, although the UE operation may become relatively complicated, it can be said to be a flexible method from the perspective of power control in that dynamic power control is possible through L1 signaling (e.g., DCI format 2_2) for the PUSCH transmission unit transmitted relatively later in time as well as the power control value that can be determined at the PDCCH scheduling time point.

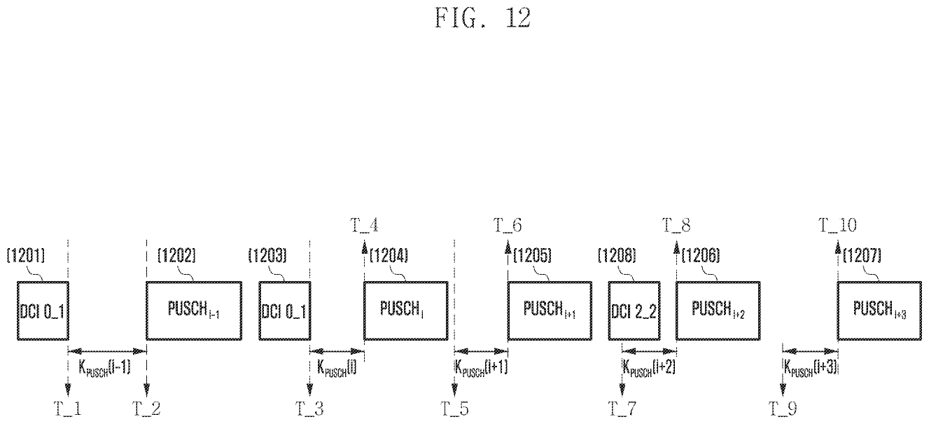

FIG. 12 is another diagram illustrating calculation of a PUSCH power control adjustment state according to an embodiment of the disclosure.

In FIG. 12, DCI format 0_1 1201 schedules a single PUSCH transmission unit, PUSCHᵢ₋₁ 1202, and DCI format 0_1 1203 schedules four PUSCH transmission units, PUSCH; 1204, PUSCHᵢ₊₁ 1205, PUSCHᵢ₊₂ 1206, and PUSCHᵢ₊₃ 1207. For the i-th PUSCH transmission unit, i₀ can be obtained to determine the above Dᵢ. Since T_3 which is K_{PUSCH}(i) ahead of T_4 which is the start point of the first symbol of PUSCH; is later in time than T_1 which is K_{PUSCH}(i−1) ahead of T_2 which is the start point of the first symbol of PUSCHᵢ₋₁, that is, since T_1<T_3, i₀ can be 1. Therefore, the TPC command value included in Dᵢ can be a value included in DCI 0_1 1203. As described above, since K_{PUSCH}(i) can be determined through the symbol length from the end point of the last symbol that receives the PDCCH that schedules the i-th PUSCH transmission unit to the start point of the PUSCH transmission unit that is transmitted earliest in time among all PUSCH transmission units scheduled by the corresponding PDCCH, all of K_{PUSCH}(i) to K_{PUSCH}(i+3) corresponding to PUSCHᵢ, PUSCHᵢ₊₁, PUSCHᵢ₊₂, and PUSCHᵢ₊₃ can have the same value as K_{PUSCH}(i). Therefore, in case of obtaining i₀ to determine Dᵢ₊₁ for the i+1th PUSCH transmission unit, i₀ can be 1 since T_3<T_5, and there is no TPC command value included in Dᵢ₊₁. In case of obtaining i₀ to determine Dᵢ₊₂ for the i+2th PUSCH transmission unit, i₀ can be 1 since T_5<T_7, and the TPC command value included in Dᵢ₊₂ can be the DCI format 2_2 1208 received between PUSCHᵢ₊₁ and PUSCHᵢ₊₂. In case of obtaining i₀ to determine Dᵢ₊₃ for the i+3th PUSCH transmission unit, i₀ can be 1 since T_7<T_9, and the TPC command value included in Dᵢ₊₃ can be the DCI format 2_2 1208 received between PUSCHᵢ₊₁ and PUSCHᵢ₊₂.

[Method 1-1-1-3] K_{PUSCH}(i) applicable to the i-th PUSCH transmission unit may refer to a symbol length configured by higher layer signaling.
If the UE receives scheduling for one PUSCH transmission unit through reception of one corresponding PDCCH, the UE may be configured with one symbol length via higher layer signaling.
If the UE receives scheduling for the i, i+1, . . . , i+N-1th PUSCH transmission units through reception of one corresponding PDCCH, K_{PUSCH}(i), K_{PUSCH}(i+1), K_{PUSCH}(i+N−1) applicable to the i, i+1, . . . , i+N−1th PUSCH transmission units may all have the same value based on one higher layer signaling value, or may have different values based on N different higher layer signaling values. Therefore, since the end points for determining Dᵢ are all different according to the above, the value to which TPC command accumulation is applied for all PUSCH transmission units scheduled by the corresponding PDCCH may be different for each PUSCH transmission unit. In addition, if Method 1-1-1-2 is used, a symbol interval from a certain PDCCH to the first PUSCH transmission unit scheduled may not always be the same as a symbol interval from another PDCCH to the first PUSCH transmission unit scheduled, so that K_{PUSCH}(i) to be considered from a specific PUSCH transmission unit may vary depending on different PDCCH scheduling. In contrast, in the case of configuring the value through higher layer signaling as in Method 1-1-1-3, there may be the advantage of allowing UE operation to be controlled relatively simply and consistently.
In case where the above-described higher layer signaling is one
   In one example, the signaling may have a symbol unit value as an independent higher layer signaling for TPC command accumulation, and this may be defined as K_{PUSCH,min}.
   In another example, the signaling may be the number of symbols obtained by multiplying the smallest value among the scheduling slot offset k2 or k2-16, which are higher layer signalings configured in all TDRA entries, by 14, and this may be defined as K_{PUSCH,min}.
   In still another example, the signaling may be the number of symbols obtained by multiplying the smallest value among the scheduling slot offset k2, which are configured in the higher layer signaling PUSCH-ConfigCommon, by 14, and this may be defined as K_{PUSCH,min}.
In case where the above-described higher layer signaling is plural
   In one example, the signaling may have a symbol unit value as multiple independent higher layer signalings for TPC command accumulation, and if the number of repetition transmissions is N, they may be defined as K_{PUSCH,min,1}, . . . , K_{PUSCH,min,N}, respectively.
   In another example, the signaling may be the number of symbols obtained by multiplying k2 or k2-16 by 14, considering the number of PUSCH transmission units scheduled by the corresponding PDCCH from the smallest value of all scheduling slot offsets k2 or k2-16, which are higher layer signalings configured in all TDRA entries, and if the number of repetition transmissions is N, they may be defined as K_{PUSCH,min,1}, . . . , K_{PUSCH,min,N}, respectively.
   In still another example, the signaling may be the number of symbols obtained by multiplying k2 by 14, considering the number of PUSCH transmission units scheduled by the corresponding PDCCH from the smallest value of all scheduling slot offsets k2 set in higher layer signaling PUSCH-ConfigCommon, and if the number of repetition transmissions is N, these may be defined as K_{PUSCH,min,1}, . . . , K_{PUSCH,min,N}, respectively.

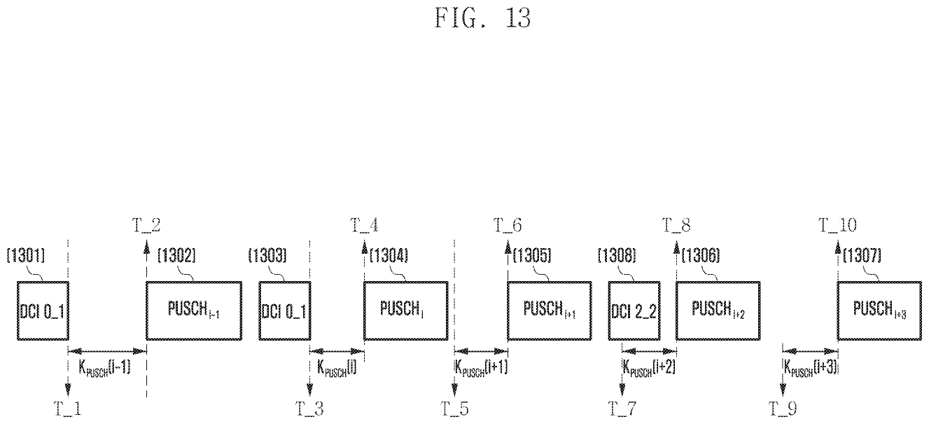

FIG. 13 is still another diagram illustrating calculation of a PUSCH power control adjustment state according to an embodiment of the disclosure.

In FIG. 13, DCI format 0_1 1301 schedules a single PUSCH transmission unit, PUSCHᵢ₋₁ 1302, and DCI format 0_1 1303 schedules four PUSCH transmission units, PUSCHᵢ 1304, PUSCHᵢ₊₁ 1305, PUSCHᵢ₊₂ 1306, and PUSCHᵢ₊₃ 1307. For the i-th PUSCH transmission unit, i₀ can be obtained to determine the above Dᵢ. Since T_3 which is K_{PUSCH}(i) ahead of T_4 which is the start point of the first symbol of PUSCHᵢ is later in time than T_1 which is K_{PUSCH}(i−1) ahead of T_2 which is the start point of the first symbol of PUSCHᵢ₋₁, that is, since T_1<T_3, i₀ can be 1. Therefore, the TPC command value included in Dᵢ can be a value included in DCI 0_1 1303. As described above, K_{PUSCH}(i) can be determined through higher layer signaling, and in this drawing, it is assumed that one higher layer signaling is configured and the corresponding value is applied equally to all PUSCH transmission units. That is, all of K_{PUSCH}(i) to K_{PUSCH}(i+3) corresponding to PUSCHᵢ, PUSCHᵢ₊₁, PUSCHᵢ₊₂, and PUSCHᵢ₊₃ can have the same value as K_{PUSCH}(i) which is the number of symbols configured via higher layer signaling. Therefore, in case of obtaining i₀ to determine Dᵢ₊₁ for the i+1th PUSCH transmission unit, i₀ can be 1 since T_3<T_5, and there is no TPC command value included in Dᵢ₊₁. In case of obtaining i₀ to determine Dᵢ₊₂ for the i+2th PUSCH transmission unit, i₀ can be 1 since T_5<T_7, and the TPC command value included in Dᵢ₊₂ can be the DCI format 2_2 1308 received between PUSCHᵢ₊₁ and PUSCHᵢ₊₂. In case of obtaining i₀ to determine Dᵢ₊₃ for the i+3th PUSCH transmission unit, i₀ can be 1 since T_7<T_9, and the TPC command value included in Dᵢ₊₃ can be the DCI format 2 2 1308 received between PUSCHᵢ₊₁ and PUSCHᵢ₊₂.

[Method 1-1-1-4] PUSCH (i) applicable to the i-th PUSCH transmission unit may refer to a symbol length from the end point of the last symbol that receives the PDCCH to the start point of the i-th PUSCH transmission unit if the i-th PUSCH transmission unit is the first PUSCH transmission unit scheduled through the PDCCH, and may refer to a symbol length from the end point of the last symbol, where the i-1th PUSCH transmission unit is transmitted, to the start point of the i-th PUSCH transmission unit if the i-th PUSCH transmission unit is not the first PUSCH transmission unit scheduled through the PDCCH.
If the UE receives scheduling for one PUSCH transmission unit through reception of one corresponding PDCCH, Method 1-1-1-4 can derive the same K_{PUSCH}(i) value as Method 1-1-1-1.
If the UE receives scheduling for the i, i+1, . . . , i+N−1th PUSCH transmission units through reception of corresponding one PDCCH, K_{PUSCH}(i) applicable to the i-th PUSCH transmission unit is calculated using the PDCCH that schedules it and the time point of the i-th PUSCH transmission unit, and when determining K_{PUSCH}(i+1), . . . , K_{PUSCH}(1+N−1) applicable to the i+1, . . . , i+N−1th PUSCH transmission, units, they are calculated by considering each of the i, . . . , i+N−2th PUSCH transmission units, similar to the PDCCH used to calculate K_{PUSCH}(i) for the i-th PUSCH transmission unit.

[Method 1-1-1-5] K_{PUSCH}(i) applicable to the i-th PUSCH transmission unit may refer to a symbol length from the end point of the last symbol that receives the PDCCH to the start point of the i-th PUSCH transmission unit if the i-th PUSCH transmission unit is the first PUSCH transmission unit scheduled through the PDCCH, and may refer to a symbol length from the end point of the closest downlink symbol that exists before the ith PUSCH transmission unit to the start point of the i-th PUSCH transmission unit if the i-th PUSCH transmission unit is not the first PUSCH transmission unit scheduled through the PDCCH.
If the UE receives scheduling for one PUSCH transmission unit through reception of one corresponding PDCCH, Method 1-1-1-5 can derive the same K_{PUSCH}(i) value as Method 1-1-1-1.

[Method 1-1-1-6] The UE can define K_{PUSCH}(i) applicable to the i-th PUSCH transmission unit through a combination of the above-described Methods 1-1-1-1 to 1-1-1-5. For example, if the UE receives scheduling for N repeated i, i+1, . . . , i+N-1-th PUSCH transmission units through the PDCCH, Method 1-1-1-1 can be used to define K_{PUSCH}(i) for the i-th PUSCH transmission unit, which is the first among them, and Method 1-1-1-2 can be used for K_{PUSCH}(i+1), . . . , K_{PUSCH}(i+N−1) for the remaining i+1, . . . , i+N−1-th PUSCH transmission units.

[Method 1-1-1-7] The UE may use one of the above-described Methods 1-1-1-1 to 1-1-1-6 as a method of defining K_{PUSCH}(i) by configuring it through higher layer signaling from the base station. For example, the UE may receive configuration called tpcAccumulationTimeDetermination, which is a higher layer signaling, from the base station, and the corresponding higher layer signaling may be configured to one of scheme1 to scheme6, where scheme1 to scheme6 may refer to the above-described Methods 1-1-1-1 to 1-1-1-6, respectively.

[Method 1-1-1-8] The UE may be configured with a higher layer signaling (e.g., enableTPCAccumulationTimeDetermination) indicating whether to use a method for defining K_{PUSCH}(i) from the base station, wherein if the corresponding higher layer signaling is not configured, it may mean to define K_{PUSCH}(i) by using one (e.g., Method 1-1-1-1) of the above-described Methods 1-1-1-1 to 1-1-1-6, and if the corresponding higher layer signaling is configured (e.g., if the UE receives a configuration value of on), it may mean that it is possible to use a specific K_{PUSCH}(i) definition method. In this case, the specific K_{PUSCH}(i) definition method may be one (e.g., Method 1-1-1-6) of the above-described Methods 1-1-1-1 to 1-1-1-6 except for a method used when the corresponding higher layer signaling is not configured.

### [Condition 1-1-2]

In addition to the above Condition 1-1, if the UE cannot perform the TPC command accumulation operation and operates through the absolute value (i.e., if the higher layer signaling tpc-Accumulation is configured)

[Method 1-1-2-1] δ_{PUSCH,b,f,c}(i,l) may be a TPC command field value included in the PDCCH that schedules the i-th PUSCH transmission unit corresponding to the closed loop index l within the bandwidth part b, carrier frequency f, and cell c.
In this method, the UE may receive scheduling for one PUSCH transmission unit through reception of corresponding one PDCCH, or receive scheduling for multiple PUSCH transmission units through reception of corresponding one PDCCH, or the same absolute TPC command value may be applied to all PUSCH transmission units.
In this method, if the UE receives scheduling for multiple PUSCH transmission units through reception of corresponding one PDCCH, since δ_{PUSCHb,f,c}(i,l) only follows the value of the TPC command field included in the scheduling PDCCH, the value of the TPC command field included in the DCI format 2_2 transmitted together with the CRC scrambled by TPC-PUSCH-RNTI between transmissions of two PUSCH transmission units may not be applied.

[Method 1-1-2-2] δ_{PUSCH,b,f,c}(i,l) may be the most recently received TPC command value before transmission of the i-th PUSCH transmission unit corresponding to the closed loop index l within the bandwidth part b, carrier frequency f, and cell c.
In this method, the UE may receive scheduling for one PUSCH transmission unit through reception of corresponding one PDCCH, or receive scheduling for multiple PUSCH transmission units through reception of corresponding one PDCCH, or if there is no DCI format 2_2 transmitted together with the CRC scrambled by TPC-PUSCH-RNTI transmitted more recently than the scheduling PDCCH for all PUSCH transmission units, the absolute TPC command value included in the scheduling PDCCH may be applied equally to all PUSCH transmission units.
In this method, in the case where the UE receives scheduling for multiple PUSCH transmission units through reception of corresponding one PDCCH, if DCI format 2_2 transmitted together with the CRC scrambled by TPC-PUSCH-RNTI is received between transmissions of the i-th and i+1-th PUSCH transmission units, and the most recently received TPC command value from the i-th PUSCH transmission unit is a value indicated by the TPC command field included in the scheduling PDCCH, then the absolute TPC command value applied to the i-th PUSCH transmission unit may follow the value indicated by the scheduling PDCCH, and for the i+1-th PUSCH transmission unit, it may follow the absolute TPC command value included in the DCI format 2_2.

[Method 1-1-2-3] δ_{PUSCH,b,f,c}(i,l) may be the most recently received TPC command value from a time point earlier by Pusch (1) symbols than the transmission of the i-th PUSCH transmission unit corresponding to the closed loop index l within the bandwidth part b, carrier frequency f, and cell c.
A method for defining K_{PUSCH}(i) can apply one of the above-described Methods 1-1-1-1 to 1-1-1-8.

### [Condition 1-2]

If the UE is configured with two SRS-ResourceSets in which usage, which is a higher layer signaling, is configured to codebook or noncodebook, and if the i-th PUSCH transmission is scheduled through a DCI format,
If the dynamic switching field between single TRP and multiple TRP transmissions in the DCI format indicates multiped TRP transmission (i.e., the value ‘10’ or ‘11’ is indicated through the dynamic switching field),
The UE can receive scheduling for multiple repeated PUSCH transmission units through PDCCH reception.
If the UE is configured with pusch-RepTypeA or pusch-RepTypeB for pusch-RepTypeIndicatorDCI-0-1-r16 or pusch-RepTypeIndicatorDCI-0-2-r16, which is an higher layer signaling, and an entry indicated by a TDRA field existing in DCI format 0_1 or 0_2 corresponds to the higher layer signaling PUSCH-TimeDomainResourceAllocation-r16 which includes one higher layer signaling PUSCH-Allocation-r16 in which the value of numberOfRepetitions-r16 greater than 1 is configured, the UE can receive scheduling for multiple PUSCH transmission units having a number of repetition transmissions that can be dynamically indicated.
The UE can be configured with a cyclic mapping or sequential mapping via higher layer signaling as a method of applying different transmission beams or spatial relation info to multiple repeatedly transmitted PUSCH transmission units.
If ‘10’ is indicated through the dynamic switching field, the first PUSCH transmission unit can be connected to the first SRS resource set, and the remaining PUSCH transmission units can be applied according to the method of applying the transmission beams or spatial relation info. For example, in case of cyclic mapping, odd-numbered (first, third, etc.) PUSCH transmission units can be connected to the first SRS resource set, and even-numbered (second, fourth, etc.) PUSCH transmission units can be connected to the second SRS resource set.
If ‘11’ is indicated through the dynamic switching field, the first PUSCH transmission unit can be connected to the second SRS resource set, and the remaining PUSCH transmission units can be applied according to the method of applying the transmission beams or spatial relation information. For example, in case of cyclic mapping, odd-numbered (first, third, etc.) PUSCH transmission units can be connected to the second SRS resource set, and even-numbered (second, fourth, etc.) PUSCH transmission units can be connected to the first SRS resource set.

### [Condition 1-2-1]

In addition to the above Condition 1-2, if the UE can perform TPC command accumulation operation (i.e., if the higher layer signaling tpc-Accumulation is not configured),

[Method 1-2-1-1] K_{PUSCH}(i) applicable to the i-th PUSCH transmission unit may refer to a symbol length from the end point of the last symbol that receives the PDCCH that schedules the i-th PUSCH transmission unit to the start point of the i-th PUSCH transmission unit.
If the UE receives scheduling for the i, i+1, . . . , i+N-1th PUSCH transmission units through reception of corresponding one PDCCH, the end points of the last symbol of the PDCCH that determine all of K_{PUSCH}(i), K_{PUSCH}(i+1), . . . , K_{PUSCH}(i+N−1) applicable to the i, i+1, . . . , i+N−1th PUSCH transmission units may all be the same. Therefore, since the end points for determining Dᵢ according to the above are all the same, the values to which TPC command accumulation is applied may all be the same for all PUSCH transmission units scheduled by the corresponding PDCCH. In this case, there is an advantage in that the operation of the UE can be simplified without complicating it by applying the power control value that can be determined at the PDCCH scheduling time point through two TPC command field values corresponding to each closed loop index l (e.g., 0 or 1) existing in the PDCCH that schedules multiple TRP transmissions to all PUSCH transmission units corresponding to a specific closed loop index l, but it is an inflexible method in that dynamic power control via L1 signaling (e.g., DCI format 2_2) is impossible for PUSCH transmission units that are transmitted relatively later in time.

[Method 1-2-1-2] K_{PUSCH}(i) applicable to the i-th PUSCH transmission unit may refer to the symbol length from the end point of the last symbol that receives the PDCCH that schedules the i-th PUSCH transmission unit to the start point of the PUSCH transmission unit that is transmitted earliest among all PUSCH transmission units to which the transmission beam or spatial relation information applied to the i-th PUSCH transmission unit is identically applied.
If the UE receives scheduling for the i, i+1, . . . , i+N−1th PUSCH transmission units through reception of one corresponding PDCCH, and is configured with cyclic mapping as the transmission beam or spatial relation info application method via higher layer signaling, the values applicable to odd-numbered transmission units (i, i+2, i+4, . . . ) can all be the same as K PUSCH (i) value. In this case, if a different closed loop index l (e.g., 0 or 1) is used for each TRP, K_{PUSCH}(i) and K_{PUSCH}(i+1) can be used for each closed loop index. However, since the value of K_{PUSCH}(i+1) becomes relatively larger than the value of K_{PUSCH}(i) corresponding to the transmission beam or spatial relation info that is applied temporally first among multiple repeated PUSCH transmission units scheduled by PDCCH, there may be a disadvantage that flexible power control may not be possible for PUSCH transmission units corresponding to the transmission beam or spatial relation info that is applied temporally later.

[Method 1-2-1-3] A K_{PUSCH}(i) applicable to the i-th PUSCH transmission unit may refer to the symbol length from the end point of the last symbol that receives the PDCCH that schedules the i-th PUSCH transmission unit to the start point of the PUSCH transmission unit that is transmitted earliest among all PUSCH transmission units scheduled by the corresponding PDCCH.
If the UE receives scheduling for the i, i+1, . . . , i+N−1th PUSCH transmission units through reception of one corresponding PDCCH, K_{PUSCH}(i), K_{PUSCH}(i+1), . . . , K_{PUSCH}(i+N−1) applicable to the i, i+1, . . . , i+N−1th PUSCH transmission units may have the same value as K_{PUSCH}(i) applicable to the i-th PUSCH transmission unit transmitted earliest in time among all PUSCH transmission units scheduled by the corresponding PDCCH. Therefore, since the end points for determining Dᵢ are all different according to the above, the value to which TPC command accumulation is applied for all PUSCH transmission units scheduled by the corresponding PDCCH may be different for each PUSCH transmission unit. In this case, although the UE operation may become relatively complicated, it can be said to be a flexible method from the perspective of power control in that dynamic power control is possible through L1 signaling (e.g., DCI format 2_2) for the PUSCH transmission unit transmitted relatively later in time as well as the power control value that can be determined at the PDCCH scheduling time point. In addition, compared to Method 1-2-1-2, since the K_{PUSCH}(i) values corresponding to different transmission beams or spatial relation info are all the same, the flexibility of power control applied to each transmission beam can be similarly achieved.

[Method 1-2-1-4] K_{PUSCH}(i) applicable to the i-th PUSCH transmission unit may refer to a symbol length configured by higher layer signaling.
If the UE receives scheduling for the i, i+1, . . . , i+N−1th PUSCH transmission units through reception of one corresponding PDCCH, K_{PUSCH}(i), K_{PUSCH}(i+1), . . . , K_{PUSCH}(i+N−1), applicable to the i, i+1, . . . , i+N−1th PUSCH transmission units may all have the same value based on one higher layer signaling value, or may have respective values based on different higher layer signaling depending on the number of different transmission beams or spatial relation information. Therefore, since the end points for determining Dᵢ are all different according to the above, the value to which TPC command accumulation is applied for all PUSCH transmission units scheduled by the corresponding PDCCH may be different for each PUSCH transmission unit. In addition, if Method 1-2-1-3 is used, a symbol interval from a certain PDCCH to the first PUSCH transmission unit scheduled may not always be the same as a symbol interval from another PDCCH to the first PUSCH transmission unit scheduled, so that K_{PUSCH}(i) to be considered from a specific PUSCH transmission unit may vary depending on different PDCCH scheduling. In contrast, in the case of configuring the value through higher layer signaling as in Method 1-2-1-4, there may be the advantage of allowing UE operation to be controlled relatively simply and consistently.
In case where the above-described higher layer signaling is one
In one example, the signaling may have a symbol unit value as an independent higher layer signaling for TPC command accumulation.
In another example, the signaling may be the number of symbols obtained by multiplying the smallest value among the scheduling slot offset k2 or k2-16, which are higher layer signalings configured in all TDRA entries, by 14.
In still another example, the signaling may be the number of symbols obtained by multiplying the smallest value among the scheduling slot offset k2, which are configured in the higher layer signaling PUSCH-ConfigCommon, by 14.
In case where the above-described higher layer signaling has the same number as different transmission beams or spatial relation information
In one example, the signaling may have a symbol unit value as multiple independent higher layer signalings for TPC command accumulation.
In another example, the signaling may be the number of symbols obtained by multiplying k2 or k2-16 by 14, considering the number of PUSCH transmission units scheduled by the corresponding PDCCH from the smallest value of all scheduling slot offsets k2 or k2-16, which are higher layer signalings configured in all TDRA entries.
In still another example, the signaling may be the number of symbols obtained by multiplying k2 by 14, considering the number of PUSCH transmission units scheduled by the corresponding PDCCH from the smallest value of all scheduling slot offsets k2 set in higher layer signaling PUSCH-ConfigCommon.

### [Condition 1-2-2]

In addition to the above Condition 1-2, if the UE cannot perform the TPC command accumulation operation and operates through the absolute value (i.e., if the higher layer signaling tpc-Accumulation is configured)

[Method 1-2-2-1] δ_{PUSCH,b,f,c}(i,l) may be a TPC command field value included in the PDCCH that schedules the i-th PUSCH transmission unit corresponding to the closed loop index l within the bandwidth part b, carrier frequency f, and cell c.
In this method, the UE may receive scheduling for one PUSCH transmission unit through reception of corresponding one PDCCH, or receive scheduling for multiple PUSCH transmission units through reception of corresponding one PDCCH, or the same absolute TPC command value may be applied to all PUSCH transmission units.
In this method, if the UE receives scheduling for multiple PUSCH transmission units through reception of corresponding one PDCCH, since δ_{PUSCH,b,f,c}(i,l) only follows the value of the TPC command field included in the scheduling PDCCH, the value of the TPC command field included in the DCI format 2_2 transmitted together with the CRC scrambled by TPC-PUSCH-RNTI between transmissions of two PUSCH transmission units may not be applied.

[Method 1-2-2-2] δ_{PUSCH,b,f,c}(i,l) may be the most recently received TPC command value before transmission of the i-th PUSCH transmission unit corresponding to the closed loop index l within the bandwidth part b, carrier frequency f, and cell c.
In this method, the UE may receive scheduling for one PUSCH transmission unit through reception of corresponding one PDCCH, or receive scheduling for multiple PUSCH transmission units through reception of corresponding one PDCCH, or if there is no DCI format 2_2 transmitted together with the CRC scrambled by TPC-PUSCH-RNTI transmitted more recently than the scheduling PDCCH for all PUSCH transmission units, the absolute TPC command value included in the scheduling PDCCH may be applied equally to all PUSCH transmission units.
In this method, in the case where the UE receives scheduling for multiple PUSCH transmission units through reception of corresponding one PDCCH, if DCI format 2_2 transmitted together with the CRC scrambled by TPC-PUSCH-RNTI is received between transmissions of the i-th and i+1-th PUSCH transmission units, and the most recently received TPC command value from the i-th PUSCH transmission unit is a value indicated by the TPC command field included in the scheduling PDCCH, then the absolute TPC command value applied to the i-th PUSCH transmission unit may follow the value indicated by the scheduling PDCCH, and for the i+1-th PUSCH transmission unit, it may follow the absolute TPC command value included in the DCI format 2_2.

[Method 1-2-2-3]δ_{PUSCH,b,f,c}(i,l) may be the most recently received TPC command value from a time point earlier by K_{PUSCH}(i) symbols than the transmission of the i-th PUSCH transmission unit corresponding to the closed loop index l within the bandwidth part b, carrier frequency f, and cell c.
A method for defining K_{PUSCH}(i) can apply one of the above-described Methods 1-2-1-1 to 1-2-1-4.

### [TCI State Activation and Indication Method Based on Unified TCI Scheme]

Hereinafter, a TCI state activation and indication method based on a unified TCI scheme in the 5G system will be described. The unified TCI scheme can refer to a scheme of integrating and managing the transmission/reception beam management scheme, which was distinguished in the existing Rel-15 and 16 as the TCI state scheme used in downlink reception of the UE and the spatial relation info scheme used in uplink transmission, into TCI state. Therefore, if the UE is indicated by the base station to operate based on the unified TCI scheme, it can perform beam management using the TCI state for uplink transmission as well. For example, if the UE is configured with the higher layer signaling, TCI-State, having the higher layer signaling, tci-stateId-r17, from the base station, the UE can perform the operation based on the unified TCI scheme using the corresponding TCI-State. The TCI-State can exist in two forms: joint TCI state or separate TCI state.

The first form is a joint TCI state, and the UE can be instructed of TCI state to be applied to both uplink transmission and downlink reception through single TCI-State from the base station. If the UE is instructed of TCI-State based on the joint TCI state, the UE can be instructed of a parameter to be used for downlink channel estimation using an RS corresponding to qcl-Type1 in the TCI-State based on the joint TCI state, and can be instructed of a parameter to be used as a downlink reception beam or reception filter using an RS corresponding to qcl-Type2. If the UE is instructed of TCI-State based on the joint TCI state, the UE can be instructed of a parameter to be used as an uplink transmission beam or transmission filter using an RS corresponding to qcl-Type2 in the TCI-State based on the joint TCI state. In this case, if the UE is instructed of the joint TCI state, the UE can apply the same beam to both uplink transmission and downlink reception.

The second form is a separate TCI state, and the UE can be individually instructed of a UL TCI state to be applied to uplink transmission and a DL TCI state to be applied to downlink reception from the base station. If the UE is instructed of the UL TCI state, the UE can be instructed of a parameter to be used as an uplink transmission beam or a transmission filter using a reference RS or source RS configured in the corresponding UL TCI state. If the UE is instructed of the DL TCI state, the UE can be instructed of a parameter to be used for downlink channel estimation using an RS corresponding to qcl-Type1 configured in the corresponding DL TCI state, and can be instructed of a parameter to be used as a downlink reception beam or a reception filter using an RS corresponding to qcl-Type2.

If the UE is instructed of both the DL TCI state and the UL TCI state, the UE can be instructed of a parameter to be used as an uplink transmission beam or a transmission filter using a reference RS or source RS configured in the corresponding UL TCI state, can be instructed of a parameter to be used for downlink channel estimation using an RS corresponding to qcl-Type1 configured in the corresponding DL TCI state, and can be instructed of a parameter to be used as a downlink reception beam or a reception filter using an RS corresponding to qcl-Type2. In this case, if the reference RSs or source RSs configured in the DL TCI state and UL TCI state instructed to the UE are different, the UE can individually apply beams to uplink transmission and downlink reception, respectively, based on the instructed UL TCI state and DL TCI state.

The UE can be configured with up to 128 joint TCI states per bandwidth part in a specific cell from the base station through higher layer signaling, and can be configured with up to 64 or 128 DL TCI states of the separate TCI state per bandwidth part within a specific cell through higher layer signaling based on UE capability report, and the DL TCI state of the separate TCI state and the joint TCI state can use the same higher layer signaling structure. For example, if 128 joint TCI states are configured and 64 DL TCI states of the separate TCI state are configured, the 64 DL TCI states can be included in the 128 joint TCI states.

The UL TCI state of the separate TCI state can be configured up to 32 or 64 per specific bandwidth part within a specific cell through higher layer signaling based on the UE capability report, and like the relationship between the DL TCI state of the separate TCI state and the joint TCI state, the UL TCI state of the separate TCI state and the joint TCI state can also use the same higher layer signaling structure. Alternatively, the UL TCI state of the separate TCI can use a higher layer signaling structure different from those of the joint TCI state and the DL TCI state of the separate TCI state. As such, the use of different or same higher layer signaling structures can be defined in the specification or distinguished through another higher layer signaling configured by the base station based on the UE capability report containing information on which of the two usage schemes supported by the UE.

The terminal can receive transmission/reception beam related indication in the unified TCI scheme by using one scheme between the joint TCI state and the separate TCI state configured by the base station. The UE can be configured by the base station through higher layer signaling as to whether to use one of the joint TCI state and the separate TCI state.

The UE receives transmission/reception beam related indication by using one scheme selected from the joint TCI state and the separate TCI state through higher layer signaling. At this time, as the transmission/reception beam indication method from the base station, there may be two methods: a MAC-CE-based indication method and a MAC-CE-based activation and DCI-based indication method.

If the UE is configured through higher layer signaling to receive transmission/reception beam related indication by using the joint TCI state scheme, the UE can perform a transmission and reception beam application operation by receiving a MAC-CE indicating the joint TCI state from the base station, and the base station can schedule the reception of a PDSCH including the MAC-CE indicating the joint TCI state to the UE through a PDCCH. If the MAC-CE includes one joint TCI state, the UE can determine an uplink transmission beam or transmission filter and a downlink reception beam or reception filter by using the indicated joint TCI state, from 3 ms after transmitting a PUCCH including HARQ-ACK information indicating whether the reception of the PDSCH including the corresponding MAC-CE is successful. If there are two or more joint TCI states included in the MAC-CE, the UE can confirm that the multiple joint TCI states indicated by the MAC-CE correspond to respective codepoints of the TCI state field of DCI format 1_1 or 1_2 and activate the indicated joint TCI state, from 3 ms after transmitting a PUCCH including HARQ-ACK information indicating whether the reception of the PDSCH including the corresponding MAC-CE is successful. Thereafter, the UE can receive the DCI format 1_1 or 1_2 and apply one joint TCI state indicated by the TCI state field in the corresponding DCI to the uplink transmission and downlink reception beams. In this case, the DCI format 1_1 or 1_2 may or may not include downlink data channel scheduling information (with or without DL assignment).

If the UE is configured through higher layer signaling to receive transmission/reception beam related indication by using the separate TCI state scheme, the UE can perform a transmission/reception beam application operation by receiving a MAC-CE indicating the separate TCI state from the base station, and the base station can schedule the reception of a PDSCH including the MAC-CE indicating the separate TCI state to the UE through a PDCCH. If the MAC-CE includes one set of separate TCI states, the UE can determine an uplink transmission beam or transmission filter and a downlink reception beam or reception filter by using the separate TCI states included in the indicated separate TCI state set, from 3 ms after transmitting a PUCCH including HARQ-ACK information indicating whether the reception of the corresponding PDSCH is successful. In this case, the separate TCI state set may refer to a single or multiple separate TCI states that one codepoint of a TCI state field in DCI format 1_1 or 1_2 can have, and one separate TCI state set may include one DL TCI state, one UL TCI state, or one DL TCI state and one UL TCI state. If there are two or more separate TCI state sets included in the MAC-CE, the UE can confirm that the multiple separate TCI state sets indicated by the MAC-CE correspond to respective codepoints of the TCI state field of DCI format 1_1 or 1_2 and activate the indicated separate TCI state sets, from 3 ms after transmitting a PUCCH including HARQ-ACK information indicating whether the reception of the corresponding PDSCH is successful. In this case, each codepoint of the TCI state field of DCI format 1_1 or 1_2 may indicate one DL TCI state, one UL TCI state, or one DL TCI state and one UL TCI state. Thereafter, upon receiving the DCI format 1_1 or 1_2, the UE can apply the separate TCI state set indicated by the TCI state field in the corresponding DCI to the uplink transmission and downlink reception beams. In this case, the DCI format 1_1 or 1_2 may or may not include downlink data channel scheduling information (with or without DL assignment).

The above-described MAC-CE used to activate or indicate the single joint TCI state and the separate TCI state may exist for each of the joint TCI state scheme and the separate TCI state scheme, and a single MAC-CE may be used to activate or indicate the TCI state based on either the joint TCI state scheme or the separate TCI state scheme. Various MAC-CE structures for activating and indicating the joint TCI state or the separate TCI state can be considered through the drawings described below.

If the UE is configured through higher layer signaling to receive transmission/reception beam related indication by using the joint TCI state scheme or the separate TCI state scheme, the UE can receive a PDSCH including a MAC-CE indicating the joint TCI state or the separate TCI state from the base station, and apply the indicated joint TCI state or separate TCI state to the transmission/reception beam. If the joint TCI state or the separate TCI state set indicated by the MAC-CE is two or more, the UE can confirm that the multiple joint TCI states or multiple separate TCI state sets indicated by the MAC-CE correspond to respective codepoints of the TCI state field of DCI format 1_1 or 1_2 from 3 ms after transmitting the PUCCH including HARQ-ACK information indicating whether the reception of the corresponding PDSCH is successful, and can activate the indicated joint TCI state or separate TCI state set. Thereafter, upon receiving DCI format 1_1 or 1_2, the UE can apply one joint TCI state or one separate TCI state set indicated by the TCI state field in the corresponding DCI to the uplink transmission and downlink reception beams. In this case, the DCI format 1_1 or 1_2 may or may not include downlink data channel scheduling information (with or without DL assignment).

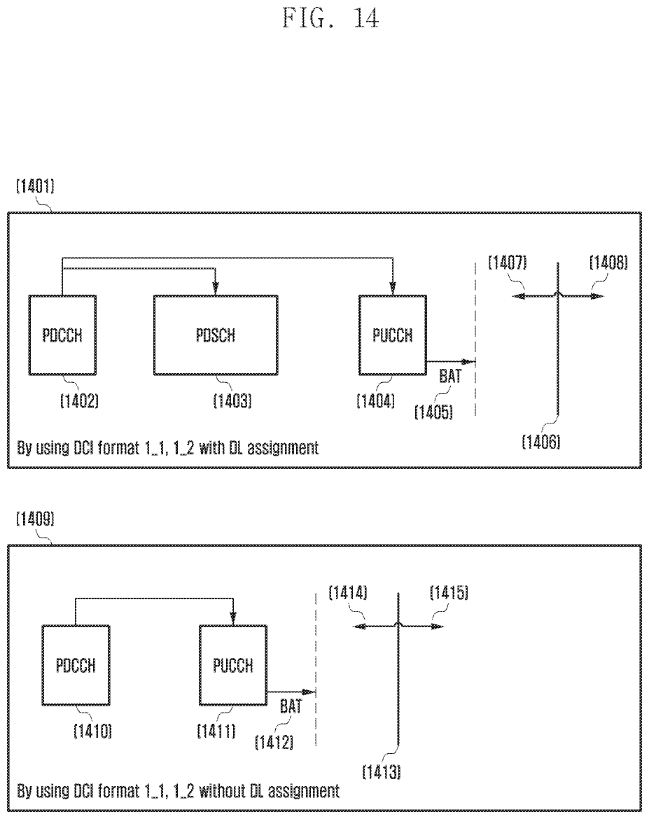

FIG. 14 is a diagram regarding beam application that can be considered in case of using a unified TCI scheme in a wireless communication system according to an embodiment of the disclosure. As described above, the UE may receive DCI format 1 1 or 1_2 including (with DL assignment) or not including (without DL assignment) downlink data channel scheduling information from the base station, and apply one joint TCI state or one separate TCI state set indicated through the TCI state field in the corresponding DCI to the uplink transmission and downlink reception beams.
DCI format 1_1 or 1_2 with DL assignment 1401: If the UE receives DCI format 1_1 or 1_2 including downlink data channel scheduling information from the base station at 1402 and indicates one joint TCI state or separate TCI state set based on the unified TCI scheme, the UE can receive at 1403 a PDSCH scheduled based on the received DCI, and transmit at 1404 a PUCCH including a HARQ-ACK indicating whether the reception of the DCI and the PDSCH is successful. In this case, the HARQ-ACK can indicate whether the reception of both the DCI and the PDSCH is successful. If the UE fails to receive at least one of the DCI and the PDSCH, the UE can transmit a NACK, and if the UE successfully receives both the DCI and the PDSCH, the UE can transmit an ACK.
DCI format 1_1 or 1_2 without DL assignment 1409: If the UE receives DCI format 1_1 or 1_2 including no downlink data channel scheduling information from the base station at 1410 and indicates one joint TCI state or separate TCI state set based on the unified TCI scheme, the UE can assume at least one of the following for the corresponding DCI.
CRC scrambled using CS-RNTI is included.
The value of all bits assigned to all fields used as RV (Redundancy Version) field is 1.
The value of all bits assigned to all fields used as MCS (Modulation and Coding Scheme) field is 1.
The value of all bits assigned to all fields used as NDI (New Data Indication) field is 0.
In the case of FDRA (Frequency Domain Resource Allocation) Type 0, the value of all bits assigned to the FDRA field is 0, in the case of FDRA Type 1, the value of all bits assigned to the FDRA field is 1, and in the case where the FDRA scheme is dynamicSwitch, the value of all bits assigned to the FDRA field is 0.

The UE can transmit at 1411 a PUCCH including a HARQ-ACK indicating whether the reception is successful for DCI format 1_1 or 1_2 assuming the above-described matters.
For both DCI format 1_1 or 1_2 with DL assignment 1401 and without DL assignment 1409, if a new TCI state indicated through DCI at 1402 or 1410 is the same as a TCI state that has been already indicated and applied to the uplink transmission and downlink reception beams, the UE can maintain the previously applied TCI state. If a new TCI state is different from the previously applied TCI state, the UE may determine a time point of applying a joint TCI state or a separate TCI state set, which can be indicated by the TCI state field included in the DCI, is from a section 1408 or 1415 after a start time 1406 or 1413 of the first slot after a beam application time (BAT) 1405 or 1412 from the PUCCH transmission, and may use the previously indicated TCI state until a section 1407 or 1414 before the start time 1406 or 1413 of that slot.
For both DCI format 1_1 or 1_2 with DL assignment 1401 and without DL assignment 1409, the BAT as a specific number of OFDM symbols can be configured via higher layer signaling based on UE capability report information, and the numerology for the BAT and the first slot after the BAT can be determined based on the smallest numerology among all cells to which a joint TCI state or a separate TCI state set indicated through DCI is applied.

The UE can apply one joint TCI state indicated through MAC-CE or DCI to reception of control resource sets connected to all UE-specific search spaces, reception of PDSCH scheduled by PDCCH transmitted from the corresponding control resource set and transmission of PUSCH, and transmission of all PUCCH resources.

If one separate TCI state set indicated via MAC-CE or DCI includes one DL TCI state, the UE can apply the one separate TCI state set to reception of control resource sets connected to all UE-specific search spaces, and reception of PDSCH scheduled by PDCCH transmitted from the corresponding control resource set, and based on the previously indicated UL TCI state, apply it to all PUSCH and PUCCH resources.

If one separate TCI state set indicated via MAC-CE or DCI includes one UL TCI state, the UE can apply the one separate TCI state set to all PUSCH and PUCCH resources, and based on the previously indicated DL TCI state, apply it to reception of control resource sets connected to all UE-specific search spaces, and reception of PDSCH scheduled by PDCCH transmitted from the corresponding control resource set.

If one separate TCI state set indicated via MAC-CE or DCI includes one DL TCI state and one UL TCI state, the UE can apply the DL TCI state to reception of control resource sets connected to all UE-specific search spaces and reception of PDSCH scheduled by PDCCH transmitted from the corresponding control resource set, and apply the UL TCI state to all PUSCH and PUCCH resources.

In the disclosure, when the UE changes an activated TCI state of an uplink through a unified TCI during uplink repetition transmission, a method for controlling PUSCH transmit power according to beam change information during PUSCH repetition transmission is provided. In addition, a PUCCH and PUSCH overlap rule and a BAT symbol determination method for whether the UE receives DCI format 1_1 and DCI format 1_2 including the unified TCI during PUSCH transmission are defined. This is not limited to PUSCH, and can be applied to all uplink channels such as SRS and PUCCH.

Method for controlling overlap of PUSCH and PUCCH including ACK/NACK information according to unified TCI configuration

In an embodiment of the disclosure, when the UE is configured with PUSCH repetition transmission from the base station and the beam configuration of an uplink is changed through unified TCI during the PUSCH repetition transmission, and in the case where a PUCCH including ACK/NACK information indicating whether or not a PDCCH for changing the beam configuration is received overlaps with a configured PUSCH, whether or not to perform multiplexing and a dropping rule are defined, and a method for determining a start point of a BAT symbol accordingly is provided.

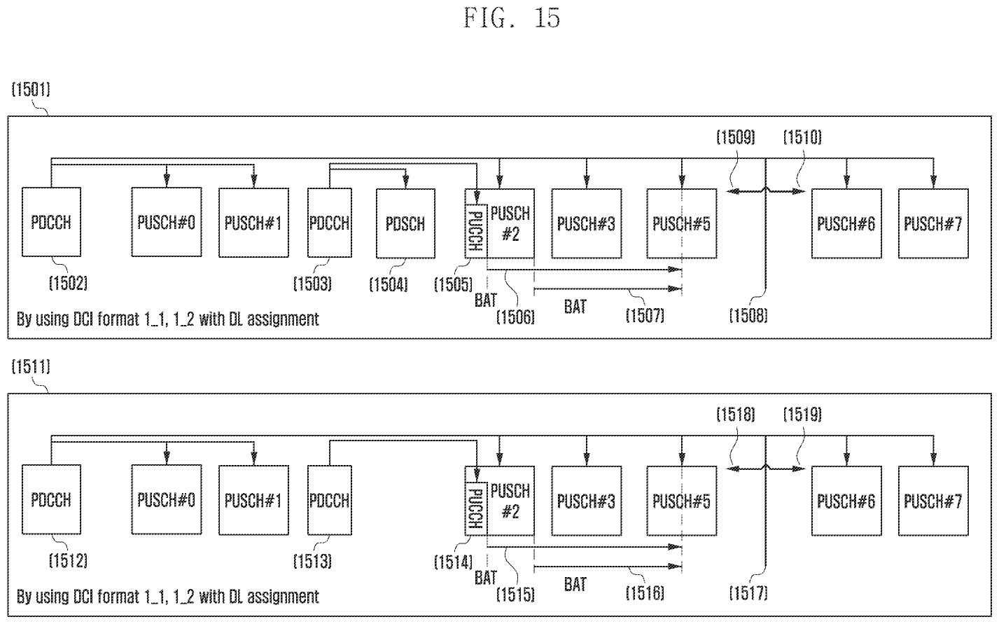

FIG. 15 is a diagram for configuring a unified TCI in case of PUSCH repetition transmission according to an embodiment of the disclosure.

With reference to FIG. 15, the UE can be configured with a unified TCI through DCI format 1_1 or 1_2 that schedules PDSCH (in case of 1501), or can be configured with a unified TCI through DCI format 1_1 or 1_2 that does not schedule PDSCH (in case of 1511). A method for configuring the unified TCI follows the method described above in the disclosure. The UE can be configured with PUSCH repetition transmission through higher layer signaling and L1 signaling. For example, if the UE receives a PDCCH 1502 or 1512 for configuring PUSCH repetition transmission and is configured with number of repetition=8, the UE can then repeatedly transmit the PUSCH. In this case, if ‘AvailableSlotCounting=enable’ is configured when allocating resources for PUSCH repetition transmission, the UE can configure PUSCH repetition transmission resources non-consecutively based on available slots where PUSCH transmission is possible; otherwise, the UE can configure PUSCH repetition transmission resources through consecutive physical slots. Thereafter, if the UE receives a PDCCH 1503 for unified TCI configuration during the PUSCH repetition transmission, the UE can receive a PDSCH 1504 scheduled based on the DCI of the received PDCCH 1503 and transmit a PUCCH 1505 including HARQ-ACK indicating whether the reception of the DCI and the PDSCH is successful. Alternatively, if the UE receives a PDCCH 1513 for unified TCI configuration during the PUSCH repetition transmission, the UE can transmit a PUCCH 1514 including HARQ-ACK indicating whether the reception of the DCI of the received PDCCH 1513 is successful. In this case, a situation may occur where the PUSCH configured for the repetition transmission overlaps with the PUCCH. At this time, for the PUCCH and PUSCH transmission, the UE can resolve the overlap of the PUCCH and the PUSCH through one of the following methods or a combination thereof.

[Method 1] The UE can determine that the PUCCH has high priority, and cancel the configured PUSCH repetition transmission. With reference to FIG. 15, if the PUCCH transmission including the HARQ-ACK indicating the successful reception or not of the PDSCH and the DCI for the unified TCI configuration overlaps with PUSCH #2 transmission, only the PUCCH can be transmitted and the PUSCH #2 transmission can be canceled. At this time, if the UE is counting the PUSCH repetition transmission, the PUSCH is counted as transmitted, but the PUSCH may not be transmitted. Thereafter, through the same method as described above, the UE can repeatedly transmit the PUSCH through the beam configuration information configured through the unified TCI for PUSCH #6 and PUSCH #7 after a start point 1508 or 1517 corresponding to the next slot after applying a BAT symbol 1506 or 1515 from the last symbol of the PUCCH transmission.

[Method 2] The UE can transmit the PUCCH by multiplexing it to the configured PUSCH repetition transmission. With reference to FIG. 15, if the transmission of a PUCCH 1505 or 1514 including the HARQ-ACK indicating the successful reception or not of the PDSCH and the DCI for the unified TCI configuration overlaps with PUSCH #2 transmission, the PUCCH 1505 or 1514 can be transmitted by multiplexing it to the PUSCH #2 transmission. Thereafter, in order to determine the start point of the BAT symbol, the UE can determine the BAT symbol 1507 or 1516 from the last symbol of the PUSCH #2 transmitted by multiplexing the PUCCH. Alternatively, the BAT symbol 1506 or 1515 can be applied on the basis of the last symbol of the configured PUCCH resource based on the configured PUCCH resource information as in the above Method 1. After that, using the next slot at the end of the BAT symbol as a criterion 1508 or 1517, the PUSCH can be transmitted through beam information configured through the existing PDCCH 1502 or 1512 before criterion 1509 or 1518, and the PUSCH can be repeatedly transmitted through beam information configured through the PDCCH 1503 or 1513 for unified TCI configuration after criterion 1510 or 1519.

Through the above embodiment, the UE can determine an overlap rule according to the overlap of PUCCH and PUSCH, and can determine the application time of the BAT symbol according to the overlap rule and the information configured with the unified TCI. The above-described method uses a case where the DCI configuring the unified TCI schedules the PDSCH, but it can also be applied equally to a case where the DCI configuring the unified TCI does not schedule the PDSCH but only configures the unified TCI (i.e., w/o PDSCH).

Method for controlling transmit power of PUSCH repetition transmission according to unified TCI configuration

In an embodiment of the disclosure, a power control method of PUSCH repetition transmission is proposed when the UE is configured with PUSCH repetition transmission from the base station and the beam configuration of uplink is changed through unified TCI during PUSCH repetition transmission. In the embodiment of the disclosure, description is based on the above-described PUSCH power control method and the TCI state activation and indication method based on the unified TCI scheme. The above-described specific method is omitted below.

FIG. 15 is a diagram for configuring a unified TCI in case of PUSCH repetition transmission according to an embodiment of the disclosure.

With reference to FIG. 15, the UE can be configured with a unified TCI through DCI format 1_1 or 1_2 that schedules PDSCH (in case of 1501), or can be configured with a unified TCI through DCI format 1_1 or 1_2 that does not schedule PDSCH (in case of 1511). A method for configuring the unified TCI follows the method described above in the disclosure. The UE can be configured with PUSCH repetition transmission through higher layer signaling and L1 signaling. For example, if the UE receives a PDCCH 1502 or 1512 for configuring PUSCH repetition transmission and is configured with number of repetition=8, the UE can then repeatedly transmit the PUSCH. In this case, if ‘AvailableSlotCounting=enable’ is configured when allocating resources for PUSCH repetition transmission, the UE can configure PUSCH repetition transmission resources non-consecutively based on available slots where PUSCH transmission is possible; otherwise, the UE can configure PUSCH repetition transmission resources through consecutive physical slots. Thereafter, if the UE receives a PDCCH 1503 for unified TCI configuration during the PUSCH repetition transmission, the UE can receive a PDSCH 1504 scheduled based on the DCI of the received PDCCH 1503 and transmit a PUCCH 1505 including HARQ-ACK indicating whether the reception of the DCI and the PDSCH is successful. Alternatively, if the UE receives a PDCCH 1513 for unified TCI configuration during the PUSCH repetition transmission, the UE can transmit a PUCCH 1514 including HARQ-ACK indicating whether the reception of the DCI of the received PDCCH 1513 is successful. In the case that a situation occurs where the PUSCH configured for the repetition transmission overlaps with the PUCCH, this can be resolved through the method of the embodiment described above for the method of controlling the overlap of PUSCH and PUCCH including ACK/NACK information according to the unified TCI configuration. Thereafter, the UE can transmit PUSCH repetition transmission PUSCH #6 and PUSCH #7 based on the next slot 1508 or 1517 after the BAT symbol through newly configured beam information through unified TCI. At this time, the UE can control the transmit power of PUSCH repetition transmission according to beam change.

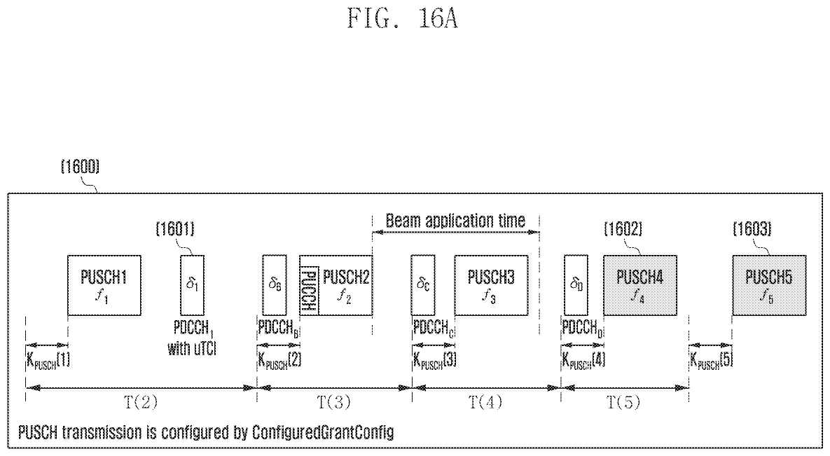

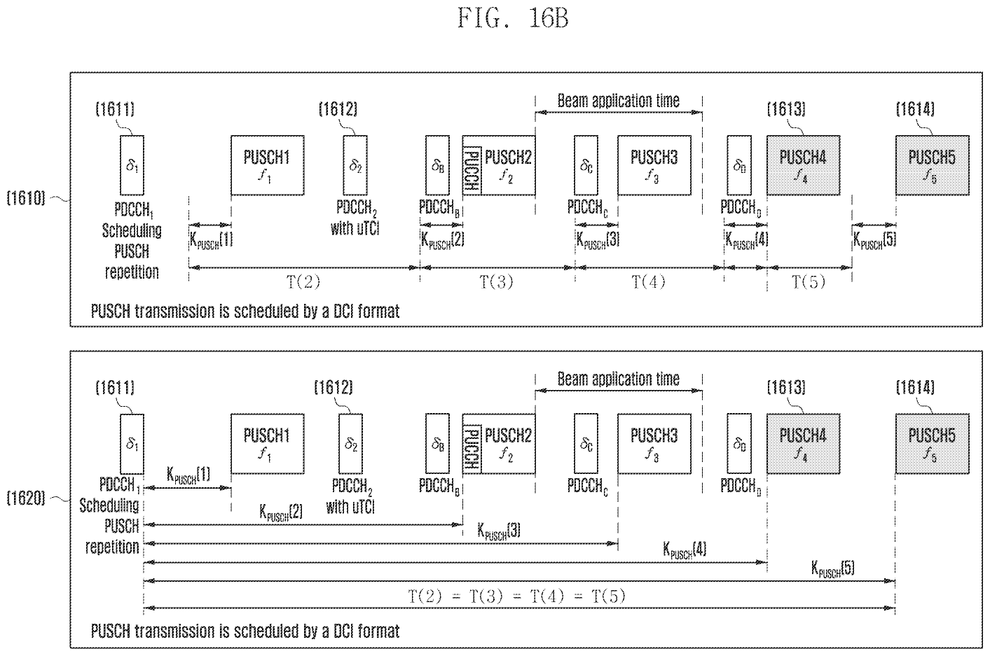

FIGS. 16A and 16B are diagrams illustrating a power control method for a PUSCH when a unified TCI is configured during PUSCH repetition transmission according to an embodiment of the disclosure.

The UE can be configured with PUSCH repetition through higher layer signaling (e.g., ConfiguredGrantConfig). Thereafter, as in Method 1-1-1-3 described above in the PUSCH power control method, the UE can perform PUSCH power control based on TPC command values received during T(i) by applying the same K_{PUSCH}(i) to each PUSCH repetition transmission. At this time, among DCIs including the TPC command, the UE considers only DCI that schedules PUSCH transmission and DCI format 2_2 that is CRC scrambled by TPC-PUSCH-RNTI. Specifically, referring to 1600 of FIG. 16A, the UE can be configured with PUSCH repetition={PUSCH1˜PUSCH5} through higher layer signaling (e.g., ConfiguredGrantConfig). Then, the UE can be configured with a new beam through PDCCH1 1601 including unified TCI configuration during PUSCH repetition transmission. At this time, the UE can determine a PUSCH power control adjustment state fᵢ for each PUSCH repetition transmission based on the TPC command values received during T(i) using the same K_{PUSCH}(i). Therefore, the UE can determine f₁ for PUSCH1 as a previously stored power control adjustment state value, f₂=f₁ for PUSCH2, f₃=f₂+δ_{B} for PUSCH3, f₄=f₃+δ_{C} for PUSCH4, and f₃=f₄+δ_{D} for PUSCH5. That is, if the DCI for unified TCI configuration is received during the PUSCH repetition transmission, the UE changes the beams of PUSCH4 1602 and PUSCH5 1603 but cannot control the power. This is an inefficient power control method for PUSCH transmission and can reduce the reliability of PUSCH transmission.

In addition, the UE can be configured with PUSCH repetition through DCI which is L1 signaling. After that, as in Method 1-1-1-1 described above in the PUSCH power control method, the UE can configure K_{PUSCH}(i) based on the last symbol of the PDCCH that schedules the PUSCH and the first symbol of the PUSCH and perform PUSCH repetition transmission by applying the same PUSCH power control adjustment state fᵢ to all PUSCH repetition transmissions. Or, as in Method 1-1-1-3, the UE can perform PUSCH power control based on TPC command values received during T(i) by applying the same K_{PUSCH}(i) to each PUSCH repetition transmission. At this time, among DCIs including the TPC command, the UE considers only DCI that schedules PUSCH transmission and DCI format 2_2 that is CRC scrambled by TPC-PUSCH-RNTI. Specifically, referring to 1610 of FIG. 16B, the UE can be configured with PUSCH repetition={PUSCH1˜PUSCH5} through PDCCH1 1611. Thereafter, the UE can be configured with a new beam through PDCCH2 1612 including unified TCI configuration during PUSCH repetition transmission. At this time, the UE can determine the PUSCH power control adjustment state fᵢ based on the TPC command values received during T(i) by applying the same K_{PUSCH}(i) to each PUSCH repetition transmission. Therefore, for PUSCH1, f₁ can be determined as the sum of the previously stored power control adjustment state value and the δ₁ value of the scheduling PDCCH1 1611, for PUSCH2, f₂=f₁, for PUSCH3, f₃=f₂+δ_{B}, for PUSCH4, f₄=f₃+δ_{C}, and for PUSCH5, f₃=f₄+δ₁). That is, if the DCI for unified TCI configuration is received during the PUSCH repetition transmission, the UE changes the beams of PUSCH4 1613 and PUSCH5 1614 but cannot control the power. This is an inefficient power control method for PUSCH transmission and can reduce the reliability of PUSCH transmission.

In addition, referring to 1620 of FIG. 16B, the UE can be configured with PUSCH repetition={PUSCH1˜PUSCH5} through PDCCH1 1621. Thereafter, the UE can be configured with a new beam through PDCCH2 1622 including unified TCI configuration during PUSCH repetition transmission. At this time, the UE can apply the same PUSCH power control adjustment state fᵢ through different K_{PUSCH}(i) values determined based on the last symbol of the PDCCH that schedules the PUSCH and the first symbol of the PUSCH for each PUSCH repetition transmission. That is, for PUSCH1, f₁ can be determined as the sum of the previously stored power control adjustment state value and the δ₁ value of the scheduling PDCCH1 1621, for PUSCH2, f₂=f₁, for PUSCH3, f₃=f₂=f₁, for PUSCH4, f₄=f₃=f₂=f₁, and for PUSCH5, f₅=f₄=f₃=f₂=f₁. Similarly, if the DCI for unified TCI configuration is received during the PUSCH repetition transmission, the UE changes the beams of PUSCH4 1623 and PUSCH5 1624 but cannot control the power. This is an inefficient power control method for PUSCH transmission and can reduce the reliability of PUSCH transmission.

The disclosure provides a method for improving the above inefficient PUSCH transmit power control method when beam configuration information is changed through unified TCI configuration during PUSCH repetition transmission.

The disclosure proposes, in the case where the UE is configured with PUSCH repetition transmission through higher layer signaling and L1 signaling, and beam configuration information through unified TCI is changed during the PUSCH repetition transmission, a method for reconfiguring transmit power for PUSCH repetition transmitted after a time point when beam configuration information is applied after a BAT symbol. To this end, the UE may apply closed loop power control that considers not only DCI that schedules PUSCH transmission and DCI format 2_2 CRC-scrambled by TPC-PUSCH-RNTI among DCIs including TPC command, but also PDCCH including unified TCI configuration information (or PDCCH including unified TCI configuration information that changes uplink TCI).

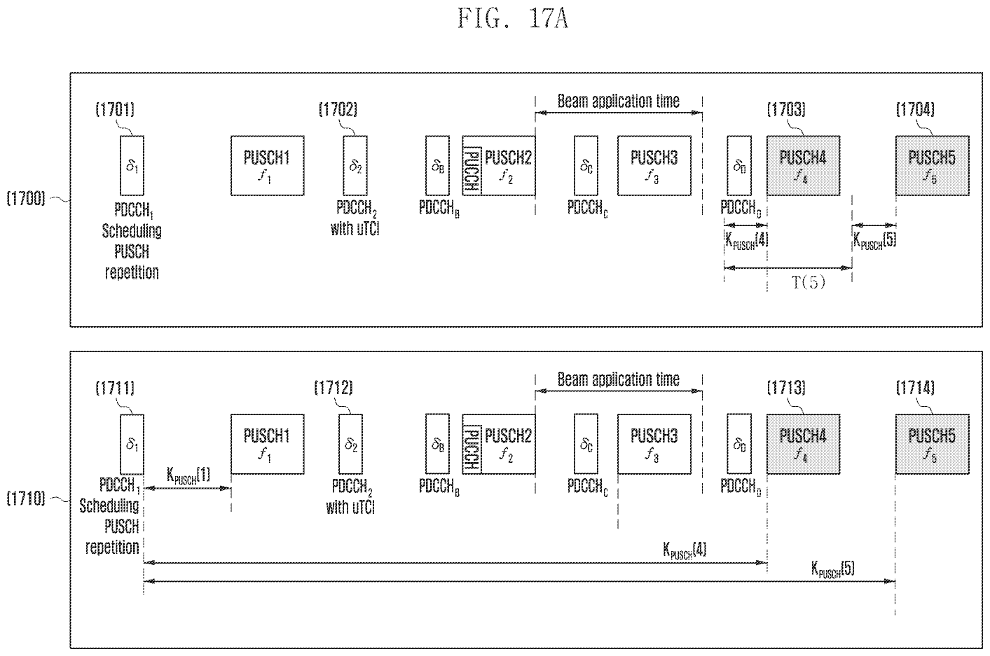

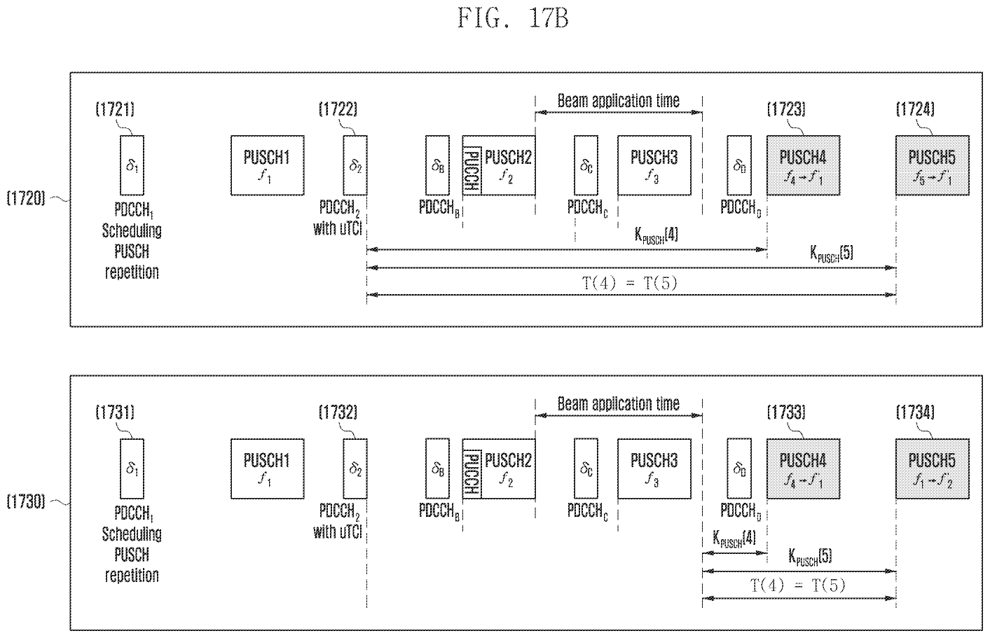

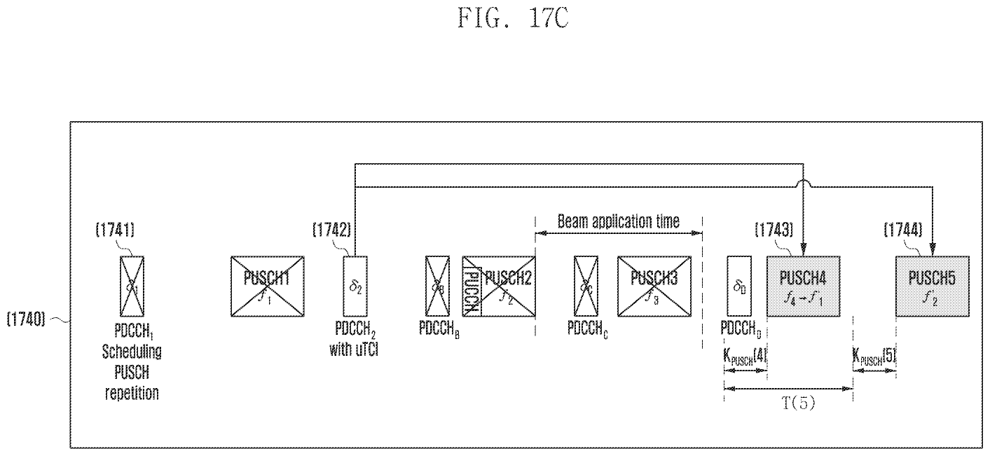

FIGS. 17A to 17C are diagrams illustrating a PUSCH transmit power control method when a unified TCI is configured during PUSCH repetition transmission according to an embodiment of the disclosure.

With reference to FIGS. 17A to 17C, when the UE is configured with PUSCH repetition transmission via DCI format and receives a PDCCH including unified TCI configuration information during the PUSCH repetition transmission, and when uplink beam is changed, a method for controlling transmit power of PUSCH repetition transmission after the beam change is described. The power control method of PUSCH transmission in case of the PUSCH beam change according to the unified TCI configuration can be applied as one of the following methods or a combination thereof.

[Method 1] If the UE is reconfigured with beam configuration information through unified TCI during PUSCH repetition transmission, the power control adjustment state fᵢ of the PUSCH transmitted from the next slot after the BAT symbol applied by beam change can be determined through the PDCCH including the unified TCI. Specifically, referring to 1700 and 1710 of FIG. 17A, the UE is configured with PUSCH repetition transmission through PDCCH1 1701 or 1711, and the PUSCH repetition transmission can control the PUSCH transmit power as in Method 1-1-1-1 or Method 1-1-1-3 described above in PUSCH power control method. At this time, the UE can be reconfigured with TCI information related to beams for transmission of PUSCH4 1703 or 1713 and PUSCH5 1704 or 1714 through PDCCH2 1702 or 1712 including unified TCI configuration information. At this time, if Method 1-1-1-3 described above in PUSCH power control method is applied, the power control adjustment state fᵢ of PUSCH4 and PUSCH5 according to the reconfigured beam information can be reconfigured to f₄=f′(i,l)+δ₂, f₅=f₄+δ_{D} by considering the TPC command value δ₂ of PDCCH2. At this time, f′(i,l) can be determined as f′(i,l) considering the closed loop index/corresponding to the TCI configured through PDCCH2. In addition, if Method 1-1-1-1 described above in the PUSCH power control method is applied, the power control adjustment state fᵢ of PUSCH4 and PUSCH5 according to the reconfigured beam information can be reconfigured to f₄=f′(i,l)+δ₂, f₅=f₄ considering the TPC command value δ₂ of PDCCH2. At this time, f′(i,l) can be determined as f′(i,l) considering the closed loop index l corresponding to the TCI configured through PDCCH2. The closed loop index l of f′(i,l) can have a value of 0 or 1, and the UE can store two values of f′(i,l) and continuously apply them.

[Method 2] When the UE is reconfigured with beam configuration information through unified TCI during PUSCH repetition transmission, K_{PUSCH}(i), which determines the power control adjustment state fᵢ of the PUSCH transmitted from the next slot after the BAT symbol applied by beam change, can be newly defined.

Specifically, referring to 1720 of FIG. 17B, the UE is configured with PUSCH repetition transmission through PDCCH1 1721, and the PUSCH repetition transmissions can control the PUSCH transmit power as in Method 1-1-1-1 or Method 1-1-1-3 described above in the PUSCH power control method. At this time, the UE can be reconfigured with TCI information related to the beam for transmission of PUSCH4 1723 and PUSCH5 1724 through PDCCH2 1722 including unified TCI configuration information. The number of symbols from the last symbol of PDCCH2 1722 including the configured unified TCI information to the first symbol of each PUSCH repetition transmission can be configured differently as K_{PUSCH}(4) and K_{PUSCH}(5). At this time, the power control adjustment state fᵢ of PUSCH4 and PUSCH5 can be determined based on f′(i,l) considering the closed loop index/corresponding to the TCI configured through PDCCH2 and the TPC command value 82 of PDCCH2. The closed loop index l of f′(i,l) can have a value of 0 or 1, and the UE can store two values of f′(i,l) and continuously apply them. Therefore, the UE can determine f₄=f′(i,l)+δ₂ for PUSCH4 1723 and f₅=f₄ for PUSCH5 1724.

As another method, referring to 1730 of FIG. 17B, the UE is configured with PUSCH repetition transmission through PDCCH1 1731, and the PUSCH repetition transmissions can control the PUSCH transmit power as in Method 1-1-1-1 or Method 1-1-1-3 described above in the PUSCH power control method. At this time, the UE can be reconfigured with TCI information related to the beam for transmission of PUSCH4 1733 and PUSCH5 1734 through PDCCH2 1732 including unified TCI configuration information. The number of symbols between the first symbol of the slot to which the configured unified TCI information is applied and the first symbol of each PUSCH repetition transmission may be configured differently as K_{PUSCH}(4) and K_{PUSCH}(5). At this time, the power control adjustment state fᵢ of PUSCH4 and PUSCH5 can be determined based on f′(i,l) considering the closed loop index/corresponding to the TCI configured through PDCCH2 and the TPC command value δ₂ of PDCCH2. The closed loop index l of f′(i,l) can have a value of 0 or 1, and the UE can store two values of f′(i,l) and continuously apply them. Therefore, the UE can determine f₄=f′(i,l)+δ₂ for PUSCH4 1733 and f₅=f₄ for PUSCH5 1734.

[Method 3] If the UE is reconfigured with beam configuration information through unified TCI during PUSCH repetition transmission, the power control adjustment state fᵢ of the PUSCH transmitted from the next slot after the BAT symbol applied by the beam change can be determined as f′(i,l) considering the closed loop index/corresponding to the TCI configured through PDCCH2 and the TPC command value 82 of the PDCCH2, and K_{PUSCH}(i) can be newly defined as in Method 1-1-1-3 described above in the PUSCH power control method. Specifically, referring to 1740 of FIG. 17C, the UE is configured with PUSCH repetition transmission through PDCCH1 1741, and the PUSCH repetition transmissions can control PUSCH transmit power as in Method 1-1-1-1 or Method 1-1-1-3 described above in the PUSCH power control method. At this time, the UE be reconfigured with TCI information related to the beam for transmission of PUSCH4 1743 and PUSCH5 1744 through PDCCH2 1742 including unified TCI configuration information. At this time, the UE can reset all previously configured power control adjustment states f (i,l) from the time point at which new TCI configuration information is applied, or make determination based on f′(i,l) considering the closed loop index/corresponding to the TCI of PDCCH2 1742 and the TPC command value 82 of the PDCCH2. Afterwards, K_{PUSCH}(i) can be applied to PUSCH4 and PUSCH5 as the same value as in Method 1-1-1-3 described above in the PUSCH power control method. Therefore, the UE can determine f₄=f′(i,l)+δ₂ for PUSCH4 1743 and f₅=f₄+δ_{D} for PUSCH5 1744.

[Method 4] When the UE is reconfigured with beam configuration information through unified TCI during PUSCH repetition transmission, the power of the PUSCH can be controlled by introducing different sets Dᵢ based on the time point at which the new TCI is applied and the beam is newly applied in order to determine the power control adjustment state fᵢ of the PUSCH transmitted from the next slot after the BAT symbol applied by beam change.

Through the above methods of the disclosure, the UE provides a method for configuring the PUSCH transmit power when a beam is changed due to unified TCI during PUSCH repetition transmission. Through this, the problem of PUSCH transmit power control in which the transmit power of the PUSCH is not changed during the existing PUSCH repetition transmission or is transmitted only by being fixed to the closed loop index/applied for configuring the PUSCH is solved, and the coverage of the PUSCH can be improved and the reliability of the PUSCH can be enhanced through an appropriate PUSCH transmit power control method according to the beam change.

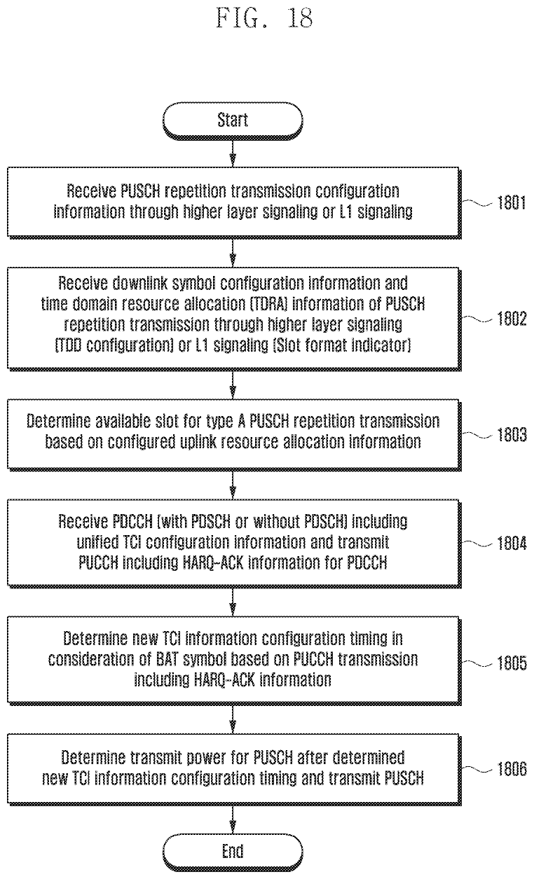

FIG. 18 is a flowchart illustrating the operation of a terminal for PUSCH transmit power control based on a beam change when beam configuration information is reconfigured through a unified TCI during PUSCH repetition transmission according to an embodiment of the disclosure.

In FIG. 18, the operation of the UE for PUSCH transmit power control according to beam change when beam configuration information is reconfigured through a unified TCI during PUSCH repetition transmission is described. From the base station, the UE can receive configuration information for PUSCH repetition transmission through higher layer signaling or L1 signaling at 1801. In addition, the UE can receive downlink symbol configuration information and time domain resource allocation (TDRA) information of PUSCH repetition transmission through higher layer signaling (TDD configuration; tdd-UL-DL-ConfigurationCommon or tdd-UL-DL-ConfigurationDedicated) or L1 signaling (Slot format indicator) at 1802. Thereafter, based on uplink resource allocation information configured from the base station, the UE can determine an available slot for PUSCH repetition transmission at 1803. Thereafter, the UE can receive unified TCI configuration information through DCI. At this time, a PDSCH can be additionally scheduled through a PDCCH including the unified TCI configuration information. Thereafter, at 1804, a PUCCH including HARQ-ACK information on whether the configured PDCCH and PDSCH are received successfully can be transmitted. At this time, if the PUCCH overlaps with the PUSCH, it can be transmitted by being multiplexed as in the method of the disclosure. At 1805, a time point at which a new TCI is to be applied can be determined by applying a BAT symbol based on the PUCCH transmission. Thereafter, through one or a combination of the above methods of the disclosure, the UE can determine the PUSCH transmit power for the PUSCH after the time point at which the new TCI is to be applied. At 1806, the UE can transmit the PUSCH with the newly determined PUSCH transmit power.

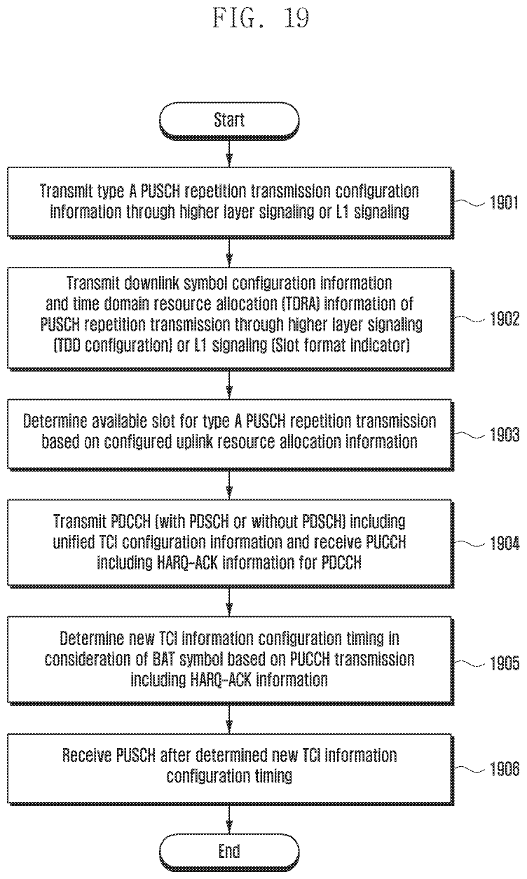

FIG. 19 is a flowchart illustrating the operation of a base station for PUSCH transmit power control based on a beam change when beam configuration information is reconfigured through a unified TCI during PUSCH repetition transmission according to an embodiment of the disclosure.

In FIG. 19, the operation of the base station for PUSCH transmit power control according to a beam change when beam configuration information is reconfigured through a unified TCI during PUSCH repetition transmission is described. To the UE, the base station can transmit configuration information for PUSCH repetition transmission through higher layer signaling or L1 signaling at 1901. In addition, the base station can transmit downlink symbol configuration information and time domain resource allocation (TDRA) information of PUSCH repetition transmission through higher layer signaling (TDD configuration; tdd-UL-DL-ConfigurationCommon or tdd-UL-DL-ConfigurationDedicated) or L1 signaling (Slot format indicator) at 1902. Thereafter, based on configured uplink resource allocation information, the base station can determine an available slot for PUSCH repetition transmission at 1903. Thereafter, the base station can transmit unified TCI configuration information through DCI. At this time, a PDSCH can be additionally scheduled through a PDCCH including the unified TCI configuration information. Thereafter, at 1904, a PUCCH including HARQ-ACK information on whether the reception of the configured PDCCH and PDSCH is successful can be received. At this time, if the PUCCH overlaps with the PUSCH, it can be received by being multiplexed as in the method of the disclosure. At 1905, a time point at which a new TCI is to be applied can be determined by applying a BAT symbol based on the PUCCH transmission. Thereafter, at 1906, the base station can receive the PUSCH after the time point at which the new TCI is to be applied.

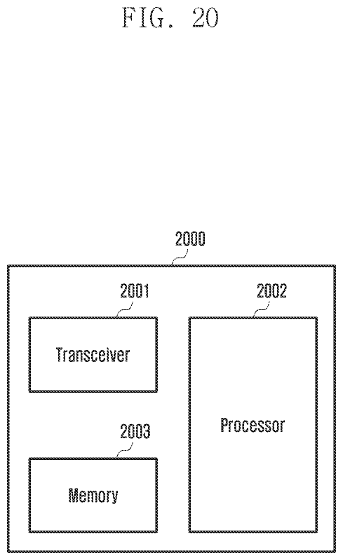

FIG. 20 is a block diagram of a terminal according to an embodiment of the disclosure.

With reference to FIG. 20, the UE 2000 may include a transceiver 2001, a controller 2002 (e.g., a processor), and a storage 2003 (e.g., a memory). The transceiver 2001, the controller 2002, and the storage 2003 of the UE 2000 can operate according to at least one of the methods corresponding to the above-described embodiments or a combination thereof. However, the components of the UE 2000 are not limited to the illustrated example. According to another embodiment, the UE 2000 may include more or fewer components than the aforementioned components. Also, in a certain case, the transceiver 2001, the controller 2002, and the storage 2003 may be implemented in the form of a single chip.

According to an embodiment, the transceiver 2001 may be composed of a transmitter and a receiver. The transceiver 2001 can transmit/receive a signal to/from the base station. This signal may include control information and data. The transceiver 2001 may include an RF transmitter for up-converting and amplifying a frequency of a transmitted signal, and an RF receiver for low-noise amplifying a received signal and down-converting a frequency of the received signal. The transceiver 2001 can receive a signal through a wireless channel and output the received signal to the controller 2002, and can transmit a signal output from the controller 2002 through the wireless channel.

The controller 2002 can control a series of procedures that the UE 2000 can operate according to the above-described embodiment of the disclosure. For example, the controller 2002 can perform or control the operation of the UE to perform at least one or a combination of the methods according to the embodiments of the disclosure. The controller 2002 may include at least one processor. For example, the controller 2002 may include a communication processor (CP) that performs control for communication, and an application processor (AP) that controls a higher layer (e.g., an application).

The storage 2003 can store control information (e.g., information related to channel estimation using DMRSs transmitted on PUSCH included in a signal acquired by the UE 2000) or data, and may have an area for storing data required for the control of the controller 2002 and data generated during the control of the controller 2002.

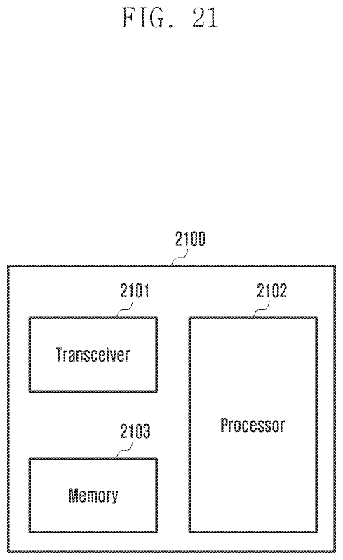

FIG. 21 is a block diagram of a base station according to an embodiment of the disclosure.

With reference to FIG. 21, the base station 2100 may include a transceiver 2101, a controller 2102 (e.g., a processor), and a storage 2103 (e.g., a memory). The transceiver 2101, the controller 2102, and the storage 2103 of the base station 2100 can operate according to at least one of the methods corresponding to the above-described embodiments or a combination thereof. However, the components of the base station 2100 are not limited to the illustrated example. According to another embodiment, the base station 2100 may include more or fewer components than the aforementioned components. Also, in a certain case, the transceiver 2101, the controller 2102, and the storage 2103 may be implemented in the form of a single chip.

According to an embodiment, the transceiver 2101 may be composed of a transmitter and a receiver. The transceiver 2101 can transmit/receive a signal to/from the UE. This signal may include control information and data. The transceiver 2101 may include an RF transmitter for up-converting and amplifying a frequency of a transmitted signal, and an RF receiver for low-noise amplifying a received signal and down-converting a frequency of the received signal. The transceiver 2101 can receive a signal through a wireless channel and output the received signal to the controller 2102, and can transmit a signal output from the controller 2102 through the wireless channel.

The controller 2102 can control a series of procedures that the base station 2100 can operate according to the above-described embodiment of the disclosure. For example, the controller 2102 can perform or control the operation of the base station to perform at least one or a combination of the methods according to the embodiments of the disclosure. The controller 2102 may include at least one processor. For example, the controller 2102 may include a communication processor (CP) that performs control for communication, and an application processor (AP) that controls a higher layer (e.g., an application).

The storage 2103 can store control information (e.g., information related to channel estimation using DMRSs transmitted on PUSCH determined by the base station 2100) or data, and may have an area for storing data required for the control of the controller 2102 and data generated during the control of the controller 2102.

In the above-described detailed embodiments, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The specification and drawings have disclosed preferred embodiments of the disclosure, and although specific terms have been used, they are only used in a general sense to easily explain the technical contents of the disclosure and to help understand the disclosure, and are not intended to limit the scope of the disclosure. In addition to the embodiments disclosed herein, it is apparent to those skilled in the art to which the disclosure pertains that other modified examples based on the technical idea of the disclosure are possible. In addition, each of the above embodiments can be combined and operated as needed.

Meanwhile, although specific embodiments have been described in the detailed description of the disclosure, various modifications are possible without departing from the scope of the disclosure. Therefore, the scope of the disclosure should not be limited to the described embodiments, but should be determined not only by the scope of the claims described below but also by equivalents of the scope of the claims.

1. A method performed by a terminal in a communication system, the method comprising:
receiving a physical uplink shared channel (PUSCH) repetition transmission configuration including a first PUSCH and a second PUSCH from a base station;
transmitting the first PUSCH to the base station;
receiving downlink control information (DCI) including unified transmission configuration indication (TCI) configuration information from the base station after transmission of the first PUSCH;
determining a power control adjustment state parameter for transmit power control of the second PUSCH based on a closed loop index related to a TCI configured based on the DCI and a TPC command field included in the DCI;
determining transmit power of the second PUSCH based on the power control adjustment state parameter; and
transmitting the second PUSCH to the base station based on the transmit power of the second PUSCH.

2. The method of claim 1, wherein the power control adjustment state parameter for the transmit power control of the second PUSCH is determined based on a TPC command field of DCI included in a set Dᵢ of DCIs including the TPC command field for performing TPC command accumulation for the second PUSCH, and
the set Dᵢ includes DCI received in a time duration defined based on a K_{PUSCH} symbol.

3. The method of claim 2, wherein the K_{PUSCH} symbol corresponds to a symbol length from a last symbol of a physical downlink control channel (PDCCH) including DCI for scheduling the second PUSCH to a start symbol of the second PUSCH.

4. The method of claim 2, wherein the K_{PUSCH} symbol corresponds to a symbol length configured through higher layer signaling.

5. The method of claim 2, wherein the K_{PUSCH} symbol corresponds to:
a symbol length from a last symbol of a PDCCH including the DCI including the unified TCI configuration information to a start symbol of the second PUSCH, or
a symbol length from a first symbol of a slot to which unified TCI is applied based on the DCI including the unified TCI configuration information to the start symbol of the second PUSCH.

6. The method of claim 1, wherein in case that a physical uplink control channel (PUCCH) including hybrid automatic repeat request-acknowledgement (HARQ-ACK) information for the DCI including the unified TCI configuration information overlaps with a PUSCH based on the PUSCH repetition transmission configuration,
canceling the PUSCH and transmitting the PUCCH, or
multiplexing and transmitting the PUCCH and the PUSCH.

7. A method performed by a base station in a communication system, the method comprising:
transmitting a physical uplink shared channel (PUSCH) repetition transmission configuration including a first PUSCH and a second PUSCH to a terminal;
receiving the first PUSCH from the terminal;
transmitting downlink control information (DCI) including unified transmission configuration indication (TCI) configuration information to the terminal after reception of the first PUSCH; and
receiving the second PUSCH from the terminal,
wherein transmit power of the second PUSCH is associated with a power control adjustment state parameter for transmit power control of the second PUSCH determined based on a closed loop index related to a TCI configured based on the DCI and a TPC command field included in the DCI.

8. The method of claim 7, wherein the power control adjustment state parameter for the transmit power control of the second PUSCH is determined based on a TPC command field of DCI included in a set Dᵢ of DCIs including the TPC command field for performing TPC command accumulation for the second PUSCH, and
the set Dᵢ includes DCI received in a time duration defined based on a K_{PUSCH} symbol.

9. The method of claim 8, wherein the K_{PUSCH} symbol corresponds to a symbol length from a last symbol of a physical downlink control channel (PDCCH) including DCI for scheduling the second PUSCH to a start symbol of the second PUSCH.

10. The method of claim 8, wherein the K_{PUSCH} symbol corresponds to a symbol length configured through higher layer signaling.

11. The method of claim 8, wherein the K_{PUSCH} symbol corresponds to:
a symbol length from a last symbol of a PDCCH including the DCI including the unified TCI configuration information to a start symbol of the second PUSCH, or
a symbol length from a first symbol of a slot to which unified TCI is applied based on the DCI including the unified TCI configuration information to the start symbol of the second PUSCH.

12. The method of claim 7, wherein in case that a physical uplink control channel (PUCCH) including hybrid automatic repeat request-acknowledgement (HARQ-ACK) information for the DCI including the unified TCI configuration information overlaps with a PUSCH based on the PUSCH repetition transmission configuration,
receiving the PUCCH from the terminal without the PUSCH, or
receiving the PUCCH and the PUSCH multiplexed.

13. A terminal in a communication system, comprising:
a transceiver and a controller,
the controller configured to:
receive a physical uplink shared channel (PUSCH) repetition transmission configuration including a first PUSCH and a second PUSCH from a base station,
transmit the first PUSCH to the base station,
receive downlink control information (DCI) including unified transmission configuration indication (TCI) configuration information from the base station after transmission of the first PUSCH,
determine a power control adjustment state parameter for transmit power control of the second PUSCH based on a closed loop index related to a TCI configured based on the DCI and a TPC command field included in the DCI,
determine transmit power of the second PUSCH based on the power control adjustment state parameter, and
transmit the second PUSCH to the base station based on the transmit power of the second PUSCH.

14. A base station in a communication system, comprising:
a transceiver and a controller,
the controller configured to:
transmit a physical uplink shared channel (PUSCH) repetition transmission configuration including a first PUSCH and a second PUSCH to a terminal,
receive the first PUSCH from the terminal,
transmit downlink control information (DCI) including unified transmission configuration indication (TCI) configuration information to the terminal after reception of the first PUSCH, and
receive the second PUSCH from the terminal,
wherein transmit power of the second PUSCH is associated with a power control adjustment state parameter for transmit power control of the second PUSCH determined based on a closed loop index related to a TCI configured based on the DCI and a TPC command field included in the DCI.
